(19) United States
(12) Patent Application Publication
(10) Pub. No.: US 2025/0048138 A1
(43) Pub. Date: Feb. 6, 2025

(54) SIGNAL PROCESSING METHOD AND DEVICE

(71) Applicant: HUAWEI TECHNOLOGIES CO., LTD., Shenzhen (CN)

(72) Inventors: Jiahui LI, Shenzhen (CN); Mengyao MA, Shenzhen (CN); Zihan TANG, Shenzhen (CN); Danny Kai Pin TAN, Shenzhen (CN); Rui DU, Singapore (SG); Min YAN, Shenzhen (CN)

(21) Appl. No.: 18/919,685

(22) Filed: Oct. 18, 2024

Related U.S. Application Data
(63) Continuation of application No. PCT/CN2023/082294, filed on Mar. 17, 2023.

(30) Foreign Application Priority Data
Apr. 19, 2022 (CN) 202210412680.2

(51) Int. Cl. H04W 24/02; H04L 27/26

(52) U.S. Cl. CPC H04W 24/02; H04L 27/26; H04L 27/265

(57) ABSTRACT

This application provides a signal processing method and device. The method includes: A first device receives a first complex signal formed after an electromagnetic signal is reflected by an ambient environment. A dimension of the first complex signal is related to configuration information of the first device. The first device sends a transformed signal to a second device. The transformed signal includes a transformed bitstream, and the transformed bitstream is obtained by the first device by transforming the first complex signal based on the configuration information of the first device, so that the second device de-transforms the transformed signal based on the configuration information of the first device to obtain a second complex signal.

### CROSS-REFERENCE TO RELATED APPLICATIONS

This application is a continuation of International Application No. PCT/CN2023/082294, filed on Mar. 17, 2023, which claims priority to Chinese Patent Application No. 202210412680.2, filed on Apr. 19, 2022. The disclosures of the aforementioned applications are hereby incorporated by reference in their entireties.

### TECHNICAL FIELD

This application relates to the field of communication technologies, and in particular, to a signal processing method and device.

### BACKGROUND

With continuous development of cellular mobile network, wireless network technology (Wi-Fi), and other communication systems, in many fields such as medical imaging, pattern recognition, wireless communication, and radar remote sensing, a sending device (for example, a sensing device or another device) may perform sensing, imaging, positioning, or the like on an ambient environment by using an electromagnetic signal. This facilitates offline or real-time modeling and analysis on a wireless transmission environment, and can significantly improve performance of the communication systems.

Currently, due to limitations from factors such as a computing capability, a battery capacity, and a sensing range, the sending device needs to transmit collected signals to a central node (for example, a server, a cloud computing center, or a device with strong computing power), and the central node performs signal fusion and information processing on the collected signals. The collected signals are usually broadband multi-frequency electromagnetic signals in different orientations, resulting in a large data amount, and affecting signal transmission and information processing. For such a consideration, before transmitting the collected signals to the central node, the sending device needs to compress the collected signals, to reduce consumption of radio transmission resources.

However, due to neglect of a characteristic of an electromagnetic signal and impact of channel transmission, a related technology such as an entropy encoding technology, an audio compression algorithm, or a video compression algorithm is limited in use performance or even cannot be used.

### SUMMARY

This application provides a signal processing method and device, to resolve a problem in a related technology that a characteristic of an electromagnetic signal and impact of channel transmission are neglected when a signal formed after an electromagnetic signal is reflected by an ambient environment is transmitted, thereby implementing signal transmission and signal reconstruction between devices, and helping improve transform efficiency and reconstruction precision.

According to a first aspect, this application provides a signal processing method, including:

A first device receives a first complex signal formed after an electromagnetic signal is reflected by an ambient environment. A dimension of the first complex signal is related to configuration information of the first device.

The first device sends a transformed signal to a second device. The transformed signal includes a transformed bitstream, and the transformed bitstream is obtained by the first device by transforming the first complex signal based on the configuration information of the first device, so that the second device de-transforms the transformed signal based on the configuration information of the first device to obtain a second complex signal.

According to the signal processing method provided in the first aspect, redundant information in a signal can be removed based on an electromagnetic characteristic of an electromagnetic signal in combination with one or more dimensions of the signal, which facilitates fast transmission of electromagnetic signals between devices, is applicable to signal transmission of sensing, imaging, positioning, or other electromagnetic signals, improves signal transform efficiency, saves radio transmission resources, facilitates information processing and signal reconstruction, and improves signal reconstruction precision.

In a possible design, the first complex signal includes data in a space dimension and a time dimension, or data in the space dimension.

That the transformed bitstream is obtained by the first device by transforming the first complex signal based on the configuration information of the first device includes:

The first device determines an initial configuration parameter based on the configuration information of the first device. The initial configuration parameter includes a space dimension size and a time dimension size of the first complex signal, and at least one of the following: a block size of block discrete cosine transform DCT or discrete Fourier transform DFT or discrete wavelet transform DWT, a block quantity of block discrete cosine transform DCT or discrete Fourier transform DFT or discrete wavelet transform DWT, a phase processing switch, a phase difference order M1, an amplitude processing switch, or an amplitude difference order Q1. M1 and Q1 are positive integers.

The first device transforms the first complex signal based on the initial configuration parameter to obtain the transformed bitstream.

In a possible design, that the first device transforms the first complex signal based on the initial configuration parameter to obtain the transformed bitstream includes:

The first device obtains, from the first complex signal, an (M2)^{th}-order phase difference of data corresponding to each time. M2 is equal to M1 or a preconfigured positive integer.

The first device performs smoothing and block discrete cosine transform DCT or discrete Fourier transform DFT or discrete wavelet transform DWT on the (M2)^{th}-order phase difference to obtain a first bitstream.

The first device obtains, from the first complex signal, a (Q2)^{th}-order amplitude difference of the data corresponding to each time. Q2 is equal to Q1 or a preconfigured positive integer.

The first device performs block discrete cosine transform DCT or discrete Fourier transform DFT or discrete wavelet transform DWT on the (Q2)^{th}-order amplitude difference to obtain a second bitstream.

The first device determines that the transformed bitstream includes the first bitstream and the second bitstream.

In this way, the first device can implement redundancy removal processing on the complex signal in combination with the space dimension and the time dimension or the space dimension based on a phase difference operation, periodic calibration, and discrete transform of the complex signal and an amplitude difference operation and discrete transform of the complex signal.

In a possible design, the transformed signal further includes first signaling, and the first signaling indicates a transmission length of the transformed bitstream and/or a total length of the transformed bitstream.

In a possible design, the first complex signal includes data in a delay-frequency domain dimension and a time dimension, or data in the delay-frequency domain dimension.

That the transformed bitstream is obtained by the first device by transforming the first complex signal based on the configuration information of the first device includes:

The first device determines an initial configuration parameter based on the configuration information of the first device. The initial configuration parameter includes a delay-frequency domain dimension size and a time dimension size of the first complex signal, and at least one of the following: a redundancy removal processing switch, a redundancy removal order P1, or a first transform step configuration. P1 is a positive integer.

The first device transforms the first complex signal based on the initial configuration parameter to obtain the transformed bitstream.

In a possible design, that the first device transforms the first complex signal based on the initial configuration parameter to obtain the transformed bitstream includes:

The first device transforms data in the delay-frequency domain dimension in the first complex signal from a frequency domain to a delay domain, to obtain a third complex signal.

The first device obtains a first region of interest ROI of data corresponding to each time in the third complex signal.

The first device performs (P2)^{th}-order redundancy removal on the data corresponding to each time in the third complex signal, to obtain a fourth complex signal. P2 is equal to P1 or a preconfigured positive integer.

The first device obtains the transformed bitstream based on the first region of interest ROI and the fourth complex signal.

In this way, the first device can implement redundancy removal processing on the complex signal in combination with the delay-frequency domain dimension and the time dimension or the delay-frequency domain dimension based on region of interest processing and time correlation of the complex signal.

In a possible design, the transformed signal further includes second signaling, and the second signaling indicates at least one of the following: a transmission length of the transformed bitstream, a total length of the transformed bitstream, a correlation coefficient for redundancy removal, or a second region of interest ROI. The second region of interest ROI is obtained by the first device through redundancy removal on the first region of interest ROI.

In a possible design, the first complex signal includes data in a space dimension, a delay-frequency domain dimension, an antenna array dimension, and a time dimension, or data in the space dimension, the delay-frequency domain dimension, and the time dimension.

That the transformed bitstream is obtained by the first device by transforming the first complex signal based on the configuration information of the first device includes:

The first device determines an initial configuration parameter based on the configuration information of the first device. The initial configuration parameter includes a space dimension size, a delay-frequency domain dimension size, an antenna array dimension size, and a time dimension size of the first complex signal, and at least one of the following: a block size of block discrete cosine transform DCT or discrete Fourier transform DFT or discrete wavelet transform DWT, a block quantity of block discrete cosine transform DCT or discrete Fourier transform DFT or discrete wavelet transform DWT, a second transform step configuration, a phase processing switch, a phase difference order K1, an antenna array dimension redundancy removal processing switch, an antenna array dimension redundancy removal order R1, a time dimension redundancy removal processing switch, or an order S1 of the time dimension redundancy removal processing switch. K1, R1, and S1 are positive integers.

The first device transforms the first complex signal based on the initial configuration parameter to obtain the transformed bitstream.

In a possible design, that the first device transforms the first complex signal based on the initial configuration parameter to obtain the transformed bitstream includes:

The first device performs at least one of the following based on the second transform step configuration and the first complex signal:
obtaining a region of interest ROI of a signal in the space dimension and the delay-frequency domain dimension, performing smoothing and block discrete cosine transform DCT or discrete Fourier transform DFT or discrete wavelet transform DWT on a phase difference of the signal, and performing antenna array dimension redundancy removal on the signal, or performing time dimension redundancy removal on the signal.

The signal is the first complex signal or a signal obtained by transforming the first complex signal.

In a possible design, that the first device performs at least one of the following based on the second transform step configuration and the first complex signal includes:

The first device transforms data in the delay-frequency domain dimension in the first complex signal from a frequency domain to a delay domain, to obtain a fifth complex signal.

The first device obtains a third region of interest ROI of data corresponding to each time in each antenna array in the fifth complex signal.

The first device obtains, from the fifth complex signal in the third region of interest ROI, a (K2)^{th}-order phase difference of data corresponding to each time in each antenna array. K2 is equal to K1 or a preconfigured positive integer.

The first device performs smoothing and block discrete cosine transform DCT or discrete Fourier transform DFT or discrete wavelet transform DWT on the (K2)^{th}-order phase difference to obtain a third bitstream.

The first device performs, in the fifth complex signal in the third region of interest ROI, (R2)^{th}-order redundancy removal on an amplitude of data corresponding to each antenna array and (S2)^{th}-order redundancy removal on an amplitude of data corresponding to each time, to obtain a real signal. R2 is equal to R1 or a preconfigured positive integer, and S2 is equal to S1 or a preconfigured positive integer.

The first device performs block discrete cosine transform DCT or discrete Fourier transform DFT or discrete wavelet transform DWT on the real signal to obtain a fourth bitstream.

The first device determines that the transformed bitstream includes the third bitstream and the fourth bitstream.

In this way, the first device can implement redundancy removal processing on the complex signal in combination with the space dimension, the delay-frequency domain dimension, the antenna array dimension, and the time dimension, or the space dimension and the delay-frequency domain dimension, or the space dimension, the delay-frequency domain dimension, and the antenna array dimension, or the space dimension, the delay-frequency domain dimension, and the time dimension based on region of interest processing of the complex signal, a phase difference operation, periodic calibration, and discrete transform of the complex signal, an amplitude difference operation and discrete transform of the complex signal, time correlation, and redundancy removal between antenna arrays.

In a possible design, the transformed signal further includes third signaling, and the third signaling indicates at least one of the following: a transmission length of the transformed bitstream, a total length of the transformed bitstream, a correlation coefficient for antenna array dimension redundancy removal, a correlation coefficient for time dimension redundancy removal, or a fourth region of interest ROI. The fourth region of interest ROI is obtained by the first device through redundancy removal on the third region of interest ROI of each antenna array.

In a possible design, that the first device performs at least one of the following based on the second transform step configuration and the first complex signal includes:

The first device transforms data in the delay-frequency domain dimension in the first complex signal from a frequency domain to a delay domain, to obtain a sixth complex signal.

The first device performs (S3)^{th}-order redundancy removal on an amplitude of data corresponding to each time in the sixth complex signal, to obtain a seventh complex signal. S3 is equal to S1 or a preconfigured positive integer.

The first device obtains a fifth region of interest ROI of data corresponding to each time in each antenna array in the seventh complex signal.

The first device obtains, from the seventh complex signal in the fifth region of interest ROI, a (K3)^{th}-order phase difference of data corresponding to each time in each antenna array. K3 is equal to K1 or a preconfigured positive integer.

The first device performs smoothing and block discrete cosine transform DCT or discrete Fourier transform DFT or discrete wavelet transform DWT on the (K3)^{th}-order phase difference to obtain a fifth bitstream.

The first device performs block discrete cosine transform DCT or discrete Fourier transform DFT or discrete wavelet transform DWT on an amplitude of the seventh complex signal in the fifth region of interest ROI to obtain a sixth bitstream.

The first device determines that the transformed bitstream includes the fifth bitstream and the sixth bitstream.

In a possible design, the transformed signal further includes fourth signaling, and the fourth signaling indicates at least one of the following: a transmission length of the transformed bitstream, a total length of the transformed bitstream, a correlation coefficient for time dimension redundancy removal, or a sixth region of interest ROI. The sixth region of interest ROI is obtained by the first device through redundancy removal on the fifth region of interest ROI of each antenna array.

In a possible design, before the first device sends the transformed signal to the second device, the method further includes:

The first device performs at least one of data quantization, bit layering, run-length encoding, or entropy encoding on a corresponding bitstream, to update the corresponding bitstream.

In a possible design, a data quantization type is related to a data distribution status before data quantization and a channel status between the first device and the second device.

In a possible design, before the first device receives the first complex signal formed after the electromagnetic signal is reflected by the ambient environment, the method further includes:

The first device transmits the electromagnetic signal, so that the first device receives the first complex signal.

Alternatively, the first device sends a transmit request to a third device. The transmit request is used by the third device to transmit the electromagnetic signal, so that the first device receives the first complex signal, and the third device is different from the first device.

In a possible design, the method further includes:

The first device sends a configuration indication to the second device. The configuration indication includes the initial configuration parameter, and the initial configuration parameter is related to the configuration information of the first device, so that the second device determines the initial configuration parameter based on the configuration indication, and de-transforms the transformed signal based on the initial configuration parameter, to obtain the second complex signal.

Alternatively, the first device sends a configuration indication to the second device. The configuration indication indicates a type of the first complex signal, and the type of the first complex signal is related to the initial configuration parameter, so that the second device determines the initial configuration parameter based on the configuration indication, and de-transforms the transformed signal based on the initial configuration parameter, to obtain the second complex signal.

In a possible design, the dimension of the first complex signal is related to at least one of the following in the configuration information of the first device:
an antenna configuration of the first device, a quantity of carriers of the first device, or a duration for signal collection of the first device.

In a possible design, before the first device sends the transformed signal to the second device, the method further includes:

The first device sends a resource request to the second device. The resource request is used to request a transmission resource of the transformed bitstream.

The first device receives a first resource indication from the second device. The first resource indication indicates a first allocated resource of the transformed bitstream.

The first device obtains an adapted transformed bitstream from the transformed bitstream based on the first allocated resource of the transformed bitstream.

That the first device sends a transformed signal to a second device includes:

That the first device sends a transformed signal to a second device is sending the adapted transformed bitstream.

In a possible design, that the first device obtains an adapted transformed bitstream from the transformed bitstream based on the first allocated resource of the transformed bitstream includes:

The first device determines a first transform parameter based on the first allocated resource of the transformed bitstream. The first transform parameter includes at least one of the following: a first length, a first distortion amount, and a first compression rate.

The first device determines that the adapted transformed bitstream is a transformed bitstream that is in the transformed bitstream and that is adapted to the first transform parameter.

In a possible design, that the first device obtains an adapted transformed bitstream from the transformed bitstream based on the first allocated resource of the transformed bitstream includes:

The first device obtains a first transformed bitstream from the transformed bitstream based on a preconfigured transmission resource.

When determining that the preconfigured transmission resource conforms to the first allocated resource of the transformed bitstream, the first device determines the first transformed bitstream as the adapted transformed bitstream.

Alternatively, when determining that the preconfigured transmission resource does not conform to the first allocated resource of the transformed bitstream, the first device determines a second transform parameter based on the first allocated resource of the transformed bitstream, where the second transform parameter includes at least one of the following: a second length, a second distortion amount, and a second compression ratio, and determines that the adapted transformed bitstream is a transformed bitstream that is in the transformed bitstream and that is adapted to the second transform parameter.

In a possible design, before the first device sends the transformed signal to the second device, the method further includes:

The first device sends a second resource indication to the second device. The second resource indication indicates a second allocated resource of the transformed bitstream.

The first device obtains an adapted transformed bitstream from the transformed bitstream based on the second allocated resource of the transformed bitstream.

That the first device sends a transformed signal to a second device includes:

That the first device sends a transformed signal to a second device is sending the adapted transformed bitstream.

According to a second aspect, this application provides a signal processing method, including:

A second device receives a transformed signal from a first device. The transformed signal includes a transformed bitstream, the transformed bitstream is obtained by the first device by transforming a first complex signal based on configuration information of the first device, the first complex signal is obtained by reflecting an electromagnetic signal by an ambient environment and received by the first device, and a dimension of the first complex signal is related to the configuration information of the first device.

The second device de-transforms the transformed signal based on the configuration information of the first device, to obtain a second complex signal.

In a possible design, the transformed signal further includes an instruction, and the instruction indicates a transmission length of the transformed bitstream and/or a total length of the transformed bitstream.

In a possible design, the method further includes:

The second device receives a configuration indication from the first device. The configuration indication includes an initial configuration parameter, and the initial configuration parameter is related to the configuration information of the first device.

That the second device de-transforms the transformed signal based on the configuration information of the first device, to obtain a second complex signal includes:

The second device determines the initial configuration parameter based on the configuration indication.

The second device de-transforms the transformed signal based on the initial configuration parameter, to obtain the second complex signal.

In a possible design, the method further includes:

The second device receives a configuration indication from the first device. The configuration indication indicates a type of the first complex signal, and the type of the first complex signal is related to an initial configuration parameter.

That the second device de-transforms the transformed signal based on the configuration information of the first device, to obtain a second complex signal includes:

The second device determines the initial configuration parameter based on the configuration indication.

The second device de-transforms the transformed signal based on the initial configuration parameter, to obtain the second complex signal.

In a possible design, the dimension of the first complex signal is related to at least one of the following in the configuration information of the first device:
an antenna configuration of the first device, a quantity of carriers of the first device, or a duration for signal collection of the first device.

In a possible design, the method further includes:

The second device receives a resource request from the first device. The resource request is used to request a transmission resource of the transformed bitstream.

The second device determines a first resource indication based on the transmission resource of the transformed bitstream. The first resource indication indicates a first allocated resource of the transformed bitstream.

The second device sends the first resource indication to the first device, so that the first device obtains an adapted transformed bitstream from the transformed bitstream based on the first allocated resource of the transformed bitstream.

That a second device receives a transformed signal from a first device includes:

That a second device receives a transformed signal from a first device is receiving the adapted transformed bitstream.

In a possible design, the method further includes:

The second device receives a second resource indication from the first device. The second resource indication indicates a second allocated resource of the transformed bitstream.

That a second device receives a transformed signal from a first device includes:

That a second device receives a transformed signal from a first device is receiving an adapted transformed bitstream. The adapted transformed bitstream is obtained by the first device from the transformed bitstream based on the second allocated resource of the transformed bitstream.

For beneficial effects of the signal processing method provided in the second aspect and the possible designs of the second aspect, refer to the beneficial effects brought by the first aspect and the possible implementations of the first aspect. Details are not described herein again.

According to a third aspect, this application provides a signal processing apparatus, including:
a first receiving module, configured to receive a first complex signal formed after an electromagnetic signal is reflected by an ambient environment, where a dimension of the first complex signal is related to configuration information of the first device;
a first processing module, configured to transform the first complex signal based on the configuration information of the first device, to obtain a transformed bitstream; and
a first sending module, configured to send a transformed signal to a second device, where the transformed signal includes the transformed bitstream, so that the second device de-transforms the transformed signal based on the configuration information of the first device to obtain a second complex signal.

In a possible design, the first processing module is configured to: when the first complex signal includes data in a space dimension and a time dimension, or data in the space dimension,
determine an initial configuration parameter based on the configuration information of the first device, where the initial configuration parameter includes a space dimension size and a time dimension size of the first complex signal, and at least one of the following: a block size of block discrete cosine transform DCT or discrete Fourier transform DFT or discrete wavelet transform DWT, a block quantity of block discrete cosine transform DCT or discrete Fourier transform DFT or discrete wavelet transform DWT, a phase processing switch, a phase difference order M1, an amplitude processing switch, or an amplitude difference order Q1, where M1 and Q1 are positive integers; and
transform the first complex signal based on the initial configuration parameter to obtain the transformed bitstream.

In a possible design, the first processing module is specifically configured to obtain, from the first complex signal, an (M2)^{th}-order phase difference of data corresponding to each time, where M2 is equal to M1 or a preconfigured positive integer;
perform smoothing and block discrete cosine transform DCT or discrete Fourier transform DFT or discrete wavelet transform DWT on the (M2)^{th}-order phase difference to obtain a first bitstream;
obtain, from the first complex signal, a (Q2)^{m}-order amplitude difference of the data corresponding to each time, where Q2 is equal to Q1 or a preconfigured positive integer;
perform block discrete cosine transform DCT or discrete Fourier transform DFT or discrete wavelet transform DWT on the (Q2)^{th}-order amplitude difference to obtain a second bitstream; and
determine that the transformed bitstream includes the first bitstream and the second bitstream.

In a possible design, the transformed signal further includes first signaling, and the first signaling indicates a transmission length of the transformed bitstream and/or a total length of the transformed bitstream.

In a possible design, the first processing module is configured to: when the first complex signal includes data in a delay-frequency domain dimension and a time dimension, or data in the delay-frequency domain dimension,
determine an initial configuration parameter based on the configuration information of the first device, where the initial configuration parameter includes a delay-frequency domain dimension size and a time dimension size of the first complex signal, and at least one of the following: a redundancy removal processing switch, a redundancy removal order P1, or a first transform step configuration, where P1 is a positive integer; and
transform the first complex signal based on the initial configuration parameter to obtain the transformed bitstream.

In a possible design, the first processing module is specifically configured to transform data in the delay-frequency domain dimension in the first complex signal from a frequency domain to a delay domain, to obtain a third complex signal;
obtain a first region of interest ROI of data corresponding to each time in the third complex signal;
perform (P2)^{th}-order redundancy removal on the data corresponding to each time in the third complex signal, to obtain a fourth complex signal, where P2 is equal to P1 or a preconfigured positive integer; and
obtain the transformed bitstream based on the first region of interest ROI and the fourth complex signal.

In a possible design, the transformed signal further includes second signaling, and the second signaling indicates at least one of the following: a transmission length of the transformed bitstream, a total length of the transformed bitstream, a correlation coefficient for redundancy removal, or a second region of interest ROI. The second region of interest ROI is obtained by the first processing module through redundancy removal on the first region of interest ROI.

In a possible design, the first processing module is configured to: when the first complex signal includes data in a space dimension, a delay-frequency domain dimension, an antenna array dimension, and a time dimension, or data in the space dimension, the delay-frequency domain dimension, and the time dimension,
determine an initial configuration parameter based on the configuration information of the first device, where the initial configuration parameter includes a space dimension size, a delay-frequency domain dimension size, an antenna array dimension size, and a time dimension size of the first complex signal, and at least one of the following: a block size of block discrete cosine transform DCT or discrete Fourier transform DFT or discrete wavelet transform DWT, a block quantity of block discrete cosine transform DCT or discrete Fourier transform DFT or discrete wavelet transform DWT, a second transform step configuration, a phase processing switch, a phase difference order K1, an antenna array dimension redundancy removal processing switch, an antenna array dimension redundancy removal order R1, a time dimension redundancy removal processing switch, or an order S1 of the time dimension redundancy removal processing switch, where K1, R1, and S1 are positive integers; and
transform the first complex signal based on the initial configuration parameter to obtain the transformed bitstream.

In a possible design, the first processing module is configured to perform at least one of the following based on the second transform step configuration and the first complex signal:
obtaining a region of interest ROI of a signal in the space dimension and the delay-frequency domain dimension, performing smoothing and block discrete cosine transform DCT or discrete Fourier transform DFT or discrete wavelet transform DWT on a phase difference of the signal, and performing antenna array dimension redundancy removal on the signal, or performing time dimension redundancy removal on the signal.

The signal is the first complex signal or a signal obtained by transforming the first complex signal.

In a possible design, the first processing module is specifically configured to transform data in the delay-frequency domain dimension in the first complex signal from a frequency domain to a delay domain, to obtain a fifth complex signal;
obtain a third region of interest ROI of data corresponding to each time in each antenna array in the fifth complex signal;
obtain, from the fifth complex signal in the third region of interest ROI, a (K2)^{th}-order phase difference of data corresponding to each time in each antenna array, where K2 is equal to K1 or a preconfigured positive integer;
perform smoothing and block discrete cosine transform DCT or discrete Fourier transform DFT or discrete wavelet transform DWT on the (K2)^{th}-order phase difference to obtain a third bitstream;
perform, in the fifth complex signal in the third region of interest ROI, (R2)^{th}-order redundancy removal on an amplitude of data corresponding to each antenna array and (S2)^{th}-order redundancy removal on an amplitude of data corresponding to each time, to obtain a real signal, where R2 is equal to R1 or a preconfigured positive integer, and S2 is equal to S1 or a preconfigured positive integer;
perform block discrete cosine transform DCT or discrete Fourier transform DFT or discrete wavelet transform DWT on the real signal to obtain a fourth bitstream; and
determine that the transformed bitstream includes the third bitstream and the fourth bitstream.

In a possible design, the transformed signal further includes third signaling, and the third signaling indicates at least one of the following: a transmission length of the transformed bitstream, a total length of the transformed bitstream, a correlation coefficient for antenna array dimension redundancy removal, a correlation coefficient for time dimension redundancy removal, or a fourth region of interest ROI. The fourth region of interest ROI is obtained by the first processing module through redundancy removal on the third region of interest ROI of each antenna array.

In a possible design, the first processing module is specifically configured to transform data in the delay-frequency domain dimension in the first complex signal from a frequency domain to a delay domain, to obtain a sixth complex signal;
perform (S3)^{th}-order redundancy removal on an amplitude of data corresponding to each time in the sixth complex signal, to obtain a seventh complex signal, where S3 is equal to S1 or a preconfigured positive integer;
obtain a fifth region of interest ROI of data corresponding to each time in each antenna array in the seventh complex signal;
obtain, from the seventh complex signal in the fifth region of interest ROI, a (K3)^{th}-order phase difference of data corresponding to each time in each antenna array, where K3 is equal to K1 or a preconfigured positive integer;
perform smoothing and block discrete cosine transform DCT or discrete Fourier transform DFT or discrete wavelet transform DWT on the (K3)^{th}-order phase difference to obtain a fifth bitstream;
perform block discrete cosine transform DCT or discrete Fourier transform DFT or discrete wavelet transform DWT on an amplitude of the seventh complex signal in the fifth region of interest ROI to obtain a sixth bitstream; and
determine that the transformed bitstream includes the fifth bitstream and the sixth bitstream.

In a possible design, the transformed signal further includes fourth signaling, and the fourth signaling indicates at least one of the following: a transmission length of the transformed bitstream, a total length of the transformed bitstream, a correlation coefficient for time dimension redundancy removal, or a sixth region of interest ROI. The sixth region of interest ROI is obtained by the first processing module through redundancy removal on the fifth region of interest ROI of each antenna array.

In a possible design, the first processing module is further configured to: before the transformed signal is sent to the second device, perform at least one of data quantization, bit layering, run-length encoding, or entropy encoding on a corresponding bitstream, to update the corresponding bitstream.

In a possible design, a data quantization type is related to a data distribution status before data quantization and a channel status between the first device and the second device.

In a possible design, the first sending module is further configured to: before the first receiving module receives the first complex signal formed after the electromagnetic signal is reflected by the ambient environment, transmit the electromagnetic signal, so that the first receiving module receives the first complex signal; or
send a transmit request to a third device, where the transmit request is used by the third device to transmit the electromagnetic signal, so that the first receiving module receives the first complex signal, and the third device is different from the first device.

In a possible design, the first sending module is further configured to: send a configuration indication to the second device, where the configuration indication includes the initial configuration parameter, and the initial configuration parameter is related to the configuration information of the first device, so that the second device determines the initial configuration parameter based on the configuration indication, and de-transforms the transformed signal based on the initial configuration parameter, to obtain the second complex signal; or
send a configuration indication to the second device, where the configuration indication indicates a type of the first complex signal, and the type of the first complex signal is related to the initial configuration parameter, so that the second device determines the initial configuration parameter based on the configuration indication, and de-transforms the transformed signal based on the initial configuration parameter, to obtain the second complex signal.

In a possible design, the dimension of the first complex signal is related to at least one of the following in the configuration information of the first device:
an antenna configuration of the first device, a quantity of carriers of the first device, or a duration for signal collection of the first device.

In a possible design, the first sending module is further configured to: before sending the transformed signal to the second device, send a resource request to the second device. The resource request is used to request a transmission resource of the transformed bitstream.

The first receiving module is further configured to receive a first resource indication from the second device. The first resource indication indicates a first allocated resource of the transformed bitstream.

The first processing module is further configured to obtain an adapted transformed bitstream from the transformed bitstream based on the first allocated resource of the transformed bitstream.

The first sending module is further configured to send the transformed signal to the second device, that is, send the adapted transformed bitstream.

In a possible design, the first processing module is further configured to: determine a first transform parameter based on the first allocated resource of the transformed bitstream, where the first transform parameter includes at least one of the following: a first length, a first distortion amount, and a first compression rate; and
determine that the adapted transformed bitstream is a transformed bitstream that is in the transformed bitstream and that is adapted to the first transform parameter.

In a possible design, the first processing module is specifically configured to: obtain a first transformed bitstream from the transformed bitstream based on a preconfigured transmission resource; and
when determining that the preconfigured transmission resource conforms to the first allocated resource of the transformed bitstream, determine the first transformed bitstream as the adapted transformed bitstream; or
when determining that the preconfigured transmission resource does not conform to the first allocated resource of the transformed bitstream, determine a second transform parameter based on the first allocated resource of the transformed bitstream, where the second transform parameter includes at least one of the following: a second length, a second distortion amount, and a second compression ratio, and determine that the adapted transformed bitstream is a transformed bitstream that is in the transformed bitstream and that is adapted to the second transform parameter.

In a possible design, the first sending module is further configured to: before sending the transformed signal to the second device, send a second resource indication to the second device. The second resource indication indicates a second allocated resource of the transformed bitstream.

The first processing module is further configured to obtain an adapted transformed bitstream from the transformed bitstream based on the second allocated resource of the transformed bitstream.

The first sending module is further configured to send the transformed signal to the second device, that is, send the adapted transformed bitstream.

For beneficial effects of the signal processing apparatus provided in the third aspect and the possible designs of the third aspect, refer to the beneficial effects brought by the first aspect and the possible implementations of the first aspect. Details are not described herein again.

According to a fourth aspect, this application provides a signal processing apparatus, including:
a second receiving module, configured to receive a transformed signal from a first device, where the transformed signal includes a transformed bitstream, the transformed bitstream is obtained by the first device by transforming a first complex signal based on configuration information of the first device, the first complex signal is obtained by reflecting an electromagnetic signal by an ambient environment and received by the first device, and a dimension of the first complex signal is related to the configuration information of the first device; and
a second processing module, configured to de-transform the transformed signal based on the configuration information of the first device, to obtain a second complex signal.

In a possible design, the transformed signal further includes an instruction, and the instruction indicates a transmission length of the transformed bitstream and/or a total length of the transformed bitstream.

In a possible design, the second receiving module is further configured to receive a configuration indication from the first device. The configuration indication includes an initial configuration parameter, and the initial configuration parameter is related to the configuration information of the first device.

The second processing module is specifically configured to: determine the initial configuration parameter based on the configuration indication; and de-transform the transformed signal based on the initial configuration parameter, to obtain the second complex signal.

In a possible design, the second receiving module is further configured to receive a configuration indication from the first device. The configuration indication indicates a type of the first complex signal, and the type of the first complex signal is related to an initial configuration parameter.

The second processing module is specifically configured to: determine the initial configuration parameter based on the configuration indication; and de-transform the transformed signal based on the initial configuration parameter, to obtain the second complex signal.

In a possible design, the dimension of the first complex signal is related to at least one of the following in the configuration information of the first device:
an antenna configuration of the first device, a quantity of carriers of the first device, or a duration for signal collection of the first device.

In a possible design, the signal processing apparatus further includes a second sending module.

The second receiving module is further configured to receive a resource request from the first device. The resource request is used to request a transmission resource of the transformed bitstream.

The second processing module is further configured to determine a first resource indication based on the transmission resource of the transformed bitstream. The first resource indication indicates a first allocated resource of the transformed bitstream.

The second sending module is configured to send the first resource indication to the first device, so that the first device obtains an adapted transformed bitstream from the transformed bitstream based on the first allocated resource of the transformed bitstream.

The second receiving module is specifically configured to receive the transformed signal from the first device, that is, receive the adapted transformed bitstream.

In a possible design, the second receiving module is further configured to receive a second resource indication from the first device. The second resource indication indicates a second allocated resource of the transformed bitstream.

The second receiving module is specifically configured to receive the transformed signal from the first device, that is, receive an adapted transformed bitstream. The adapted transformed bitstream is obtained by the first device from the transformed bitstream based on the second allocated resource of the transformed bitstream.

For beneficial effects of the signal processing apparatus provided in the fourth aspect and the possible designs of the fourth aspect, refer to the beneficial effects brought by the second aspect and the possible implementations of the second aspect. Details are not described herein again.

According to a fifth aspect, this application provides a communication system, including the signal processing apparatus provided in the third aspect and the possible designs of the third aspect and the signal processing apparatus provided in the fourth aspect and the possible designs of the fourth aspect.

According to a sixth aspect, this application provides a signal processing apparatus, including a memory and a processor. The memory is configured to store program instructions, and the processor is configured to invoke the program instructions in the memory, to enable the signal processing apparatus to perform the signal processing method in any one of the first aspect and the possible designs of the first aspect.

According to a seventh aspect, this application provides a signal processing apparatus, including a memory and a processor. The memory is configured to store program instructions, and the processor is configured to invoke the program instructions in the memory, to enable the signal processing apparatus to perform the signal processing method in any one of the second aspect and the possible designs of the second aspect.

According to an eighth aspect, this application provides a chip, including an interface circuit and a logic circuit. The interface circuit is configured to receive a signal from another chip other than the chip and transmit the signal to the logic circuit, or send a signal from the logic circuit to the another chip other than the chip. The logic circuit is configured to implement the signal processing method in any one of the first aspect and the possible designs of the first aspect, and/or implement the signal processing method in any one of the second aspect and the possible designs of the second aspect.

According to a ninth aspect, this application provides a computer-readable storage medium. The computer-readable storage medium stores a computer program, and the computer program is executed by a processor to enable a signal processing apparatus to implement the signal processing method in any one of the first aspect and the possible designs of the first aspect, and/or implement the signal processing method in any one of the second aspect and the possible designs of the second aspect.

According to a tenth aspect, this application provides a computer program product, including executable instructions. The executable instructions are stored in a readable storage medium, at least one processor of a signal processing apparatus may read the executable instructions from the readable storage medium, and the at least one processor executes the instructions to enable the signal processing apparatus to implement the signal processing method in any one of the first aspect and the possible designs of the first aspect, and/or implement the signal processing method in any one of the second aspect and the possible designs of the second aspect.

### BRIEF DESCRIPTION OF DRAWINGS

FIG. 1A and FIG. 1B are diagrams of architectures of a communication system according to an embodiment of this application;

FIG. 2 is a signaling interaction diagram of a signal processing method according to an embodiment of this application;

FIG. 3 is a schematic flowchart of a signal processing method according to an embodiment of this application;

FIG. 4A is a diagram of effects before and after phase difference smoothing of a first complex signal according to an embodiment of this application;

FIG. 4B is a diagram of effects before and after space block padding according to an embodiment of this application;

FIG. 5 is a diagram of a transformed signal according to an embodiment of this application;

FIG. 6 is a schematic flowchart of a signal processing method according to an embodiment of this application;

FIG. 7 is a schematic flowchart of a signal processing method according to an embodiment of this application;

FIG. 8 is a diagram of a data reference according to an embodiment of this application;

FIG. 9 is a diagram of a transformed signal according to an embodiment of this application;

FIG. 10 is a schematic flowchart of a signal processing method according to an embodiment of this application;

FIG. 11 is a diagram of a first complex signal according to an embodiment of this application;

FIG. 12 is a schematic flowchart of a signal processing method according to an embodiment of this application;

FIG. 13 is a diagram of a data range according to an embodiment of this application;

FIG. 14 is a diagram of a transformed signal according to an embodiment of this application;

FIG. 15 is a schematic flowchart of a signal processing method according to an embodiment of this application;

FIG. 16 is a schematic flowchart of a signal processing method according to an embodiment of this application;

FIG. 17 is a schematic flowchart of a signal processing method according to an embodiment of this application;

FIG. 18 is a signaling interaction diagram of a signal processing method according to an embodiment of this application;

FIG. 19 is a signaling interaction diagram of a signal processing method according to an embodiment of this application;

FIG. 20 is a diagram of a structure of a signal processing apparatus according to an embodiment of this application;

FIG. 21 is a diagram of a structure of a signal processing apparatus according to an embodiment of this application;

FIG. 22 is a diagram of a structure of a signal processing apparatus according to an embodiment of this application;

FIG. 23 is a diagram of a hardware structure of a signal processing apparatus according to an embodiment of this application; and

FIG. 24 is a diagram of a hardware structure of a signal processing apparatus according to an embodiment of this application.

### DESCRIPTION OF EMBODIMENTS

In this application, “at least one” means one or more, and “a plurality of” means two or more. The term “and/or” describes an association relationship between associated objects, and represents that three relationships may exist. For example, A and/or B may represent the following cases: Only A exists, both A and B exist, and only B exists, where A and B may be singular or plural. The character “/” generally indicates an “or” relationship between the associated objects. The expression “at least one of the following items (pieces)” or a similar expression thereof indicates any combination of these items, including a single item (piece) or any combination of a plurality of items (pieces). For example, at least one of a, b, or c may represent: a, b, c, a combination of a and b, a combination of a and c, a combination of b and c, or a combination of a, b and c, where each of a, b, and c may be in a singular form or a plural form. In addition, terms “first” and “second” are merely used for a purpose of description, and shall not be understood as an indication or implication of relative importance. An orientation or a position relationship indicated by the term such as “center”, “vertical”, “horizontal”, “up”, “down”, “left”, “right”, “front”, or “back” is based on an orientation or a position relationship shown in the accompanying drawings, and is merely intended to facilitate description of this application and simplify description, but does not indicate or imply that a specified apparatus or element needs to have a specific orientation and be constructed and operated in a specific orientation. Therefore, such terms should not be construed as limitations to this application.

This application provides a signal processing method, so that redundant information in a signal can be removed by fully using an electromagnetic characteristic of an electromagnetic signal in combination with one or more dimensions of the signal, thereby improving signal transform efficiency, facilitating signal transmission, information processing, and signal reconstruction, and improving signal reconstruction precision.

The signal processing method in this application may be applied to a communication system. The communication system may include but is limited to a wireless communication system, for example, a narrowband-Internet of things (narrowband-Internet of things, NB-IoT) system, a global system for mobile communications (global system for mobile communications, GSM), an enhanced data rate for GSM evolution system (enhanced data rate for GSM evolution, EDGE), a wideband code division multiple access system (wideband code division multiple access, WCDMA), a code division multiple access 2000 system (code division multiple access, CDMA2000), a time division-synchronous code division multiple access system (time division-synchronous code division multiple access, TD-SCDMA), a long term evolution system (long term evolution, LTE), a 5th generation mobile communications (the 5th generation mobile communications technology, 5G) system, or a future 6G system.

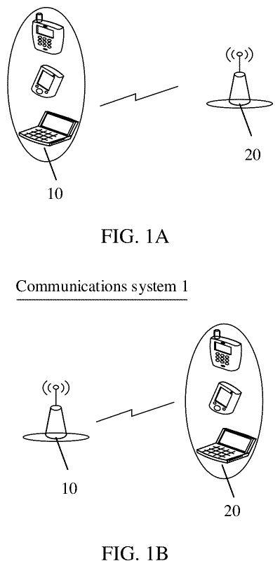

FIG. 1A and FIG. 1B are diagrams of architectures of a communication system according to an embodiment of this application.

As shown in FIG. 1A and FIG. 1B, the communication system 1 in this application may include a first device 10 and a second device 20. The first device 10 and the second device 20 may communicate with each other.

The first device 10 may be used as a sending device, and is configured to perform at least one of sensing, imaging, or positioning on an ambient environment (for example, a target object and/or a target environment) by using an electromagnetic signal, and implement signal collection, signal transform, and signal transmission.

The first device 10 may collect a signal formed after the electromagnetic signal is reflected by the ambient environment. Then, the first device 10 may transform the collected signal, and may transmit a transformed signal to the second device 20.

Correspondingly, the second device 20 may be used as a central node, and is configured to implement information processing and signal reconstruction.

The second device 20 may receive the transformed signal from the first device 10. Then, the second device 20 may de-transform the transformed signal to obtain a reconstructed signal. This facilitates offline or real-time modeling and analysis on the ambient environment.

The transform and de-transform are inverse processes to each other.

In addition, specific implementations of the first device 10 and the second device 20 are not limited in this application.

In some embodiments, the first device 10 may include but is not limited to, for example, a terminal device (such as user equipment (user equipment, UE)), a sensor, or a network device such as a base station (base station, BS). The second device 20 may include but is not limited to, for example, a server, a cloud computing center, a network device such as a BS, or a device with strong computing power.

The terminal device may be a wireless terminal or a wired terminal. The wireless terminal may be a device that provides a user with voice and/or other service data connectivity, a handheld device with a wireless connection function, or another processing device connected to a wireless modem. The wireless terminal may communicate with one or more core networks through a radio access network (Radio Access Network, RAN). The wireless terminal may be a mobile terminal, for example, a mobile phone (or referred to as a “cellular” phone) or a computer having a mobile terminal, for example, may be a portable, pocket-sized, handheld, computer built-in, or in-vehicle mobile apparatus, which exchanges a voice and/or data with the radio access network, for example, a device such as a personal communications service (personal communications service, PCS) phone, a cordless phone, a session initiation protocol (session initiation protocol, SIP) phone, a wireless local loop (wireless local loop, WLL) station, a personal digital assistant (personal digital assistant, PDA), an uncrewed aerial vehicle, a wearable device, or a terminal in the Internet of vehicles. The wireless terminal may also be referred to as a system, a subscriber unit (subscriber unit), a subscriber station (subscriber station), a mobile station (mobile station), a mobile (mobile), a remote station (remote station), a remote terminal (remote terminal), an access terminal (access terminal), a user terminal (user terminal), a user agent (user agent), a user device (user device or user equipment), or user equipment (user equipment, UE). This is not limited herein. In addition, the terminal device may use a mobile operating system such as ios, Android, or HarmonyOS. This is not limited in this embodiment of this application.

The network device may be a base station, an access point, an access network device, or a device that is in an access network and that communicates with a wireless terminal through one or more sectors over an air interface. The network device may be configured to mutually convert a received over-the-air frame and an IP packet and serve as a router between the wireless terminal and a rest portion of the access network, where the rest portion of the access network may include an Internet protocol (IP) network. The network device may further coordinate attribute management on the air interface. For example, the network device may be a satellite, an uncrewed aerial vehicle, a base transceiver station (base transceiver station, BTS) in a global system for mobile communications (global system of mobile communications, GSM) or code division multiple access (code division multiple access, CDMA), a NodeB (NodeB, NB) in wideband code division multiple access (wideband code division multiple access, WCDMA), an evolved NodeB (evolved NodeB, eNB or eNodeB) in long term evolution (long term evolution, LTE), a terminal, a relay station, or an access point that undertakes a base station function in V2X (vehicle to everything, vehicle to everything), device-to-device (Device-to-Device, D2D) communication, or machine-to-machine communication (Machine-to-Machine, M2M), a base station in a 5G network, for example, a gNB, or a base station in a future 6G network. This is not limited herein.

In a network structure, the network device may include a central unit (central unit, CU) node or a distributed unit (distributed unit, DU) node, a RAN device including a CU node and a DU node, or a RAN device including a control plane CU node (CU-CP node), a user plane CU node (CU-UP node), and a DU node.

For ease of description, in FIG. 1A, for example, the first device 10 is UE and the second device 20 is a BS. In FIG. 1B, for example, the first device 10 is a BS, and the second device 20 is UE.

In addition, the electromagnetic signal may be transmitted by a sending device to the ambient environment.

A specific implementation of the sending device is not limited in this application.

In some embodiments, the first device 10 may be further used as the sending device to transmit the electromagnetic signal, so that the signal is transmitted.

In some other embodiments, the communication system 1 may further include a third device (not shown in FIG. 1A or FIG. 1). The first device 10 and the third device may communicate with each other, and the third device is different from the first device 10.

The third device may be used as the sending device to transmit the electromagnetic signal, so that the signal is transmitted.

In some embodiments, the first device 10 may send a transmit request to the third device, and the transmit request may be used to request to send the electromagnetic signal. A specific implementation of the transmit request is not limited in this application.

Then, after receiving the transmit request, the third device may transmit the electromagnetic signal, so that the first device 10 may receive the signal formed after the electromagnetic signal is reflected by the ambient environment.

A specific implementation of the third device is not limited in this application. In some embodiments, the third device may include but is not limited to, for example, a mobile terminal, a sensor, or a BS.

Next, in the following embodiments of this application, the signal processing method provided in this application is described in detail with reference to accompanying drawings and application scenarios by using the first device and the second device that have the structures shown in FIG. 1A and FIG. 1B as an example.

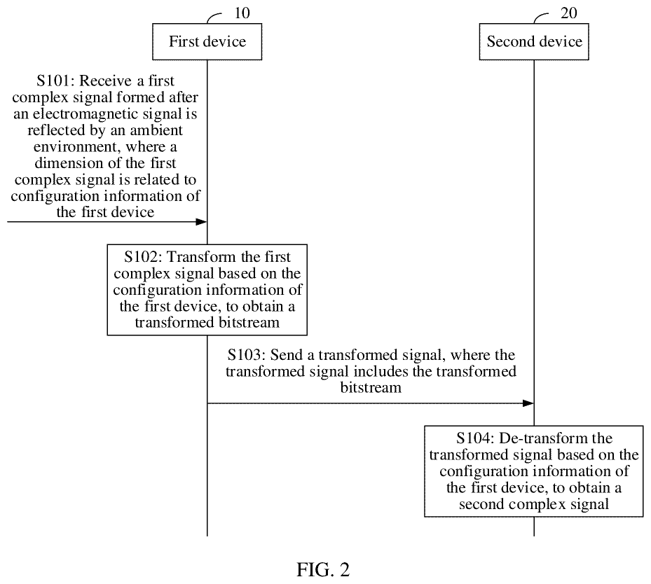

FIG. 2 is a signaling interaction diagram of a signal processing method according to an embodiment of this application.

As shown in FIG. 2, the signal processing method in this application may include the following steps.

S101: The first device receives a first complex signal formed after an electromagnetic signal is reflected by an ambient environment, where a dimension of the first complex signal is related to configuration information of the first device.

After the electromagnetic signal is reflected by the ambient environment, the first device may receive the first complex signal.

A specific implementation of the electromagnetic signal is not limited in this application. In some embodiments, a type of the electromagnetic signal may include at least one of an original electromagnetic signal that can be received by the first device, a signal obtained through imaging processing, or point cloud data used for positioning.

In addition, generally, the first device may receive the first complex signal through a physical layer (physical layer, PHY).

The first complex signal carries the sent electromagnetic signal and an electromagnetic characteristic that represents an ambient environment feature. The first complex signal may include a plurality of pieces of data, and the dimension of the first complex signal may be understood as a dimension corresponding to the data. The dimension of the first complex signal may include but is not limited to a space dimension, a delay-frequency domain dimension, an antenna array dimension, a time dimension, and the like.

The following describes in detail specific implementations of the dimension of the first complex signal.

The space dimension may be used to describe a scanning direction of an antenna element in the first device during signal collection.

The first device may perform scanning in one or more directions (for example, a horizontal direction and/or a vertical direction) by using the antenna element in the first device, to collect data in the space dimension in the first complex signal.

It should be noted that the data in the space dimension may be one-dimensional (1D (dimension)) or multi-dimensional (for example, 2D or 5D) data. For example, if the antenna element performs scanning in the horizontal direction and the vertical direction, the data in the space dimension is 2D data.

The delay-frequency domain dimension may include a delay domain dimension and a frequency domain dimension.

The delay domain dimension may be used to describe signal sampling points corresponding to different delays in a signal collected by the first device at a time. Data in the delay domain dimension and data in the frequency domain dimension can be converted to each other through discrete Fourier transform (discrete fourier transform, DFT) and inverse discrete Fourier transform (inverse discrete fourier transform, IDFT).

The first device may use a signal sampling point (that is, a delay domain signal) corresponding to a delay in collecting the first complex signal or a frequency domain signal converted from the signal sampling point as data in the delay-frequency domain dimension in the first complex signal.

The antenna array dimension may be used to describe an antenna element used when the first device collects a signal.

The first device may obtain, based on an actual situation of an antenna element in the first device, data in the antenna array dimension in the first complex signal. For example, when A antenna arrays are configured in the antenna element, an antenna array dimension size of the antenna element is A. A is a positive integer.

The time dimension may be used to describe different moments (also referred to as times in this application) on a macro scale at which the first device collects a signal.

The first device may use a time at which the first complex signal is collected as data in the time dimension in the first complex signal.

It should be noted that the time dimension is a macro concept, and corresponds to different moments (also referred to as times in this application). The delay domain in the delay-frequency domain dimension is a micro concept, and corresponds to signals with different delays that are collected at one moment. For example, in an orthogonal frequency division multiplexing (orthogonal frequency division multiplexing, OFDM) system, a time dimension signal and a frequency dimension signal may be obtained, and a delay domain signal may be obtained through inverse transform on the frequency dimension signal.

It can be learned that the dimension of the first complex signal is related to related information (for example, a manner and/or performance) about signal receiving of the first device.

The configuration information of the first device may represent related information about signal receiving and signal sending of the first device. The configuration information of the first device may include but is not limited to an antenna configuration (such as a quantity, a type, or a layout) of the first device, a software and hardware bearer capability (such as a quantity of carriers, a throughput rate, a quantity of connections, a quantity of pieces of signaling, or a quantity of interfaces that can be supported) of the first device, or an operating configuration (such as an operating bandwidth, a power range, receive and transmit channels, or a duration for signal collection) of the first device.

In conclusion, the dimension of the first complex signal is related to the configuration information of the first device. In some embodiments, the dimension of the first complex signal may be related to at least one of, for example, the antenna configuration of the first device, the quantity of carriers of the first device, or the duration for signal collection of the first device in the configuration information of the first device.

S102: The first device transforms the first complex signal based on the configuration information of the first device, to obtain a transformed bitstream.

Based on descriptions of S101, the first device may obtain, through analysis based on the configuration information of the first device, the related information about signal receiving of the first device. The first device may learn of the dimension of the first complex signal based on the related information about signal receiving of the first device. Then, the first device may transform the first complex signal in combination with one or more dimensions of the first complex signal, to obtain a transformed bitstream.

In addition, the first device may further obtain, through analysis based on the configuration information of the first device, the related information about signal sending of the first device. The first device may determine a transform manner based on the related information about signal sending of the first device and an actual situation (for example, at least one of a single-transmission resource of the first device, a transmission resource of the transformed bitstream, a channel status between the first device and the second device, or related information about signal receiving of the second device).

The single-transmission resource of the first device may indicate a maximum quantity of transformed bitstreams that can be transmitted by the first device at a time. The transmission resource of the transformed bitstream may indicate a quantity of transmission resources required by the first device to send all transformed bitstreams to the second device. The transmission resource mentioned in this application is usually a radio transmission resource.

In addition, the transmission resource of the transformed bitstream may further indicate at least one parameter of, for example, a length range, a maximum length, a minimum length, a distortion amount range (that is, a loss range), a maximum distortion amount, a minimum distortion amount, a compression rate range, a maximum compression rate, or a minimum compression rate of the transformed bitstream.

The transform manner may indicate how the first device transforms the first complex signal. The transform manner may include but is not limited to at least one manner of, for example, compression, expansion, or interleaving.

The compression may include lossy compression or lossless compression. The compression may be performed to reduce a length and/or a quantity of dimensions of a signal, and is usually applicable to a scenario in which transmission resources are insufficient, to help improve a signal transmission rate.

The expansion may be performed to increase a length and/or a quantity of dimensions of a signal, and is usually applicable to a scenario in which a signal-to-noise ratio is low, to help improve robustness during signal transmission on a noisy channel.

The interleaving may be performed to disperse concentrated errors that occur during transmission of a signal, to help improve robustness for the signal on a fading channel and avoid a phenomenon that a large quantity of continuous errors occur in the signal.

Then, the first device may transform the first complex signal in the transform manner in combination with one or more dimensions of the first complex signal, to obtain a transformed bitstream.

When the transform manner is compression, a data amount of the transformed bitstream is less than a data amount of the first complex signal.

It should be noted that the first device usually may transform the first complex signal at a time.

S103: The first device sends a transformed signal to the second device, where the transformed signal includes the transformed bitstream.

Based on descriptions of S102, the first device may include the transformed bitstream into a transformed signal, and send the transformed signal to the second device. A manner for sending the transformed bitstream and a specific implementation of the transformed signal are not limited in this application.

In some embodiments, the first device may compare a size of the single-transmission resource of the first device with a size of the transmission resource of the transformed bitstream, to determine the manner for sending the transformed bitstream.

For a specific implementation of the single-transmission resource of the first device, refer to the foregoing descriptions. Details are not described herein again.

When the single-transmission resource of the first device is greater than or equal to the transmission resource of the transformed bitstream, the first device may determine that the single-transmission resource of the first device is sufficient for transmitting all the transformed bitstreams at a time. Therefore, the first device may choose to send the transformed bitstream at a time.

That is, the first device may include all the transformed bitstreams into a transformed signal, and send the transformed signal to the second device.

When the single-transmission resource of the first device is less than the transmission resource of the transformed bitstream, the first device may determine that the single-transmission resource of the first device is insufficient for transmitting all the transformed bitstreams at a time. Therefore, the first device may choose to send the transformed bitstream at a plurality of times.

That is, in each sending process, the first device may select an adapted transformed bitstream from the transformed bitstream based on the single-transmission resource of the first device, so that a transmission resource of the adapted transformed bitstream is less than or equal to the single-transmission resource of the first device. Then, the first device includes the adapted transformed bitstream into a transformed signal, and sends the transformed signal to the second device until the first device sends all the transformed bitstreams to the second device.

In some other embodiments, the first device may alternatively determine a target transmission resource based on the single-transmission resource of the first device. The target transmission resource may indicate a transmission resource of a transformed bitstream sent by the first device each time.

That is, the first device sends an adapted transformed bitstream to the second device each time based on a same transmission resource (that is, the target transmission resource).

In addition, the target transmission resource may further represent at least one parameter of, for example, a length, a distortion amount, or a compression rate of the bitstream. A specific size of the target transmission resource is not limited in this application.

In each sending process, the first device selects an adapted transformed bitstream from the transformed bitstream based on the target transmission resource, so that a transmission resource of the adapted transformed bitstream is equal to the target transmission resource. Then, the first device includes the adapted transformed bitstream into a transformed signal, and sends the transformed signal to the second device until the first device sends all the transformed bitstreams to the second device.

It should be noted that, in the foregoing two implementations, in a last sending process, a transmission resource of a remaining transformed bitstream may be less than the single-transmission resource or the target transmission resource of the first device. In this case, the first device may send the remaining transformed bitstream to the second device at a time.

In addition, this application includes but is not limited to the foregoing two implementations.

S104: The second device de-transforms the transformed signal based on the configuration information of the first device, to obtain a second complex signal.

Based on descriptions of S101 or S102, the second device may obtain, through analysis based on the configuration information of the first device, the related information about signal receiving of the first device. The second device may learn of the dimension of the first complex signal based on the related information about signal receiving of the first device. Then, the second device may de-transform the transformed signal in combination with one or more dimensions of the first complex signal, to obtain a second complex signal.

In addition, based on descriptions of S101 or S102, the second device may further obtain, through analysis based on the configuration information of the first device, the related information about signal sending of the first device. The second device may determine a transform manner based on the related information about signal sending of the first device and an actual situation. The second device may determine the de-transform manner based on an inverse process of the transform manner.

The transform manner and the de-transform manner are inverse processes to each other. For example, if the transform manner is compression, the de-transform manner is decompression. Alternatively, if the transform manner is expansion, the de-transform manner is de-expansion. If the transform manner is interleaving, the de-transform manner is de-interleaving.

Then, the second device may de-transform the transformed signal in the de-transform manner in combination with one or more dimensions of the first complex signal, to obtain a second complex signal.

The second complex signal may represent an electromagnetic characteristic of an ambient environment feature, that is, reflect the first complex signal formed after the electromagnetic signal is reflected by the ambient environment. When the transform manner is a lossless manner, the second complex signal may be the first complex signal. When the transform manner is a lossy manner, the second complex signal may be a signal related to the first complex signal, and there are some errors between the second complex signal and the first complex signal.

According to the signal processing method provided in this application, the first device receives a first complex signal formed after an electromagnetic signal is reflected by an ambient environment. A dimension of the first complex signal is related to configuration information of the first device. The first device transforms the first complex signal based on the configuration information of the first device, to obtain a transformed bitstream. The first device sends a transformed signal to the second device. The transformed signal includes the transformed bitstream. The second device de-transforms the transformed signal based on the configuration information of the first device, to obtain a second complex signal. In this way, in this application, redundant information in a signal can be removed based on an electromagnetic characteristic of an electromagnetic signal in combination with one or more dimensions of the signal, which facilitates fast transmission of electromagnetic signals between devices, is applicable to signal transmission of sensing, imaging, positioning, or other electromagnetic signals, improves signal transform efficiency, saves radio transmission resources, facilitates information processing, and improves reconstruction precision.

Based on descriptions of the foregoing embodiment, the first device may transform the first complex signal in a transform manner, to implement signal redundancy removal. Correspondingly, the second device may de-transform the transformed signal in a corresponding de-transform manner, to implement signal reconstruction.

The following describes, in detail with reference to a scenario 1, a scenario 2, and a scenario 3, specific implementation processes of transform of the first device and de-transform of the second device.

### Scenario 1

In the scenario 1, the electromagnetic signal may be a narrowband signal (for example, a single-frequency signal). The narrowband signal may be understood as a signal being a pulse in time domain and a point in frequency domain. Correspondingly, after the narrowband signal is reflected by the ambient environment, the first device may receive the first complex signal by using a single antenna array (for example, directional beam, total radiation, or other types may be used) in the antenna element.

Based on the foregoing descriptions, the first complex signal received by the first device may include data in the space dimension and the time dimension. Alternatively, the first complex signal received by the first device may include data in the space dimension.

When the first device receives the first complex signal at a time, a time dimension size is 1. In this case, the data in the space dimension in the first complex signal may be considered as a special example of the data in the space dimension and the time dimension in the first complex signal.

That is, in the first complex signal, each time corresponds to one group of 1D or multi-dimensional data. The first complex signal may or may not include data in the time dimension. This is not limited in this application.

In addition, the dimension of the first complex signal may include but is not limited to the foregoing dimensions.

In conclusion, the first device may determine an initial configuration parameter based on the configuration information of the first device.

The initial configuration parameter may indicate the configuration information of the first device, that is, represent the dimension of the first complex signal. The initial configuration parameter usually may include a parameter that remains unchanged within a period of time, and may be configured in a semi-static or periodic manner.

In some embodiments, the initial configuration parameter may include, for example, a space dimension size and a time dimension size of the first complex signal, and at least one parameter of a block size of block discrete cosine transform (discrete cosine transform, DCT) or DFT or discrete wavelet transform (discrete wavelet transform, DWT), a block quantity of block DCT or DFT or DWT, a phase processing switch, a phase difference order M1, an amplitude processing switch, or an amplitude difference order Q1. M1 and Q1 are positive integers.

DCT and inverse discrete cosine transform (inverse discrete cosine transform, IDCT) are inverse transform to each other. DWT and inverse discrete wavelet transform (inverse discrete wavelet transform, IDWT) are inverse transform to each other.

In conclusion, the first device may transform the first complex signal based on the initial configuration parameter in combination with the space dimension and the time dimension or the space dimension, to obtain the transformed bitstream.

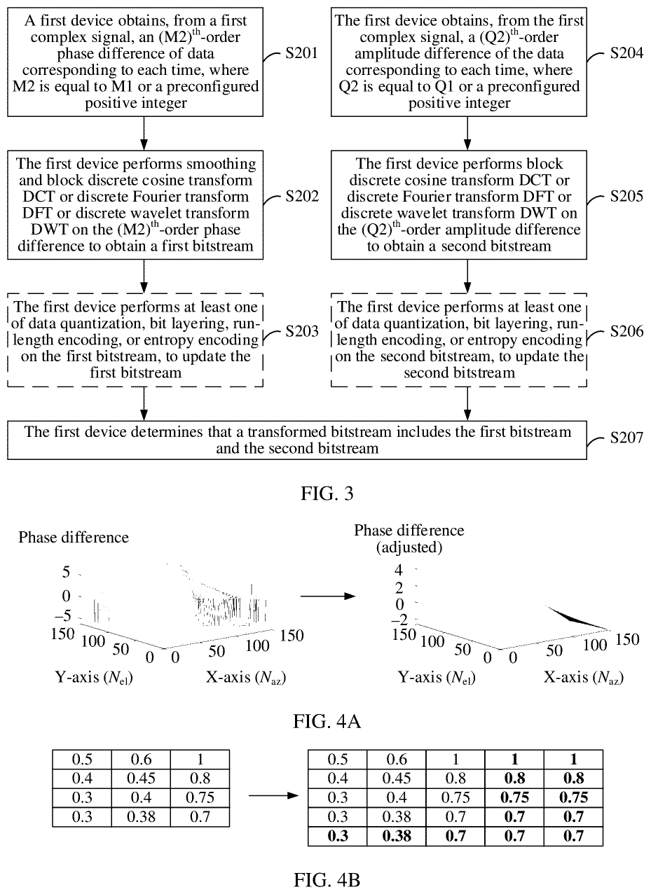

The following describes, in detail with reference to FIG. 3, a specific implementation of signal transform of the first device.

FIG. 3 is a schematic flowchart of a signal processing method according to an embodiment of this application.

As shown in FIG. 3, the signal processing method in this application may include the following steps.

S201: The first device obtains, from the first complex signal, an (M2)^{th}-order phase difference of data corresponding to each time, where M2 is equal to M1 or a preconfigured positive integer.

When the phase processing switch is “on” or the phase processing switch is turned on by default, the first device may transform a phase of the first complex signal in combination with the space dimension and the time dimension or the space dimension.

In some embodiments, the first device may use first data as a reference, and perform a difference operation based on phases of the first data and the data corresponding to each time in the first complex signal, to obtain the (M2)^{th}-order phase difference of the data corresponding to each time in the first complex signal.

When the space dimension and the time dimension are used, the first data may include but is not limited to at least one of, for example, data corresponding to a previous time, data corresponding to a first time, data corresponding to a next time, data corresponding to several times, or preconfigured data obtained based on experience or other factors. When the space dimension is used, the first data may include but is not limited to preconfigured data obtained based on experience or other factors. The data corresponding to each time is data that is in the space dimension and that corresponds to each time. For ease of description, for example, the first data is data corresponding to a previous time. It can be learned that each time in the first complex signal is adjacent to a previous time.

When M2=1, the first device may obtain, from the first complex signal, a phase of the data that is in the space dimension and that corresponds to each time, and then perform, by using a phase of data that is in the space dimension and that corresponds to the previous time as a reference, a difference operation on phases of data that is in the space dimension and that corresponds to adjacent times, to obtain a first-order phase difference.

In some embodiments, the first device may represent the first-order phase difference by using the following expression:

$$∇ Phase @ {T}_{N + 1} = Phase @ {T}_{N + 1} - {Phase}^{′} @ {T}_{N} .$$

∇Phase@T_{N+1} is a first-order phase difference of a time T_{N+1} in the first complex signal, Phase is a phase of data in the space dimension in the first complex signal, a value range of the phase is −π to π, T_{N} and T_{N+1} are adjacent times in the first complex signal, T_{N} is an N^{th} time in the first complex signal, T_{N+1} is an (N+1)^{th} time in the first complex signal, N is a positive integer greater than or equal to 1 and less than or equal to the time dimension size Nₚₖ of the first complex signal, Phase′ is a phase of data in the space dimension in a reconstructed signal, and the reconstructed signal is a signal obtained through simulation that the first complex signal is transformed and then de-transformed.

When M2>1, the first device may obtain, from the first complex signal by using a difference formula with the phase of the data that is in the space dimension and that corresponds to the previous time as a reference, an (M2)^{th}-order phase difference of the data that is in the space dimension and that corresponds to each time.

In some embodiments, the first device may represent the (M2)^{th}-order phase difference by using the following expressions:

$${∇}^{M 2} Phase @ {T}_{N + 1} = {∇}^{M 2 - 1} Phase @ {T}_{N + 1} - {∇}^{M 2 - 1} Phase @ {T}_{N} , and ∇ Phase @ {T}_{2} = Phase @ {T}_{2} - {Phase}^{′} @ {T}_{1} .$$

∇^{M2}Phase@T_{N+1} is an (M2)^{th}-order phase difference of a time T_{N+1} in the first complex signal, ∇^{M2-1}Phase@T_{N+1} is an (M2-1)^{th}-order phase difference of the time T_{N+1} in the first complex signal, ∇^{M2-1}Phase@T_{N} is an (M2-1)^{th}-order phase difference of a time T_{N} in the first complex signal, ∇Phase@T₂ is a first-order phase difference of a time T₂ in the first complex signal, Phase is a phase of data in the space dimension in the first complex signal, a value range of the phase is −π to π, T_{N} and T_{N+1} are adjacent times in the first complex signal, T_{N} is an N^{th} time in the first complex signal, T_{N+1} is an (N+1)^{th} time in the first complex signal, N is a positive integer greater than or equal to 1 and less than or equal to the time dimension size Nₚₖ of the first complex signal, Phase′ is a phase of data in the space dimension in a reconstructed signal, and the reconstructed signal is a signal obtained through simulation that the first complex signal is transformed and then de-transformed.

Then, the first device may obtain the (M2)^{th}-order phase difference of the data corresponding to each time in the first complex signal.

The first device may determine M2 to be equal to M1 in the initial configuration parameter, or may determine M2 to be equal to a preconfigured positive integer. This is not limited in this application.

S202: The first device performs smoothing and block discrete cosine transform DCT or discrete Fourier transform DFT or discrete wavelet transform DWT on the (M2)^{th}-order phase difference to obtain a first bitstream.

After the phase transform of the first complex signal, the (M2)^{th}-order phase difference of the data corresponding to each time is within −2π to 2π. It can be learned that a phenomenon of periodic inversion may occur in the (M2)^{th}-order phase difference of the data corresponding to each time, resulting in violent jitter of the first complex signal, and easily reducing transform efficiency.

Therefore, considering a phase periodicity (usually 27c), the first device may smooth the (M2)^{th}-order phase difference of the data corresponding to each time in the first complex signal, so that jitter of the first complex signal can be reduced, to ensure smoothness of the first complex signal.

The smoothing mentioned in this application may be understood as periodically transforming, by using the first data as a reference, the (M2)^{th}-order phase difference of the data corresponding to each time in the first complex signal, so that a complex space of the first complex signal is compressed (for example, to a half of the complex space). This helps all data in the first complex signal to be located in a concentrated complex space, and ensures smoothness of the signal.

It should be noted that, in this application, a 1-bit (bit) identifier usually may be used to indicate a complex space in which the data corresponding to each time in the first complex signal is located before smoothing, for example, a range [−2π, −π)U[0, π) or a range [−π, 0)U[π, 2π).

In addition, a specific implementation of the periodic transform is not limited in this application.

For ease of description, for example, the data in the space dimension in the first complex signal is 2D data scanned in the horizontal direction and the vertical direction. When the space dimension size of the first complex signal is represented as N_{az}×Nₑₗ, N_{az} is a data size in the horizontal scanning direction of the 2D data, and Nₑₗ is a data size in the vertical scanning direction of the 2D data.

In some embodiments, using 2π as a periodicity, the first device may perform, by using the following expression with the phase of the data that is in the space dimension and that corresponds to the previous time as a reference, periodic transform on the (M2)^{th}-order phase difference of the data corresponding to each time in the first complex signal:

$${Phase}_{ij} @ {T}_{N + 1} - Phase @ {T}_{N} + 2 {k}_{ij , N} π , where 1 \leq i \leq {N}_{az} , 1 \leq j \leq {N}_{el} , and {k}_{ij , N} = \pm 1 , \pm 2 , …$$

In some other embodiments, using π as a periodicity, the first device may perform, by using the following expression with the phase of the data that is in the space dimension and that corresponds to the previous time as a reference, periodic transform on the (M2)^{th}-order phase difference of the data corresponding to each time in the first complex signal:

Phaseᵢⱼ@T_{N+1}−Phase′ᵢⱼ@T_{N}+k_{ij,N}π, where 1≤i≤N_{az}, 1≤j≤Nₑₗ, and k_{ij,N}=±1,±2, . . .

For a value range of k_{ij,N}, refer to data nearby that has been smoothed.

It should be noted that, when the first data is data whose coordinates are (i−1, j−1), that is, Phase_{i-1,j-1}@T_{N+1}−Phase′_{i-1,j-1}@T_{N}+2k_{i-1,j-1,N}π, k_{ij,N} meets that |(Phase_{i-1,j-1}@T_{N+1}−Phase′_{i-1,j-1}@T_{N}+2k_{i-1,j-1,N}π)−(Phaseᵢⱼ@T_{N+1}−Phase′ᵢⱼ@T_{N}+2k_{ij,N}π)| is minimized, so that smoothness of the signal can be ensured.

In addition, other than the foregoing reference, one or more other pieces of data may be selected as the first data. For example, when the first data is data whose coordinates are (i, j−1), (i−1, j), and (i−1, j−1), k_{ij,N} meets that (Phase_{i,j-1}@T_{N+1}−Phase′_{i,j-1}@T_{N}+2k_{i,j-1,N}π)−(Phaseᵢⱼ@T_{N+1}−Phase′ᵢⱼ@T_{N}+2k_{ij,N}π)|+|(Phase_{i-1,j}@T_{N+1}−Phase′_{i-1,j}@T_{N}+2k_{i-1,j,N}π)−(Phaseᵢⱼ@T_{N+1}−Phase′ᵢⱼ@T_{N}+2k_{ij,N}π)|+|(Phase_{i-1,j-1}@T_{N+1}-Phase′_{i-1,j-1}@T_{N}+2k_{i-1,j-1,N}π)−(Phaseᵢⱼ@T_{N+1}−Phase′ᵢⱼ@T_{N}+2k_{ij,N}π)| is minimized, so that smoothness of the signal can be ensured.

For example, the space dimension size of the first complex signal is N_{az}×Nₑₗ. As shown in FIG. 4A, an X axis represents the horizontal scanning direction of the 2D data, whose data size is N_{az}, a Y axis represents the vertical scanning direction of the 2D data, whose data size is Nₑₗ, and a Z axis represents the (M2)^{th}-order phase difference (Phase difference) of the data corresponding to each time in the first complex signal or a smoothed (M2)^{th}-order phase difference (Phase difference (adjusted)) of the data corresponding to each time in the first complex signal.

As shown in a left diagram in FIG. 4A, the (M2)^{th}-order phase difference of the data that is in the space dimension and that corresponds to each time in the first complex signal is within −2π to 2π. It can be learned that the phase difference of the first complex signal changes violently.

As shown in a right diagram in FIG. 4A, the (M2)^{th}-order phase difference that is in the space dimension, that corresponds to each time in the first complex signal, and that is obtained through phase difference smoothing is within a range of −π to π. It can be learned that the smoothed phase difference of the first complex signal does not change violently, and transform efficiency can be improved.

It is assumed that in the first complex signal, an (M2)^{th}-order phase difference of data 1 that is in the space dimension and that corresponds to a time 1 is A1, and an (M2)^{th}-order phase difference of data that is in the space dimension and that corresponds to a time 2 is A2.

When A1 is close to −2π, and A2 is close to 2π, it can be learned that positions of the data 1 and the data 2 in a complex space dimension are actually very close. Therefore, the first device may add 2π to A1, and subtract 2π from A2, so that the data 1 and the data 2 can be located in a concentrated complex space, to implement a smoothing operation of the first complex signal, thereby helping eliminate jitter of the first complex signal.

Then, the first device may perform, in the first complex signal, block DCT or DFT or DWT on the (M2)^{th}-order phase difference that is obtained through data smoothing and that corresponds to each time, to obtain the first bitstream.

The block DCT is used as an example. The first device may divide, based on a block size or a block quantity of the block DCT, the (M2)^{th}-order phase difference that is obtained through data smoothing and that corresponds to each time in the first complex signal, to obtain a plurality of space blocks. Each space block is data in the space dimension.

When a size of a last space block does not match the block size of the block DCT, the first device may pad data of the last space block, so that the size of the last space block is the block size of the block DCT.

FIG. 4B is a diagram of effects before and after space block padding according to an embodiment of this application.

As shown in a left diagram in FIG. 4B, the size of the last space block is 3*4.

For example, the block size of the block DCT is 5*5. As shown in a right diagram in FIG. 4B, the first device performs replication and padding on the last space block. For example, the first device first performs replication and padding on a fourth column and a fifth column based on a last column of data of the last space block, and then performs replication and padding on a fifth row based on a last row of data of the last space block that is padded, so that the size of the first complex signal changes from 3*4 to 5*5.

In conclusion, redundant information in the first complex signal is removed through the phase transform of the first complex signal, so that the first bitstream more accurately represents change intensity of the first complex signal, and it is ensured that the first bitstream effectively and purely carries the electromagnetic characteristic of the ambient environment feature.

S203: The first device performs at least one of data quantization, bit layering, run-length encoding, or entropy encoding on the first bitstream, to update the first bitstream.

It should be noted that, S203 is an optional step. In addition, S201 to S203 are performed sequentially.

In some embodiments, in addition to the smoothing and block DCT or DFT or DWT, the first device may further continue to perform at least one of data quantization, bit layering, run-length encoding, or entropy encoding on the first bitstream, to update the first bitstream.

The data quantization may be performed to quantize a real part or an imaginary part of a real number, or an amplitude or a phase, that is, convert consecutive real numbers into a finite quantity of bits (that is, a width) or a discrete bitstream, to implement bitstream discretization.

A specific implementation of the data quantization is not limited in this application.

In some embodiments, a data quantization type is related to a data distribution status before data quantization and a channel status between the first device and the second device. This matches different data distribution statuses and different channel statuses, thereby achieving better data quantization precision.

For example, the first device may learn of the data quantization type by using a quantization option Fq. The quantization option Fq may be configured in a semi-static or dynamic manner.

When Fq=0, the data quantization type is uniform scalar quantization.

When Fq=1, the data quantization type is non-uniform scalar quantization.

When Fq=2, the data quantization type is uniform vector quantization, for example, uniform quantization based on trellis coding (TCQ w/uniform codebook). Trellis coded quantization is trellis coded quantization, TCQ for short.

When Fq=3, the data quantization type is non-uniform vector quantization, for example, non-uniform quantization based on trellis coding (TCQ w/non-uniform codebook).

The scalar quantization operation is simple, and the vector quantization has a low error and high efficiency. The foregoing TCQ algorithm may use a Viterbi algorithm, and is less complex than other vector quantization.

When data is uniformly distributed before data quantization, the data quantization type may be uniform quantization. On the contrary, the data quantization type may be non-uniform quantization, to improve performance.

If uniform quantization is performed, the first device and the second device may obtain, based on a data quantization parameter, a bitstream after data quantization. The data quantization parameter may include a quantity of quantized bits and a value range. The data quantization parameter may indicate a data quantization width. The data quantization parameter may be configured in a semi-static or dynamic manner.

If non-uniform quantization is performed, the first device may obtain a bitstream after quantization through calculation based on a data distribution status by using a Lloyd algorithm. A parameter, such as a length, of the bitstream after quantization needs to be sent to the second device by using signaling. Related information of the bitstream after quantization may be configured in a semi-static or periodic manner, so that transmission overheads can be reduced.

When the channel status between the first device and the second device is poor, the data quantization type may be scalar quantization, so that error transfer can be avoided, blocks do not affect each other, robustness is better, and complexity is lower. On the contrary, the data quantization type may be TCQ-based vector quantization, so that a quantization error can be reduced by TCQ.

The block mentioned above may be a space block or a space-delay block.

The bit layering may be performed to collect statistics on a most significant bit, a least significant bit, and different layers of a bitstream, to implement bitstream layering and improve transform efficiency. A specific implementation of the bit layering is not limited in this application.

The run-length encoding may be performed to remove a zero in a bitstream, to implement bitstream compression. A specific implementation of the run-length encoding is not limited in this application.

The entropy encoding may be performed to compress a bitstream. An entropy encoding type may include but is not limited to Shannon (Shannon) coding, Huffman (Huffman) coding, and arithmetic coding (arithmetic coding).

Based on the foregoing descriptions, the initial configuration parameter may further include at least one parameter of a data quantization processing switch, a data quantization type, a data quantization parameter, a bit layering processing switch, a run-length encoding processing switch, an entropy encoding processing switch, an entropy encoding type, or the like.

Then, the first device may perform at least one of data quantization, bit layering, run-length encoding, or entropy encoding on the first bitstream based on the initial configuration parameter.

It should be noted that this application includes but is not limited to the operation in S203, and may further include an operation such as a direct current coefficient difference operation. In this way, a data amount can be reduced.

S204: The first device obtains, from the first complex signal, a (Q2)^{th}-order amplitude difference of the data corresponding to each time, where Q2 is equal to Q1 or a preconfigured positive integer.

When the amplitude processing switch is “on” or the amplitude processing switch is turned on by default, the first device may transform an amplitude of the first complex signal in combination with the space dimension and the time dimension or the space dimension. The amplitude of the first complex signal may indicate signal strength, represented in, for example, a form of a dB domain amplitude or a linear domain. In addition, Q2 and M2 may be the same or different.

In some embodiments, the first device may use second data as a reference, and perform a difference operation based on amplitudes of the second data and the data corresponding to each time in the first complex signal, to obtain the (Q2)^{th}-order amplitude difference of the data corresponding to each time in the first complex signal.

The second data may include but is not limited to at least one of, for example, data corresponding to a previous time, data corresponding to a first time, data corresponding to a next time, data corresponding to several times, or preconfigured data obtained based on experience or other factors. The data corresponding to each time is data that is in the space dimension and that corresponds to each time.

For ease of description, for example, the second data is data corresponding to a previous time. It can be learned that each time in the first complex signal is adjacent to a previous time.

When Q2=1, the first device may obtain, from the first complex signal, a dB domain amplitude of the data that is in the space dimension and that corresponds to each time, and then perform, by using a phase of data that is in the space dimension and that corresponds to the previous time as a reference, a difference operation on dB domain amplitudes of data that is in the space dimension and that corresponds to adjacent times, to obtain a first-order amplitude difference.

In some embodiments, the first device may represent the first-order amplitude difference by using the following expression:

$$∇ Amp @ {T}_{N - 1} = {Amp}_{dB} @ {T}_{N + 1} - {Amp}_{dB}^{′} @ {T}_{N} .$$

∇Amp@T_{N+1} is a first-order amplitude difference of a time T_{N+1} in the first complex signal, Amp is a dB domain amplitude of data in the space dimension in the first complex signal, T_{N} and T_{N+1} are adjacent times in the first complex signal, T_{N} is an N^{th} time in the first complex signal, T_{N+1} is an (N+1)^{th} time in the first complex signal, N is a positive integer greater than or equal to 1 and less than or equal to the time dimension size Nₚₖ of the first complex signal, Amp′ is a dB domain amplitude of data in the space dimension in a reconstructed signal, and the reconstructed signal is a signal obtained through simulation that the first complex signal is transformed and then de-transformed.

When Q2>1, the first device may obtain, from the first complex signal by using a difference formula with the phase of the data that is in the space dimension and that corresponds to the previous time as a reference, a (Q2)^{th}-order amplitude difference of the data that is in the space dimension and that corresponds to each time.

In some embodiments, the first device may represent the (Q2)^{th}-order amplitude difference by using the following expressions:

$${∇}^{Q 2} Amp @ {T}_{N + 1} = {∇}^{Q 2 - 1} Amp @ {T}_{N + 1} - {∇}^{Q 2 - 1} Amp @ {T}_{N} , and ∇ Amp @ {T}_{2} = Amp @ {T}_{2} - {Amp}^{′} @ {T}_{1} .$$

∇^{Q2}Amp@T_{N+1} is a (Q2)^{th}-order amplitude difference of a time T_{N+1} in the first complex signal, ∇^{Q2-1}Amp@T_{N+1} is a (Q2-1)^{th}-order amplitude difference of the time T_{N+1} in the first complex signal, ∇^{Q2-1}Amp@T_{N} is a (Q2-1)^{th}-order amplitude difference of a time T_{N} in the first complex signal, ∇Amp@T₂ is a first-order amplitude difference of a time T₂ in the first complex signal, Amp is a dB domain amplitude of data in the space dimension in the first complex signal, T_{N} and T_{N+1} are adjacent times in the first complex signal, T_{N} is an N^{th} time in the first complex signal, T_{N+1} is an (N+1)^{th} time in the first complex signal, N is a positive integer greater than or equal to 1 and less than or equal to the time dimension size Nₚₖ of the first complex signal, Amp′ is a dB domain amplitude of data in the space dimension in a reconstructed signal, and the reconstructed signal is a signal obtained through simulation that the first complex signal is transformed and then de-transformed.

Then, the first device may obtain the (Q2)^{th}-order amplitude difference of the data corresponding to each time in the first complex signal.

The first device may determine Q2 to be equal to Q1 in the initial configuration parameter, or may determine Q2 to be equal to a preconfigured positive integer. This is not limited in this application.

S205: The first device performs block discrete cosine transform DCT or discrete Fourier transform DFT or discrete wavelet transform DWT on the (Q2)^{th}-order amplitude difference to obtain a second bitstream.

After the amplitude transform of the first complex signal, the first device may perform block DCT or DFT or DWT on the (Q2)^{th}-order amplitude difference of the data corresponding to each time in the first complex signal, to obtain a second bitstream.

In conclusion, redundant information in the first complex signal is removed through the amplitude transform of the first complex signal, so that the second bitstream more accurately represents change intensity of the first complex signal, and it is ensured that the second bitstream effectively and purely carries the electromagnetic characteristic of the ambient environment feature.

S206: The first device performs at least one of data quantization, bit layering, run-length encoding, or entropy encoding on the second bitstream, to update the second bitstream.

It should be noted that, S206 is an optional step. In addition, S204 to S206 are performed sequentially. S201 and S204 are not necessarily performed in a specific time sequence, and S201 and S204 may be performed simultaneously or sequentially.

For a specific implementation of S206, refer to descriptions of the embodiment of S203. Details are not described herein again.

In addition, the initial configuration parameter may further include at least one parameter of a data quantization processing switch, a data quantization type, a data quantization parameter, a bit layering processing switch, a run-length encoding processing switch, an entropy encoding processing switch, an entropy encoding type, or the like.

S207: The first device determines that the transformed bitstream includes the first bitstream and the second bitstream.

When the first device does not perform S203 or S206, the first device may splice bitstreams that are in the first bitstream and the second bitstream and that are at a same time, to obtain the transformed bitstream. A time corresponding to the transformed bitstream is consistent with the data in the time dimension in the first complex signal.

When the first device performs S203 and S206, the first device may splice bitstreams that are in the first bitstream and the second bitstream and that are at a same time, and retain bitstreams that are in the first bitstream and the second bitstream and that are at different times, to obtain the transformed bitstream. A time range corresponding to the transformed bitstream is less than or equal to a range of the data in the time dimension in the first complex signal.

In conclusion, the first device may perform phase and amplitude transform on the first complex signal, to remove redundant information in the first complex signal as a whole, and shorten a transmission length of the transformed bitstream, making it more convenient to transmit and process the transformed bitstream.

Then, the first device may include the transformed bitstream into a transformed signal and send the transformed signal to the second device.

In addition, in the scenario 1, the transformed signal may further include first signaling. The first signaling may indicate a transmission length of the transformed bitstream and/or a total length of the transformed bitstream.

The total length of the transformed bitstream indicates a length of all the transformed bitstreams. After obtaining all the transformed bitstreams, the first device may determine the total length of the transformed bitstream.

In this way, the first device may notify the second device of the total length of all the transformed bitstreams, so that the second device can determine whether all the transformed bitstreams (that is, a complete transformed bitstream) are received.

The transmission length of the transformed bitstream indicates a length of a transformed bitstream in a transformed signal transmitted by the first transmission to the second transmission each time. Based on descriptions of the embodiment of S103, the first device may determine a corresponding transmission length of the transformed bitstream based on a manner of sending the transformed signal.

In this way, the first device may notify the second device of a transmission length of a transformed bitstream in each transmission, so that the second device can determine whether a transformed bitstream of a corresponding transmission length is received each time, and the second device can further determine whether all the transformed bitstreams are received.

When the transformed bitstream is transmitted based on the single-transmission resource of the first device, the first device may determine a transmission length of an adapted transformed bitstream based on the single-transmission resource of the first device. The single-transmission resource of the first device may be learned of in advance, or may be learned of from the second device. This is not limited in this application.

When the transformed bitstream is transmitted based on the target transmission resource, the first device may learn of the target transmission resource in advance. Therefore, the first device may learn of the transmission length of the transformed bitstream in advance. Then, before any sending process, the first device may determine a transmission length of an adapted transformed bitstream based on the target transmission resource.

In addition, when the transformed bitstream is sent at a time, the transmission length of the transformed bitstream is the total length of the transformed bitstream. Therefore, the first signaling may indicate the transmission length of the transformed bitstream or the total length of the transformed bitstream. In this way, the second device may obtain the second complex signal through reconstruction based on the transformed signal.

When the transformed bitstream is sent at a plurality of times, transformed bitstreams sent at different times may have a same length, or may have different lengths. Therefore, the first signaling may indicate the transmission length of the transformed bitstream, or the total length of the transformed bitstream, or the transmission length of the transformed bitstream and the total length of the transformed bitstream. In this way, the second device may obtain the second complex signal through reconstruction based on the transformed signal.

FIG. 5 is a diagram of a transformed signal according to an embodiment of this application.

It is assumed that a data size N_{az}×Nₑₗ×Nₚₖ of the first complex signal is 150*150*301.

In this case, the initial configuration parameter may include: the space dimension size of the first complex signal is 150*150, the time dimension size of the first complex signal is 301, the block size of the block DCT is 5*5, the block quantity of the block DCT is 30, the phase processing switch is “on”, the phase difference order M1 is 1, the amplitude processing switch is “on”, the amplitude difference order Q1 is 1, the data quantization processing switch is “on”, the data quantization type is non-uniform scalar quantization, the data quantization parameter is 8-bit quantization, the run-length encoding processing switch is “on”, the bit layering processing switch is “on”, the entropy encoding processing switch is “on”, and the entropy encoding type is arithmetic coding.

Based on descriptions of the embodiment in FIG. 3, the first device may obtain the first-order phase difference and the first-order amplitude difference of the data corresponding to each time in the first complex signal.

The first device may perform smoothing and block DCT on the first-order phase difference of the data corresponding to each time in the first complex signal, to obtain a first bitstream. The first device may perform block DCT on the first-order amplitude difference of the data corresponding to each time in the first complex signal, to obtain a second bitstream.

During the block DCT, 5*5 space blocks are first obtained through division, and then DCT is performed on each space block.

The first device may perform data quantization, bit layering, run-length encoding, and entropy encoding on the first bitstream and the second bitstream respectively, to update the first bitstream.

In the update process, 8-bit non-uniform scalar quantization is first performed, then run-length encoding is performed on alternating current coefficients of DCT transform coefficients in the second bitstream, a difference operation is performed on direct current coefficients of the DCT transform coefficients in the second bitstream (for example, a difference between direct current coefficients of adjacent blocks obtained through the block DCT may be obtained), and arithmetic coding is performed on all coefficients to update the bitstream.

The DCT transform coefficients may be obtained through the block DCT. The DCT transform coefficients include different frequency components. A DCT transform coefficient of each block may include one direct current coefficient and several alternating current coefficients.

The first device may determine that the transformed bitstream includes the first bitstream and the second bitstream.

Then, the first device may send a transformed signal shown in FIG. 5 to the second device.

In FIG. 5, the transformed signal may include the transformed bitstream (Payload (payload) is used as an example in FIG. 5) and the first signaling (length information (length) of Payload is used as an example in FIG. 5). Payload length may indicate a transmission length of the transformed bitstream and/or a total length of the transformed bitstream.

Based on the foregoing descriptions, the second device may de-transform the transformed bitstream in the transformed signal based on the initial configuration parameter in combination with the space dimension and the time dimension or the space dimension, to obtain the second complex signal.

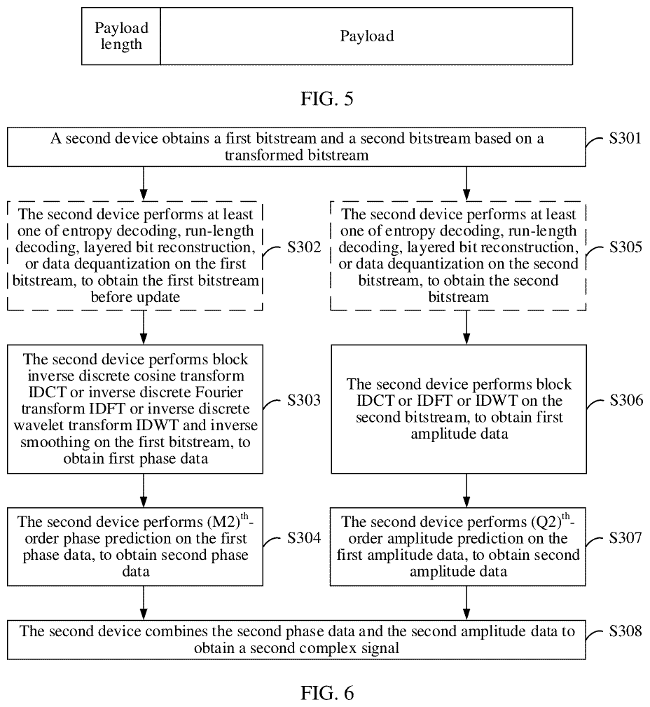

The following describes, in detail with reference to FIG. 6, a specific implementation of de-transform of the second device.

FIG. 6 is a schematic flowchart of a signal processing method according to an embodiment of this application.

As shown in FIG. 6, the signal processing method in this application may include the following steps.

S301: The second device obtains the first bitstream and the second bitstream based on the transformed bitstream.

S301 and S207 in FIG. 3 are inverse processes to each other. For a specific implementation of S301, refer to descriptions of the embodiment of S207 in FIG. 3. Details are not described herein again.

S302: The second device performs at least one of entropy decoding, run-length decoding, layered bit reconstruction, or data dequantization on the first bitstream, to obtain the first bitstream before update.

It should be noted that, S302 is an optional step.

The entropy decoding and entropy encoding, the run-length decoding and run-length encoding, the layered bit reconstruction and bit layering, and the data dequantization and data quantization are all inverse processes to each other.

For a specific implementation of S302, refer to descriptions of the embodiment of S203 in FIG. 3. Details are not described herein again.

S303: The second device performs block inverse discrete cosine transform IDCT or inverse discrete Fourier transform IDFT or inverse discrete wavelet transform IDWT and inverse smoothing on the first bitstream, to obtain first phase data.

It should be noted that, when the 1-bit identifier is received, that is, the smoothing periodicity is π, the second device may determine that an inverse smoothing operation needs to be performed. When the 1-bit identifier is not received, that is, the smoothing periodicity is 2π, the second device may determine that no inverse smoothing operation needs to be performed.

The block IDCT and block DCT, the block IDFT and block DFT, the block IDWT and block DWT, and the inverse smoothing and smoothing are all inverse processes to each other.

For a specific implementation of S303, refer to descriptions of the embodiment of S202 in FIG. 3. Details are not described herein again.

S304: The second device performs (M2)^{th}-order phase prediction on the first phase data, to obtain second phase data.

The (M2)^{th}-order phase prediction and (M2)^{th}-order phase difference calculation are inverse processes to each other.

For a specific implementation of S304, refer to descriptions of the embodiment of S201 in FIG. 3. Details are not described herein again.

It should be noted that S302 to S304 are performed sequentially.

S305: The second device performs at least one of entropy decoding, run-length decoding, layered bit reconstruction, or data dequantization on the second bitstream, to obtain the second bitstream.

It should be noted that, S305 is an optional step.

The entropy decoding and entropy encoding, the run-length decoding and run-length encoding, the layered bit reconstruction and bit layering, and the data dequantization and data quantization are all inverse processes to each other.

For a specific implementation of S305, refer to descriptions of the embodiment of S206 in FIG. 3. Details are not described herein again.

S306: The second device performs block IDCT or IDFT or IDWT on the second bitstream, to obtain first amplitude data.

The block IDCT and block DCT, the block IDFT and block DFT, the block IDWT and block DWT, and the inverse smoothing and smoothing are all inverse processes to each other.

For a specific implementation of S306, refer to descriptions of the embodiment of S205 in FIG. 3. Details are not described herein again.

S307: The second device performs (Q2)^{th}-order amplitude prediction on the first amplitude data, to obtain second amplitude data.

The (Q2)^{th}-order amplitude prediction and (Q2)^{th}-order amplitude difference calculation are inverse processes to each other. For a specific implementation of S307, refer to descriptions of the embodiment of S204 in FIG. 3. Details are not described herein again.

It should be noted that S305 to S307 are performed sequentially. In addition, S303 and S306 are not necessarily performed in a specific time sequence, and S303 and S306 may be performed simultaneously or sequentially.

S308: The second device combines the second phase data and the second amplitude data to obtain the second complex signal.

In conclusion, the second device may reconstruct the second complex signal by de-transforming the transformed signal.

In the scenario 1, the first device may transform the first complex signal in combination with the space dimension and the time dimension or the space dimension through operations such as smoothing and discrete transform on a phase difference and discrete transform on an amplitude difference, which removes redundant information in the first complex signal as a whole, thereby facilitating transmission and processing of the transformed signal and reducing consumption of radio transmission resources. Correspondingly, the second device may de-transform the transformed signal in combination with the space dimension and the time dimension or the space dimension through operations such as inverse discrete transform and inverse smoothing on a phase, phase prediction, inverse discrete transform on an amplitude, and amplitude prediction, thereby facilitating reconstruction of the second complex signal, and improving transform efficiency and reconstruction precision.

### Scenario 2

In the scenario 2, the electromagnetic signal may be a broadband signal (for example, a multi-frequency signal or a multi-carrier signal). Correspondingly, after the broadband signal is reflected by the ambient environment, the first device may receive the first complex signal by using a single antenna (for example, directional beam, total radiation, or other types may be used) in the antenna element.

Based on the foregoing descriptions, the first complex signal received by the first device may include data in the delay-frequency domain dimension and the time dimension. Alternatively, the first complex signal received by the first device may include data in the delay-frequency domain dimension.

When the first device receives the first complex signal at a time, a time dimension size is 1. In this case, the data in the delay-frequency domain dimension in the first complex signal may be considered as a special example of the data in the delay-frequency domain dimension and the time dimension in the first complex signal.

That is, in the first complex signal, each time corresponds to data in the delay-frequency domain dimension. The first complex signal may or may not include data in the time dimension. This is not limited in this application.

In addition, the dimension of the first complex signal may include but is not limited to the foregoing dimensions.

In conclusion, the first device may determine an initial configuration parameter based on the configuration information of the first device.

For a specific implementation of the initial configuration parameter, refer to descriptions in the scenario 1. Details are not described herein again.

In some embodiments, the initial configuration parameter may include, for example, a delay-frequency domain dimension size and a time dimension size of the first complex signal, and at least one parameter of a redundancy removal processing switch, a redundancy removal order P1, or a first transform step configuration. P1 is a positive integer. The first transform step configuration indicates whether data ROI processing and time-correlation-based redundancy removal are executed and a corresponding execution sequence.

In conclusion, the first device may transform the first complex signal based on the initial configuration parameter in combination with the delay-frequency domain dimension and the time dimension or the delay-frequency domain dimension, to obtain the transformed bitstream.

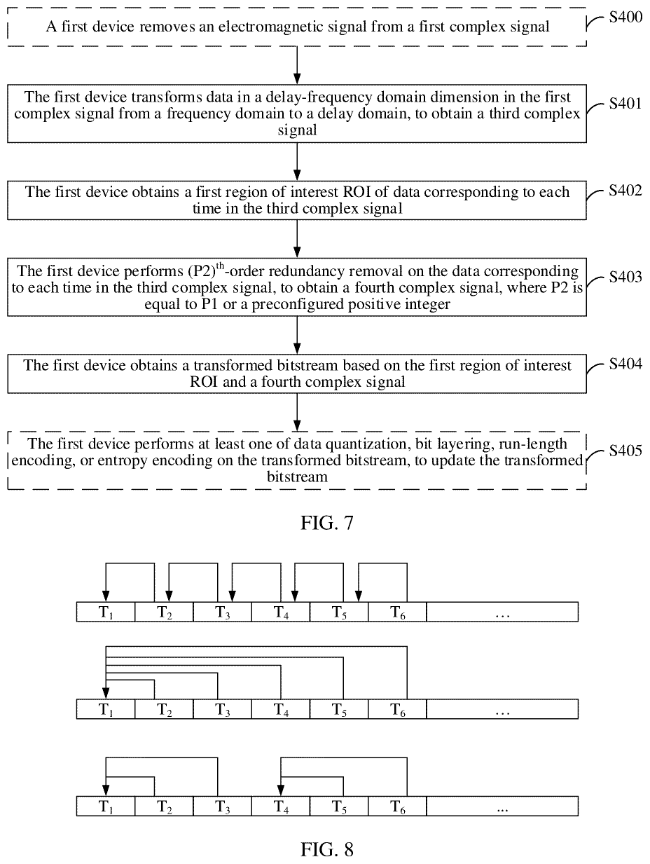

The following describes, in detail with reference to FIG. 7, a specific implementation of signal transform of the first device.

FIG. 7 is a schematic flowchart of a signal processing method according to an embodiment of this application.

As shown in FIG. 7, the signal processing method in this application may include the following steps.

S400: The first device removes the electromagnetic signal from the first complex signal.

It should be noted that, S400 is an optional step.

In the scenario 2, the first complex signal usually includes the original electromagnetic signal. Therefore, the first device may remove the electromagnetic signal from the first complex signal. This avoids a problem of much redundant information existing when the first complex signal is directly transformed.

S401: The first device transforms data in the delay-frequency domain dimension in the first complex signal from a frequency domain to a delay domain, to obtain a third complex signal.

In the scenario 2, the data in the delay-frequency domain dimension in the first complex signal may belong to the frequency domain, or may belong to the delay domain. It is more convenient to transform data belonging to the delay domain. Therefore, the first device may transform the data in the delay-frequency domain dimension in the first complex signal from the frequency domain to the delay domain. This helps construct a sparser signal.

In this way, the first device may preprocess the first complex signal to obtain a third complex signal, so that the third complex signal more purely and only reflects the electromagnetic characteristic of the ambient environment feature.

It should be noted that S400 and S401 are not necessarily performed in a specific time sequence, and may be performed simultaneously or sequentially.

S402: The first device obtains a first region of interest (region of interest, ROI) of data corresponding to each time in the third complex signal.

The first device may perform, in the third complex signal, redundancy removal on data in the delay-frequency domain dimension that is collected at each time, to obtain a first region of interest ROI. In this way, redundant data in the delay-frequency domain dimension in the third complex signal is removed through the foregoing data ROI processing.

The first region of interest ROI indicates non-redundant data in the delay-frequency domain dimension in the third complex signal. The first region of interest ROI may include a data range corresponding to each time. The data range corresponding to each time is not limited in this application.

It may be understood that one time corresponds to one path, one path corresponds to a plurality of taps, and one tap corresponds to signal sampling points corresponding to a plurality of delays.

Based on the foregoing descriptions, the first device may determine that a data range corresponding to any time is a mark range to which taps corresponding to the time belong. The data range herein is a delay domain data range, and the tap herein is a delay domain tap.

In some embodiments, for any time, the first device may obtain power Pₘₐₓ (decibel, dB) of a strongest path from a plurality of paths. Then, the first device may determine that a data range corresponding to the time is a mark range to which a tap whose power is greater than (Pₘₐₓ−ΔP) (dB) belongs. ΔP (dB) is a preset power threshold. This helps filter out noise/interference.

In some other embodiments, for any time, the first device may obtain the first Mₜₐₚ taps with maximum power, to ensure that a percentage of energy of the first Mₜₐₚ taps in total energy of all taps is greater than or equal to a preset threshold. A specific value of the preset threshold is not limited in this application. Then, the first device may determine that a data range corresponding to the time is a mark range to which the Mₜₐₚ taps belong. This helps filter out noise/interference.

In this way, the first device may obtain the first region of interest ROI.

In conclusion, the redundant data in the delay-frequency domain dimension in the third complex signal is removed through data ROI processing, so that a transmission resource of the transformed bitstream can be reduced, and the transformed bitstream can more accurately represent change intensity of the third complex signal, thereby ensuring that the transformed bitstream effectively and purely represents the electromagnetic characteristic of the ambient environment feature.

S403: The first device performs (P2)^{th}-order redundancy removal on the data corresponding to each time in the third complex signal, to obtain a fourth complex signal, where P2 is equal to P1 or a preconfigured positive integer.

When the redundancy removal processing switch is “on” or the redundancy removal processing switch is turned on by default, the first device may perform time-correlation-based redundancy removal on the third complex signal in combination with the delay-frequency domain dimension and the time dimension or the delay-frequency domain dimension.

In some embodiments, the first device may use third data as a reference, and perform (P2)^{th}-order redundancy removal based on the third data and the data corresponding to each time in the third complex signal, to obtain the fourth complex signal.

When the delay-frequency domain dimension and the time dimension are used, the third data may include but is not limited to at least one of, for example, data corresponding to a previous time, data corresponding to a first time, data corresponding to a next time, data corresponding to several times, or preconfigured data obtained based on experience or other factors. When the delay-frequency domain dimension is used, the third data may include but is not limited to preconfigured data obtained based on experience or other factors. The data corresponding to each time is data that is in the delay-frequency domain dimension and that corresponds to each time.

When P2=1, the first device may perform, in the third complex signal by using the third data as a reference, first-order redundancy removal on the data corresponding to each time, to obtain the fourth complex signal.

In some embodiments, when the third data is data corresponding to a previous time, the first device may represent, by using the following expressions, an ROI of data corresponding to each time in the fourth complex signal:

$$Δ {ROI}_{1} = {ROI}_{1} , and {ΔROI}_{N} - {ROI}_{N - 1} = [ {τ}_{min , N} - {τ}_{min , N - 1} , {τ}_{max , N} - {τ}_{max , N - 1} ] , where 2 \leq N \leq {N}_{pk}$$

ΔROI_{N} is an ROI of data corresponding to a time T_{N} in the fourth complex signal, ROI_{N}=[τ_{min,N}, τ_{max,N}] is an ROI of data corresponding to the time T_{N} in the third complex signal, ROI_{N-1}=[τ_{min,N-1}, τ_{max,N-1}] is an ROI of data corresponding to a time T_{N-1} in the third complex signal, T_{N} and T_{N-1} are adjacent times in the third complex signal, T_{N} is an N^{th} time in the third complex signal, T_{N-1} is an (N−1)^{th} time in the third complex signal, and N is a positive integer greater than or equal to 2 and less than or equal to a time dimension size Nₚₖ of the third complex signal.

In this way, signal ROI redundancy removal is implemented by using a change status of different taps of each time.

In some other embodiments, when the third data is data corresponding to a previous time, the first device may represent, by using the following expressions, an ROI of data corresponding to each time in the fourth complex signal:

$$Δ {x}_{1} = {x}_{1} , and Δ {x}_{N} = {x}_{N} - {α}_{N} * {x}_{N - 1}^{′} , where {α}_{N} = {{x}_{N}}^{T} * {x}_{N - 1}^{′} / ( {{x}_{N - 1}^{′}}^{T} * {x}_{N - 1}^{′} ) , and 2 \leq N \leq {N}_{pk} .$$

Δx_{N} is data corresponding to a time T_{N} in the fourth complex signal, x_{N} is data corresponding to the time T_{N} in the third complex signal, T_{N} and T_{N-1} are adjacent times in the third complex signal, T_{N} is an N^{th} time in the third complex signal, T_{N}-1 is an (N−1)^{th} time in the third complex signal, and N is a positive integer greater than or equal to 2 and less than or equal to a time dimension size Nₚₖ of the third complex signal.

α_{N} represents a correlation coefficient between x_{N} and x_{N-1}. For example, a projection manner is used. A value range of α_{N} is [−1, 1]. When α_{N} is 0, it indicates that x_{N} is unrelated to x_{N-1}. When α_{N} is 1 or −1, it indicates that x_{N} is related to x_{N-1}. x′₁ is data obtained by transforming and then de-transforming x₁, x′_{N-1}=Δx′_{N-1}+α_{N-1}*x′_{N-2}, 3≤N≤Nₚₖ, and Δx′_{N-1} is data obtained by transforming and then de-transforming Δx_{N-1}.

In this way, signal redundancy removal is implemented by using correlation between different data at each time.

When P2>1, the first device may perform, by using a difference formula with the third data as a reference, (P2)^{th}-order redundancy removal on the data corresponding to each time, to obtain the fourth complex signal.

The first device may determine P2 to be equal to P1 in the initial configuration parameter, or may determine P2 to be equal to a preconfigured positive integer. This is not limited in this application.

In addition, other than the data corresponding to the previous time, the third data may be data corresponding to a first time, or data corresponding to a time at an interval of several (for example, two) times, or the like.

As shown in a first diagram in FIG. 8, for a time T_{N+1} in the third complex signal, the first device may perform, by using T_{N} as a reference, first-order redundancy removal on data corresponding to the time T_{N+1} and data corresponding to the time T_{N}.

For example, for a time T₄ in the third complex signal, the first device may perform, by using T₃ as a reference, first-order redundancy removal on data corresponding to the time T₄ and data corresponding to the time T₃.

As shown in a second diagram in FIG. 8, for a time T_{N+1} in the third complex signal, the first device may perform, by using T₁ as a reference, first-order redundancy removal on data corresponding to the time T_{N+1} and data corresponding to the time T_{N}.

For example, for a time T₄ in the third complex signal, the first device may perform, by using T₁ as a reference, first-order redundancy removal on data corresponding to the time T₄ and data corresponding to the time T₁.

As shown in a third diagram in FIG. 8, for a time T_{N+1} in the third complex signal, the first device may perform, by using T_{N-1} as a reference, first-order redundancy removal on data corresponding to the time T_{N+1} and data corresponding to the time T_{N-1}.

For example, for a time T₄ in the third complex signal, the first device may perform, by using T₃ as a reference, first-order redundancy removal on data corresponding to the time T₄ and data corresponding to the time T₂.

In conclusion, redundant data that is in the delay-frequency domain dimension and that corresponds to different times in the third complex signal is removed through time-correlation-based redundancy removal, so that a transmission resource of the transformed bitstream can be reduced, and the transformed bitstream can more accurately represent change intensity of the third complex signal, thereby ensuring that the transformed bitstream effectively and purely carries the electromagnetic characteristic of the ambient environment feature.

It should be noted that S402 and S403 are not necessarily performed in a specific time sequence, and S402 and S403 may be performed simultaneously or sequentially.

S404: The first device obtains the transformed bitstream based on the first region of interest ROI and the fourth complex signal.

The first device may obtain the third complex signal in the first region of interest ROI, and splice the third complex signal in the first region of interest ROI and the fourth complex signal to obtain the transformed bitstream.

S405: The first device performs at least one of data quantization, bit layering, run-length encoding, or entropy encoding on the transformed bitstream, to update the transformed bitstream.

It should be noted that, S405 is an optional step.

For a specific implementation of S405, refer to descriptions of the embodiment of S203 in FIG. 3. Details are not described herein again.

In addition, the initial configuration parameter may further include at least one parameter of a data quantization processing switch, a data quantization type, a data quantization parameter, a bit layering processing switch, a run-length encoding processing switch, an entropy encoding processing switch, an entropy encoding type, or the like.

In conclusion, the first device may preprocess the first complex signal and perform transform in the delay-frequency domain dimension and the time dimension, to remove noise/interference and redundant information in the first complex signal, and shorten a transmission length of the transformed bitstream, making it convenient to transmit and process the transformed bitstream.

Then, the first device may include the transformed bitstream into a transformed signal and send the transformed signal to the second device.

In addition, in the scenario 2, the transformed signal further includes second signaling. The second signaling indicates at least one of, for example, a transmission length of the transformed bitstream, a total length of the transformed bitstream, a correlation coefficient for redundancy removal, or a second region of interest ROI.

For specific implementations of the transmission length and the total length of the transformed bitstream, refer to the descriptions in the scenario 1. Details are not described herein again.

When P2=1, the correlation coefficient for redundancy removal is the correlation coefficient α_{N} in the embodiment of S403 in FIG. 7. When P2>1, the correlation coefficient for redundancy removal includes a plurality of correlation coefficients, which may be obtained based on descriptions of the embodiment of S403 in FIG. 7.

The second region of interest ROI indicates the first region of interest ROI, and the second region of interest ROI is obtained by the first device through redundancy removal on the first region of interest ROI. In this way, the first device may transmit the second region of interest ROI to the second device, so that the second device restores the first region of interest ROI for signal reconstruction.

In some embodiments, for any time in the first region of interest ROI, the first device may obtain a maximum mark τₘₐₓ of a tap and a minimum mark τₘᵢₙ of a tap within a data range corresponding to the time, and mark the data range corresponding to the time as [τₘᵢₙ, τₘₐₓ]. In this way, simplified marking of the first region of interest ROI is implemented, and a tap located outside the first region of interest ROI is directly discarded.

Based on the foregoing descriptions, the first device may perform, by using a data range corresponding to a previous time, a data range corresponding to a first time, a data range corresponding to a time at an interval of several times, or the like as a reference, redundancy removal on a data range corresponding to each time in the first region of interest ROI, to implement simplified marking of the second region of interest ROI.

The data range corresponding to the first time is used as a reference. It is assumed that in the first region of interest ROI, a data range corresponding to a time 1 is marked as [5, 30], a data range corresponding to a time 2 is marked as [5, 29], and a data range corresponding to a time 3 is marked as [5, 31].

In this case, in the second region of interest ROI, a data range corresponding to the time 1 may be marked as [5, 30], a data range corresponding to the time 2 may be marked as [0, −1], and a data range corresponding to the time 3 may be marked as [0, 1]. In this way, a transmission resource of the transformed signal can be reduced.

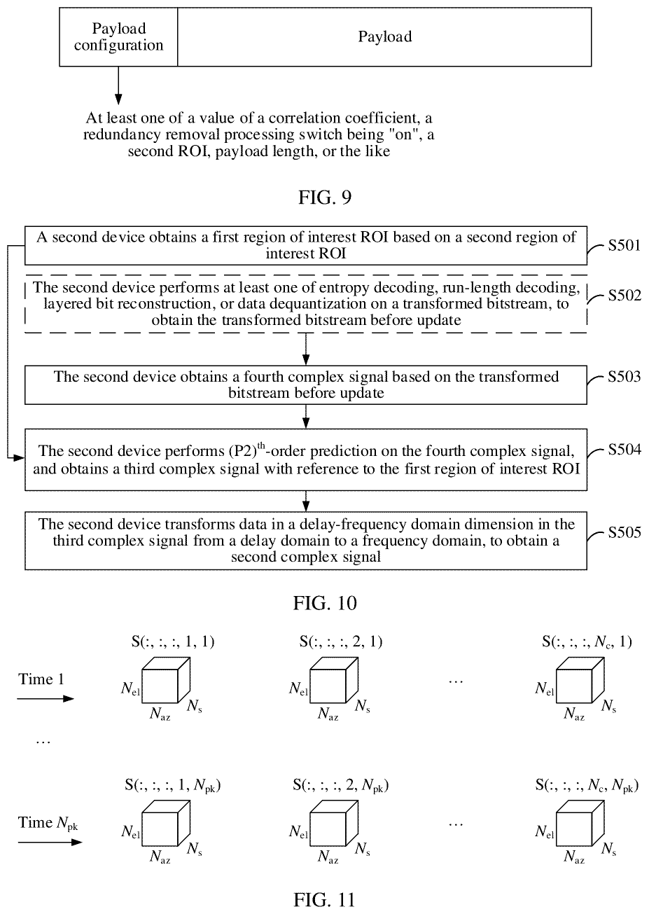

FIG. 9 is a diagram of a transformed signal according to an embodiment of this application.

It is assumed that a data size Nₛ×Nₚₖ of the first complex signal is 601*80.

In this case, the initial configuration parameter may include: the delay-frequency domain dimension size of the first complex signal is 601, the time dimension size of the first complex signal is 80, the redundancy removal processing switch is “on”, the first transform step configuration is “first performing data ROI processing in S402, and then performing time-correlation-based redundancy removal in S403”, the redundancy removal order P1 is 1, the data quantization processing switch is “on”, the data quantization type is uniform scalar quantization, the entropy encoding processing switch is “on”, and the entropy encoding type is a gzip algorithm (a compression algorithm based on Lempel-Ziv 77 and Huffman coding).

Based on descriptions of the embodiment in FIG. 7, the first complex signal received by the first device may include frequency domain channel response data. In this case, the first device may remove the electromagnetic signal from the first complex signal, and transform the data in the first complex signal from the frequency domain to the delay domain, to obtain a third complex signal.

The first device may obtain the first Mₜₐₚ taps with maximum power from the third complex signal, so that a percentage of energy of the first Mₜₐₚ taps in total energy of all taps exceeds 99% (corresponding to a normalized mean square error (normalized mean square error, NMSE) lower than 10⁻²), to obtain a data range corresponding to each time, that is, a first region of interest ROI. In addition, the first device may perform first-order redundancy removal on data at each time in the third complex signal, to obtain a fourth complex signal.

The first device may obtain a transformed bitstream based on the first region of interest ROI and the fourth complex signal.

The first device performs uniform scalar quantization on a real part and an imaginary part of the transformed bitstream, and then performs entropy encoding by using a gzip algorithm, to update the transformed bitstream.

Then, the first device may send a transformed signal shown in FIG. 9 to the second device.

In FIG. 9, the transformed signal may include the transformed bitstream (Payload (payload) is used as an example in FIG. 9) and the second signaling (configuration information (configuration) of Payload is used as an example in FIG. 9).

The configuration information of Payload may include but is not limited to at least one of preconfigured data of the correlation coefficient, the redundancy removal processing switch being “on”, the second region of interest ROI, length information (length) of Payload, or the like. For a specific implementation of Payload length, refer to the foregoing descriptions. Details are not described herein again.

Based on descriptions of the foregoing embodiment, the second device may de-transform the transformed bitstream in the transformed signal based on the initial configuration parameter in combination with the delay-frequency domain dimension and the time dimension or the delay-frequency domain dimension, to obtain the second complex signal.

The following describes, in detail with reference to FIG. 10, a specific implementation of signal de-transform of the second device.

FIG. 10 is a schematic flowchart of a signal processing method according to an embodiment of this application.

As shown in FIG. 10, the signal processing method in this application may include the following steps.

S501: The second device obtains the first region of interest ROI based on the second region of interest ROI.

A specific implementation of S501 and the foregoing process in which the first device obtains the second region of interest ROI based on the first region of interest ROI are inverse processes to each other, and details are not described herein again.

S502: The second device performs at least one of entropy decoding, run-length decoding, layered bit reconstruction, or data dequantization on the transformed bitstream, to obtain the transformed bitstream before update.

It should be noted that, S502 is an optional step.

The entropy decoding and entropy encoding, the run-length decoding and run-length encoding, the layered bit reconstruction and bit layering, and the data dequantization and data quantization are all inverse processes to each other.

For a specific implementation of S502, refer to descriptions of the embodiment of S405 in FIG. 7. Details are not described herein again.

S503: The second device obtains the fourth complex signal based on the transformed bitstream before update.

A specific implementation of S503 and descriptions of the embodiment of S404 in FIG. 7 are inverse processes to each other, and details are not described herein again.

It should be noted that S501 and S503 are not necessarily performed in a specific time sequence, and S501 and S503 may be performed simultaneously or sequentially.

S504: The second device performs (P2)^{th}-order prediction on the fourth complex signal and obtains the third complex signal in combination with the first region of interest ROI.

The (P2)^{th}-order prediction and (P2)^{th}-order redundancy removal are inverse processes to each other.

For a specific implementation of S504, refer to descriptions of the embodiments of S403 and S404 in FIG. 7. Details are not described herein again.

S505: The second device transforms data in the delay-frequency domain dimension in the third complex signal from the delay domain to the frequency domain, to obtain the second complex signal.

For a specific implementation of S505, refer to descriptions of transforming the data in the delay-frequency domain dimension in the first complex signal from the frequency domain to the delay domain in the embodiment of S401 in FIG. 7. Details are not described herein again.

In conclusion, the second device may reconstruct the second complex signal by de-transforming the transformed signal.

In the scenario 2, the first device may transform the first complex signal in combination with the delay-frequency domain dimension and the time dimension or the delay-frequency domain dimension through operations such as preprocessing, data ROI processing, and time-correlation-based redundancy removal, which removes redundant information in the first complex signal, thereby facilitating transmission and processing of the transformed signal and reducing consumption of radio transmission resources. Correspondingly, the second device may de-transform the transformed signal in combination with the delay-frequency domain dimension and the time dimension or the delay-frequency domain dimension through operations such as signal restoration, ROI prediction, signal prediction, and signal domain change, thereby facilitating reconstruction of the second complex signal, and improving transform efficiency and reconstruction precision.

### Scenario 3

In the scenario 3, the electromagnetic signal may be a broadband signal (for example, a multi-frequency signal or a multi-carrier signal). Correspondingly, after the broadband signal is reflected by the ambient environment, the first device may receive the first complex signal by using one or more antenna arrays (for example, each antenna array may use directional beam, multi-antenna, or other types) in the antenna element.

Based on the foregoing descriptions, the first complex signal received by the first device may include data in the space dimension, the delay-frequency domain dimension, the antenna array dimension, and the time dimension. Alternatively, the first complex signal received by the first device may include data in the space dimension, the delay-frequency domain dimension, and the time dimension.

When the first device receives the first complex signal at a time, a time dimension size is 1.

In this case, data in the space dimension, the delay-frequency domain dimension, and the antenna array dimension in the first complex signal may be considered as a special example of the data in the space dimension, the delay-frequency domain dimension, the antenna array dimension, and the time dimension.

Alternatively, data in the space dimension and the delay-frequency domain dimension in the first complex signal may be considered as a special example of the data in the space dimension, the delay-frequency domain dimension, and the time dimension.

That is, in the first complex signal, each time corresponds to data of each antenna array in the space dimension and the delay-frequency domain dimension.

FIG. 11 is a diagram of a first complex signal according to an embodiment of this application.

For example, a data size of the first complex signal is N_{az}×Nₑₗ×Nₛ×N_{c}×Nₚₖ. As shown in FIG. 11, in the first complex signal, a piece of data (or referred to as a group of data in this application) corresponding to a time T_{N} in an i^{th} antenna array may be represented as S(:, :, :, i, N).

Data of S(:, :, :, i, N) in the space dimension and the delay-frequency domain dimension may be represented by a point in a cube of length N_{az}×width Nₑₗ×height Nₛ, and “:” indicates that all data in a corresponding dimension is obtained.

A space dimension size of the first complex signal is N_{az}×Nₑₗ, a delay-frequency domain dimension size of the first complex signal is Nₛ, an antenna array dimension size of the first complex signal is N_{c}, and a time dimension size of the first complex signal is Nₚₖ.

For example, in the first complex signal, all data corresponding to a time T₁ may include:
S(:, :, :, 1, 1), S(:, :, :, 2, 1), . . . , and S(:, :, :, N_{c}, 1).

In the first complex signal, all data corresponding to a time T_{Npk} may include:
S(:, :, :, 1, Nₚₖ), S(:, :, :, 2, Nₚₖ), . . . , and S(:, :, :, N_{c}, Nₚₖ).

For another example, in the first complex signal, all data corresponding to a first antenna array may include:
S(:, :, :, 1, 1), . . . , and S(:, :, :, 1, Nₚₖ).

In the first complex signal, all data corresponding to a second antenna array may include:
S(:, :, :, 2, 1), . . . , and S(:, :, :, 2, Nₚₖ).

In the first complex signal, all data corresponding to an (N_{c})^{th} group antenna array may include:
S(:, N_{c}, 1), S . . . , and S(:, :, ,N_{c}, Nₚₖ).

In conclusion, at different times, the first device may be located at a same location or orientation, or may be located at different locations or orientations. In this way, the first device may collect the first complex signal that may include the space dimension, the delay-frequency domain dimension, the antenna array dimension, and the time dimension.

The first complex signal may or may not include data in the antenna array dimension. This is not limited in this application. In some embodiments, when the first device collects the first complex signal by using one antenna array, the data in the antenna array dimension may be represented as a number of the antenna array. When the first device collects the first complex signal by using a plurality of antenna arrays, the data in the antenna array dimension may be represented as a number of each antenna array.

In addition, the dimension of the first complex signal may include but is not limited to the foregoing dimensions.

Then, the first device may determine an initial configuration parameter based on the configuration information of the first device.

For a specific implementation of the initial configuration parameter, refer to descriptions in the scenario 1. Details are not described herein again.

In some embodiments, the initial configuration parameter may include, for example, a space dimension size, a delay-frequency domain dimension size, an antenna array dimension size, and a time dimension size of the first complex signal, and at least one of a block size of block DCT or DFT or DWT, a block quantity of block DCT or DFT or DWT, a second transform step configuration, a phase processing switch, a phase difference order K1, an antenna array dimension redundancy removal processing switch, an antenna array dimension redundancy removal order R1, a time dimension redundancy removal processing switch, or an order S1 of the time dimension redundancy removal processing switch. K1, R1, and S1 are positive integers.

In conclusion, the first device may transform the first complex signal based on the initial configuration parameter in combination with the space dimension, the delay-frequency domain dimension, the antenna array dimension, and the time dimension, or the space dimension, the delay-frequency domain dimension, and the antenna array dimension, or the space dimension, the delay-frequency domain dimension, and the time dimension, or the space dimension and the delay-frequency domain dimension, to obtain the transformed bitstream.

In some embodiments, the first device performs at least one of the following based on the second transform step configuration and the first complex signal:
obtaining an ROI of a signal in the space dimension and the delay-frequency domain dimension, performing smoothing and block DCT or DFT or DWT on a phase difference of the signal, and performing antenna array dimension redundancy removal on the signal, or performing time dimension redundancy removal on the signal.

The signal mentioned above is the first complex signal or a signal obtained by transforming the first complex signal. The second transform step configuration indicates whether the foregoing operations are executed and a corresponding execution sequence.

In some embodiments, the second transform step configuration may be a configuration 1 of “first obtaining an ROI, then performing smoothing and block DCT or DFT or DWT on a phase difference, then performing antenna array dimension redundancy removal, and finally performing time dimension redundancy removal”.

In some other embodiments, the second transform step configuration may be a configuration 2 of “first performing time dimension redundancy removal, then obtaining an ROI, and then performing smoothing and block DCT or DFT or DWT on a phase difference”.

Whether the first complex signal corresponding to the configuration 1 or the configuration 2 includes data in the antenna array dimension is not limited in this application.

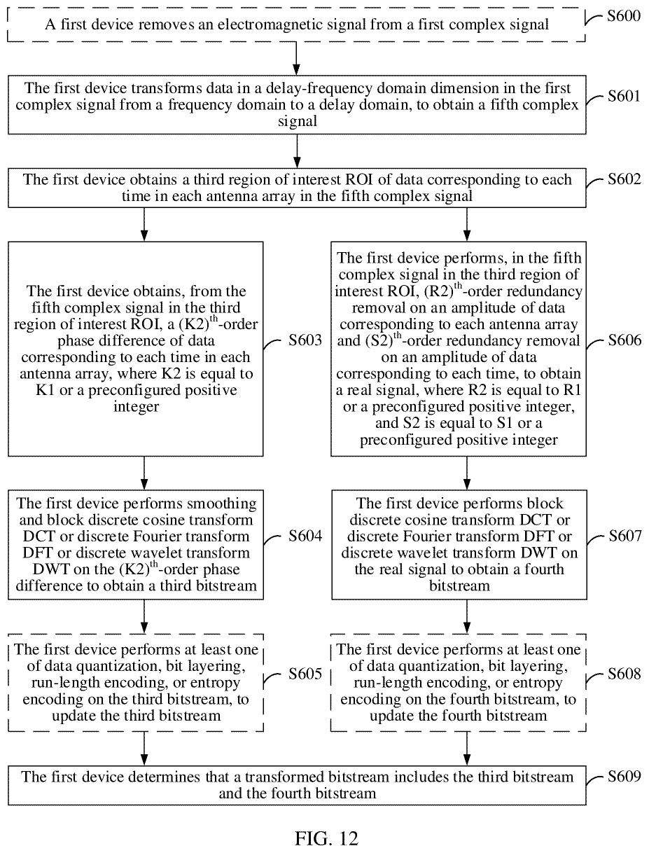

The following describes, in detail with reference to FIG. 12, a specific implementation of signal transform of the first device when the second transform step configuration is the configuration 1.

FIG. 12 is a schematic flowchart of a signal processing method according to an embodiment of this application.

As shown in FIG. 12, the signal processing method in this application may include the following steps.

S600: The first device removes the electromagnetic signal from the first complex signal.

It should be noted that, S600 is an optional step.

For a specific implementation of S600, refer to descriptions of the embodiment of S400 in FIG. 7. Details are not described herein again.

S601: The first device transforms data in the delay-frequency domain dimension in the first complex signal from a frequency domain to a delay domain, to obtain a fifth complex signal.

For a specific implementation of S601, refer to descriptions of the embodiment of S401 in FIG. 7. Details are not described herein again.

It should be noted that S600 and S601 are not necessarily performed in a specific time sequence, and may be performed simultaneously or sequentially.

S602: The first device obtains a third region of interest ROI of data corresponding to each time in each antenna array in the fifth complex signal.

The first device may perform, in the fifth complex signal, redundancy removal on data in the space dimension and the delay-frequency domain dimension that is collected by each antenna array at each time, to obtain a third region of interest ROI. In this way, redundant data in the space dimension and the delay-frequency domain dimension in the fifth complex signal is removed through the foregoing data ROI processing.

The third region of interest ROI indicates non-redundant data in the space dimension and the delay-frequency domain dimension in the fifth complex signal. The third region of interest ROI may include a data range corresponding to each time.

In this application, the first device may determine that a data range corresponding to any time is a mark range to which taps corresponding to the time belong. The data range herein is a space-delay domain data range, and the tap herein is a space-delay domain tap. The space-delay domain is short for the space domain and the delay domain.

In some embodiments, for any time in each antenna array, the first device may obtain power Pₘₐₓ (dB) of a strongest path from a plurality of paths. Then, the first device may determine that a data range corresponding to the time is a mark range to which a tap whose power is greater than (Pₘₐₓ−ΔP) (dB) belongs. ΔP (dB) is a preset power threshold. This helps filter out noise/interference.

In some other embodiments, for any time in each antenna array, the first device may obtain the first Mₜₐₚ taps with maximum power, to ensure that a percentage of energy of the first Mₜₐₚ taps in total energy of all taps is greater than or equal to a preset threshold. A specific value of the preset threshold is not limited in this application. Then, the first device may determine that a data range corresponding to the time is a mark range to which the Mₜₐₚ taps belong. This helps filter out noise/interference.

In this way, the first device may obtain the third region of interest ROI.

In conclusion, the redundant data in the delay-frequency domain dimension and the space dimension in the fifth complex signal is removed through data ROI processing, so that a transmission resource of the transformed bitstream can be reduced, and the transformed bitstream can more accurately represent change intensity of the fifth complex signal, thereby ensuring that the transformed bitstream effectively and purely represents the electromagnetic characteristic of the ambient environment feature.

S603: The first device obtains, from the fifth complex signal in the third region of interest ROI, a (K2)^{th}-order phase difference of data corresponding to each time in each antenna array, where K2 is equal to K1 or a preconfigured positive integer.

When there is a large amount of data in the space dimension, the phase processing switch is “on” or the phase processing switch is turned on by default. In this case, the first device may obtain the fifth complex signal in the third region of interest ROI. Then, the first device may transform a phase of the fifth complex signal in the third region of interest ROI in combination with the space dimension, the delay-frequency domain dimension, the antenna array dimension, and the time dimension, or the space dimension, the delay-frequency domain dimension, and the antenna array dimension, or the space dimension, the delay-frequency domain dimension, and the time dimension, or the space dimension and the delay-frequency domain dimension.

In some embodiments, the first device may use fourth data as a reference, and perform a difference operation based on phases of the fourth data and the data corresponding to each time in each antenna array in the fifth complex signal in the third region of interest ROI, to obtain the (K2)^{th}-order phase difference of the data corresponding to each time in each antenna array in the fifth complex signal in the third region of interest ROI.

When the space dimension, the delay-frequency domain dimension, the antenna array dimension, and the time dimension, or the space dimension, the delay-frequency domain dimension, and the time dimension are used, the fourth data may include but is not limited to at least one of, for example, data corresponding to a previous time, data corresponding to a first time, data corresponding to a next time, data corresponding to several times, or preconfigured data obtained based on experience or other factors. When the space dimension, the delay-frequency domain dimension, and the antenna array dimension, or the space dimension and the delay-frequency domain dimension are used, the fourth data may include but is not limited to preconfigured data obtained based on experience or other factors. The data corresponding to each time is data that is in the space dimension and the delay-frequency domain dimension and that corresponds to each time.

When K2=1, for each antenna array, the first device may obtain, from the fifth complex signal in the third region of interest ROI, a phase of the data that is in the space dimension and the delay-frequency domain dimension and that corresponds to each time, and then perform, by using the fourth data as a reference, a difference operation on phases of the fourth data and the data that is in the space dimension and the delay-frequency domain dimension and that corresponds to each time, to obtain a first-order phase difference.

When K2>1, for each antenna array, the first device may obtain, from the fifth complex signal in the third region of interest ROI by using a difference formula with the fourth data as a reference, a (K2)^{th}-order phase difference of the data that is in the space dimension and the delay-frequency domain dimension and that corresponds to each time.

For a specific implementation of the foregoing process, refer to descriptions of the embodiment of S201 in FIG. 3. Details are not described herein again.

Then, the first device may obtain the (K2)^{th}-order phase difference of the data corresponding to each time in each antenna array in the fifth complex signal in the third region of interest ROI.

The first device may determine K2 to be equal to K1 in the initial configuration parameter, or may determine K2 to be equal to a preconfigured positive integer. This is not limited in this application.

S604: The first device performs smoothing and block discrete cosine transform DCT or discrete Fourier transform DFT or discrete wavelet transform DWT on the (K2)^{th}-order phase difference to obtain a third bitstream.

For a specific implementation of S604, refer to descriptions of the embodiment of S202 in FIG. 3. Details are not described herein again.

It should be noted that, the block DCT is used as an example, and the first device may divide, based on a block size or a block quantity of the block DCT, a smoothed (K2)^{th}-order phase difference of the data corresponding to each time in each antenna array in the fifth complex signal in the third region of interest ROI, to obtain a plurality of space-delay blocks. Each space-delay block is data in the space dimension.

When a size of a last space-delay block does not match the block size of the block DCT, the first device may pad data of the last space-delay block, so that the size of the last space-delay block is the block size of the block DCT.

S605: The first device performs at least one of data quantization, bit layering, run-length encoding, or entropy encoding on the third bitstream, to update the third bitstream.

It should be noted that, S605 is an optional step. In addition, S603 to S605 are performed sequentially.

For a specific implementation of S605, refer to descriptions of the embodiment of S203 in FIG. 3. Details are not described herein again.

S606: The first device performs, in the fifth complex signal in the third region of interest ROI, (R2)^{th}-order redundancy removal on an amplitude of data corresponding to each antenna array and (S2)^{th}-order redundancy removal on an amplitude of data corresponding to each time, to obtain a real signal, where R2 is equal to R1 or a preconfigured positive integer, and S2 is equal to S1 or a preconfigured positive integer.

When there is a large amount of data in the space dimension, the amplitude processing switch is “on” or the amplitude processing switch is turned on by default. In this case, the first device may transform an amplitude of the fifth complex signal in the third region of interest ROI in combination with the space dimension, the delay-frequency domain dimension, the antenna array dimension, and the time dimension, or the space dimension, the delay-frequency domain dimension, and the antenna array dimension, or the space dimension, the delay-frequency domain dimension, and the time dimension, or the space dimension and the delay-frequency domain dimension.

In some embodiments, the first device may use fifth data as a reference, and perform (R2)^{th}-order redundancy removal based on the fifth data and the data corresponding to each antenna array in the fifth complex signal in the third region of interest ROI, to obtain a fifth complex signal that undergoes the (R2)^{th}-order redundancy removal.

When the space dimension, the delay-frequency domain dimension, the antenna array dimension, and the time dimension, or the space dimension, the delay-frequency domain dimension, and the time dimension are used, the fifth data may include but is not limited to at least one of, for example, data corresponding to a previous time, data corresponding to a first time, data corresponding to a next time, data corresponding to several times, or preconfigured data obtained based on experience or other factors. When the space dimension, the delay-frequency domain dimension, and the antenna array dimension, or the space dimension and the delay-frequency domain dimension are used, the fifth data may include but is not limited to preconfigured data obtained based on experience or other factors. The data corresponding to each antenna array is data that is in the space dimension, the delay-frequency domain dimension, and the time dimension and that corresponds to each antenna array.

When R2=1, the first device may obtain, from the fifth complex signal in the third region of interest ROI, an amplitude of the data that is in the space dimension, the delay-frequency domain dimension, and the time dimension and that corresponds to each antenna array. Then, the first device may perform, by using the fifth data as a reference, first-order redundancy removal on the amplitude of the data that is in the space dimension, the delay-frequency domain dimension, and the time dimension and that corresponds to each antenna array.

In some embodiments, when the fifth data is a first antenna array, it is assumed that the fifth complex signal in the third region of interest ROI is denoted as a 5D matrix X, where data in the space dimension is 2D, data in the delay-frequency domain dimension is 1D, data in the antenna array dimension is 1D, and data in the time dimension is 1D.

Based on the foregoing descriptions, the first device may perform, in the fifth complex signal in the third region of interest ROI by using the following expressions, first-order redundancy removal on the amplitude of the data that is in the space dimension, the delay-frequency domain dimension, and the time dimension and that corresponds to each antenna array:

$$Δ X ( : , : , : , 1 , : ) = X ( : , : , : , 1 , : ) , and Δ X ( : , : , : , i , : ) = X ( : , : , : , i , : ) - {α}_{i} * {X}^{′} ( : , : , : , 1 , : ) , where {α}_{i} = {vec ( X ( : , : , : , i , : ) )}^{T} * vec ( {X}^{′} ( : , : , : , 1 , : ) ) / ( {vec ( {X}^{′} ( : , : , : , 1 , : ) )}^{T} * vec ( {X}^{′} ( : , : , : , 1 , : ) ) ) .$$

ΔX(:, :, :, i, :) is data obtained through first-order redundancy removal on data corresponding to an i^{th} antenna array in the fifth complex signal in the third region of interest ROI, 2≤i≤N_{c}, N_{c} is an antenna array dimension size of the fifth complex signal, and “:” indicates that all data in a corresponding dimension is obtained.

αᵢ is a correlation coefficient between X(:, :, :, i, :) and X(:, :, :, 1, :). A value range of αᵢ is [−1, 1]. When αᵢ is 0, it indicates that X(:, :, :, i, :) is unrelated to X(:, :, :, 1, :). When αᵢ is 1 or −1, it indicates that X(:, :, :, i, :) is related to X(:, :, :, 1, :). X′(:, :, :, 1, :) is a value obtained by transforming and then de-transforming X(:, :, :, 1, :), and vec(⋅) indicates that a tensor is vectorized into a column vector.

In some other embodiments, when the fifth data is a previous antenna array, it is assumed that the fifth complex signal in the third region of interest ROI is denoted as a 5-dimensional matrix X, where data in the space dimension is 2D, data in the delay-frequency domain dimension is 1D, data in the antenna array dimension is 1D, and data in the time dimension is 1D.

Based on the foregoing descriptions, the first device may perform, in the fifth complex signal in the third region of interest ROI by using the following expressions, first-order redundancy removal on the amplitude of the data of each antenna array in the space dimension, the delay-frequency domain dimension, and the time dimension:

$$Δ {X}^{′} ( : , : , : , 1 , : ) = {X}^{′} ( : , : , : , 1 , : ) , and Δ {X}^{′} ( : , : , : , 1 , : ) = X ( : , : , : , i , : ) - {α}_{i - 1} * {X}^{′} ( : , : , : , i - 1 , : ) , where {α}_{i} = {vec ( X ( : , : , : , i , : ) )}^{T} * vec ( {X}^{′} ( : , : , : , i - 1 , : ) ) / ( {vec ( {X}^{′} ( : , : , : , i - 1 , : ) )}^{T} * vec ( {X}^{′} ( : , : , : , i - 1 , : ) ) )$$

ΔX(:, :, :, i, :) is data obtained through first-order redundancy removal on data corresponding to an i^{th} antenna array in the fifth complex signal in the third region of interest ROI, 2≤i≤N_{c}, N_{c} is an antenna array dimension size of the fifth complex signal, and “:” indicates that all data in a corresponding dimension is obtained.

αᵢ is a correlation coefficient between X(:, :, :, i, :) and X(:, :, :, i−1, :). A value range of αᵢ is [−1, 1]. When αᵢ is 0, it indicates that X(:, :, :, i, :) is unrelated to X(:, :, :, i−1, :). When αᵢ is 1 or −1, it indicates that X(:, :, :, i, :) is related to X(:, :, :, i−1, :). vec(⋅) indicates that a tensor is vectorized into a column vector.

X′(:, :, :, 1, :) is a value obtained by transforming and then de-transforming X(:, :, :, 1, :).

$${X}^{′} ( : , : , : , i - 1 , : ) Δ {X}^{′} ( : , : , : , i - 1 , : ) + {α}_{i - 1} * {X}^{′} ( : , : , : , i - 2 , : ) , and 3 \leq i \leq {N}_{c} .$$

ΔX′(:, :, :, i−1, :) is a value obtained by transforming and then de-transforming ΔX(:, i−1, :).

When R2>1, the first device may obtain, from the fifth complex signal in the third region of interest ROI, an amplitude of the data that is in the space dimension, the delay-frequency domain dimension, and the time dimension and that corresponds to each antenna array. Then, the first device may perform, by using a difference formula with the fifth data as a reference, (R2)^{th}-order redundancy removal on the amplitude of the data that is in the space dimension, the delay-frequency domain dimension, and the time dimension and that corresponds to each antenna array.

In this way, signal redundancy removal is implemented by using correlation between data of different antenna arrays.

The first device may determine R2 to be equal to R1 in the initial configuration parameter, or may determine R2 to be equal to a preconfigured positive integer. This is not limited in this application.

In conclusion, redundant data that is in the space dimension, the delay-frequency domain dimension, and the time dimension and that corresponds to different antenna arrays in the fifth complex signal is removed through time-correlation-based redundancy removal, so that a transmission resource of the transformed bitstream can be reduced, and the transformed bitstream can more accurately represent change intensity of the fifth complex signal, thereby ensuring that the transformed bitstream effectively and purely carries the electromagnetic characteristic of the ambient environment feature.

In some embodiments, the first device may use sixth data as a reference, and perform (S2)^{th}-order redundancy removal based on the sixth data and data corresponding to each time in the fifth complex signal that undergoes the (R2)^{th}-order redundancy removal.

When the space dimension, the delay-frequency domain dimension, the antenna array dimension, and the time dimension, or the space dimension, the delay-frequency domain dimension, and the time dimension are used, the sixth data may include but is not limited to at least one of, for example, data corresponding to a previous time, data corresponding to a first time, data corresponding to a next time, data corresponding to several times, or preconfigured data obtained based on experience or other factors. When the space dimension, the delay-frequency domain dimension, and the antenna array dimension, or the space dimension and the delay-frequency domain dimension are used, the sixth data may include but is not limited to preconfigured data obtained based on experience or other factors. The data corresponding to each time is data that is in the space dimension, the delay-frequency domain dimension, and the antenna array dimension and that corresponds to each time.

When S2=1, the first device may obtain, from the fifth complex signal that undergoes the (R2)^{th}-order redundancy removal, an amplitude of the data that is in the space dimension, the delay-frequency domain dimension, and the antenna array dimension and that corresponds to each time. Then, the first device may perform, by using the sixth data as a reference, first-order redundancy removal on the amplitude of the data that is in the space dimension, the delay-frequency domain dimension, and the antenna array dimension and that corresponds to each time.

In some embodiments, when the sixth data is data corresponding to a first time, it is assumed that the fifth complex signal that undergoes the (R2)^{th}-order redundancy removal is denoted as a 5-dimensional matrix Y, where data in the space dimension is 2D, data in the delay-frequency domain dimension is 1D, data in the antenna array dimension is 1D, and data in the time dimension is 1D.

Based on the foregoing descriptions, the first device may perform, by using the following expressions in the fifth complex signal that undergoes the (R2)^{th}-order redundancy removal, first-order redundancy removal on the amplitude of the data that is in the space dimension, the delay-frequency domain dimension, and the antenna array dimension and that corresponds to each time:

$$Δ Y ( : , : , : , : , 1 ) = Y ( : , : , : , : , 1 ) , and Δ Y ( : , : , : , : , n ) = Y ( : , : , : , : , n ) - {β}_{n} * {Y}^{′} ( : , : , : , : , 1 ) , where 2 \leq n \leq {N}_{pk} ; and {β}_{n} = {vec ( Y ( : , : , : , : , n ) )}^{T} * vec ( {Y}^{′} ( : , : , : , : , 1 ) ) / ( {vec ( {Y}^{′} ( : , : , : , : , 1 ) )}^{T} * vec ( {Y}^{′} ( : , : , : , : , 1 ) ) ) .$$

ΔY(:, :, :, :, n) is data obtained through first-order redundancy removal on data corresponding to a time Tₙ in the fifth complex signal that undergoes the (R2)^{th}-order redundancy removal, Y(:, :, :, :, n) is the data corresponding to the time Tₙ in the fifth complex signal that undergoes the (R2)^{th}-order redundancy removal, Tₙ is an n^{th} time in the fifth complex signal that undergoes the (R2)^{th}-order redundancy removal, n is a positive integer greater than or equal to 2 and less than or equal to a time dimension size Nₚₖ of the fifth complex signal, and “:” indicates that all data in a corresponding dimension is obtained.

βₙ is a correlation coefficient between Y(:, :, :, :, n) and Y (:, :, :, :, 1). A value range of βₙ is [−1, 1]. When βₙ is 0, it indicates that Y(:, :, :, :, n) is unrelated to Y(:, :, :, :, 1). When βₙ is 1 or −1, it indicates that Y(:, :, :, :, n) is related to Y(:, :, :, :, 1). Y′(:, :, :, :, 1) is a value obtained by transforming and then de-transforming Y(:, :, :, :, 1), and vec(⋅) indicates that a tensor is vectorized into a column vector.

In some other embodiments, when the sixth data is data corresponding to a previous time, it is assumed that the fifth complex signal that undergoes the (R2)^{th}-order redundancy removal is denoted as a 5-dimensional matrix Y, where data in the space dimension is 2D, data in the delay-frequency domain dimension is 1D, data in the antenna array dimension is 1D, and data in the time dimension is 1D.

Based on the foregoing descriptions, the first device may perform, by using the following expressions in the fifth complex signal that undergoes the (R2)^{th}-order redundancy removal, first-order redundancy removal on the amplitude of the data that is in the space dimension, the delay-frequency domain dimension, and the antenna array dimension and that corresponds to each time:

$$Δ Y ( : , : , : , : , 1 ) = Y ( : , : , : , : , 1 ) , and Δ Y ( : , : , : , : , n ) = Y ( : , : , : , : , n ) - {β}_{n} * {Y}^{′} ( : , : , : , : , n - 1 ) , where 2 \leq n \leq {N}_{pk} ; and {β}_{n} = {vec ( Y ( : , : , : , : , n ) )}^{T} * vec ( {Y}^{′} ( : , : , : , : , n - 1 ) ) / ( {vec ( {Y}^{′} ( : , : , : , : , n - 1 ) )}^{T} * vec ( {Y}^{′} ( : , : , : , : , n - 1 ) ) ) .$$

ΔY(:, :, :, :, n) is data obtained through first-order redundancy removal on data corresponding to a time Tₙ in the fifth complex signal that undergoes the (R2)^{th}-order redundancy removal, Y(:, :, :, :, n) is the data corresponding to the time Tₙ in the fifth complex signal that undergoes the (R2)^{th}-order redundancy removal, Y(:, :, :, :, n−1) is data corresponding to a time Tₙ₋₁ in the fifth complex signal that undergoes the (R2)^{th}-order redundancy removal, Tₙ is an n^{th} time in the fifth complex signal that undergoes the (R2)^{th}-order redundancy removal, Tₙ₋₁ is an (n−1)^{th} time in the fifth complex signal that undergoes the (R2)^{th}-order redundancy removal, n is a positive integer greater than or equal to 2 and less than or equal to a time dimension size Nₚₖ of the fifth complex signal, and “:” indicates that all data in a corresponding dimension is obtained.

βₙ is a correlation coefficient between Y(:, :, :, :, n) and Y(:, :, :, :, n−1). A value range of βₙ is [−1, 1]. When βₙ is 0, it indicates that Y(:, :, :, :, n) is unrelated to Y(:, :, :, :, n−1). When βₙ is 1 or −1, it indicates that Y(:, :, :, :, n) is related to Y(:, :, :, :, n−1). vec(⋅) indicates that a tensor is vectorized into a column vector.

Y′(:, :, :, :, 1) is a value obtained by transforming and then de-transforming Y(:, :, :, :, 1).

$${Y}^{′} ( : , : , : , : , n - 1 ) = Δ {Y}^{′} ( : , : , : , : , n - 1 ) + {β}_{n - 1} * {Y}^{′} ( : , : , : , : , n - 2 ) , 3 \leq n \leq {N}_{pk} .$$

ΔY′(:, :, :, :, n−1) is a value obtained by transforming and then de-transforming ΔY(:, , n−1).

When S2>1, the first device may obtain, from the fifth complex signal that undergoes the (R2)^{th}-order redundancy removal, an amplitude of the data that is in the space dimension, the delay-frequency domain dimension, and the antenna array dimension and that corresponds to each time. Therefore, the first device may perform, by using a difference formula with the sixth data as a reference, (S2)^{th}-order redundancy removal on the amplitude of the data that is in the space dimension, the delay-frequency domain dimension, and the antenna array dimension and that corresponds to each time, to obtain a real signal.

In this way, signal redundancy removal is implemented by using correlation between data at different times.

The first device may determine S2 to be equal to S1 in the initial configuration parameter, or may determine S2 to be equal to a preconfigured positive integer. This is not limited in this application.

In conclusion, redundant data that is in the space dimension, the delay-frequency domain dimension, and the antenna array dimension and that corresponds to different times in the fifth complex signal is removed through time-correlation-based redundancy removal, so that a transmission resource of the transformed bitstream can be reduced, and the transformed bitstream can more accurately represent change intensity of the fifth complex signal, thereby ensuring that the transformed bitstream effectively and purely carries the electromagnetic characteristic of the ambient environment feature.

In this way, the first device may obtain the real signal.

S607: The first device performs block discrete cosine transform DCT or discrete Fourier transform DFT or discrete wavelet transform DWT on the real signal to obtain a fourth bitstream.

For a specific implementation of S607, refer to descriptions of performing block DCT or DFT or DWT on the (Q2)^{th}-order amplitude difference to obtain the second bitstream in the embodiment of S205 in FIG. 3. Details are not described herein again.

S608: The first device performs at least one of data quantization, bit layering, run-length encoding, or entropy encoding on the fourth bitstream, to update the fourth bitstream.

For a specific implementation of S608, refer to descriptions of the embodiment of S206 in FIG. 3. Details are not described herein again.

In addition, the initial configuration parameter may further include at least one parameter of a data quantization processing switch, a data quantization type, a data quantization parameter, a bit layering processing switch, a run-length encoding processing switch, an entropy encoding processing switch, an entropy encoding type, or the like.

It should be noted that, S608 is an optional step. In addition, S606 to S608 are performed sequentially. S603 and S606 are not necessarily performed in a specific time sequence, and S603 and S606 may be performed simultaneously or sequentially.

S609: The first device determines that the transformed bitstream includes the third bitstream and the fourth bitstream.

For a specific implementation of S609, refer to descriptions of the embodiment of S207 in FIG. 3. Details are not described herein again.

In conclusion, the first device may preprocess the first complex signal, perform phase transform on the first complex signal, and perform redundancy removal on the first complex signal in one or more dimensions, to remove noise/interference and redundant information in the first complex signal, and shorten a transmission length of the transformed bitstream, making it more convenient to transmit and process the transformed bitstream.

Then, the first device may include the transformed bitstream into a transformed signal and send the transformed signal to the second device.

In addition, in the scenario 3, the transformed signal may further include third signaling. The third signaling indicates at least one of, for example, a transmission length of the transformed bitstream, a total length of the transformed bitstream, a correlation coefficient for antenna array dimension redundancy removal, a correlation coefficient for time dimension redundancy removal, or a fourth region of interest ROI.

For specific implementations of the transmission length and the total length of the transformed bitstream, refer to the descriptions in the scenario 1. Details are not described herein again.

When R2=1, the correlation coefficient for antenna array dimension redundancy removal is αᵢ in the embodiment of S606 in FIG. 12. When R2>1, the correlation coefficient for antenna array dimension redundancy removal includes a plurality of correlation coefficients, and αᵢ in the embodiment of S606 in FIG. 12 may be obtained based on descriptions of the embodiment of S606 in FIG. 12.

When S2=1, the correlation coefficient for time dimension redundancy removal is βₙ in the embodiment of S606 in FIG. 12. When S2>1, the correlation coefficient for time dimension redundancy removal includes a plurality of correlation coefficients, which may be obtained based on descriptions of the embodiment of S606 in FIG. 12.

The fourth region of interest ROI indicates the third region of interest ROI. The fourth region of interest ROI is obtained by the first device through redundancy removal on the third region of interest ROI of each antenna array. In this way, the first device may transmit the fourth region of interest ROI to the second device, so that the second device restores the third region of interest ROI for signal reconstruction.

In some embodiments, for any time in any antenna array in the third region of interest ROI, the first device may determine, based on a mark range to which a tap belongs, one or more data ranges corresponding to the time. The first device may mark, by using coordinates ROI[i, N]ₘ={pos[i, N]_{m,1}, pos[i, N]_{m,2}} of two endpoints, each data range corresponding to the time. i is an i^{th} antenna array in the first device, N is an N^{th} time in the first complex signal, and m is a positive integer including 1 and 2. In this way, simplified marking of the third region of interest ROI is implemented, and a tap located outside the third region of interest ROI can be directly discarded.

Based on the foregoing descriptions, the first device may perform, by using a data range corresponding to a previous time, a data range corresponding to a first time, or a data range corresponding to a time at an interval of several times as a reference, redundancy removal on a data range corresponding to each time in each antenna array in the third region of interest ROI, to implement simplified marking of the fourth region of interest ROI.

The data range corresponding to the previous time is used as a reference. For any time in any antenna array in the third region of interest ROI, the first device may mark, in a plurality of manners, a data range corresponding to the time.

In some embodiments, when quantities of data ranges corresponding to the time and the previous time are the same, the first device may first pair the data ranges corresponding to the time and the previous time, and then perform redundancy removal on paired data ranges in a manner such as obtaining a difference. When the quantities of data ranges corresponding to the time and the previous time are different, the first device may directly mark the data range corresponding to the time.

In some other embodiments, when data ranges corresponding to the time and the previous time are slightly different, the first device may first pair the data ranges corresponding to the time and the previous time, and then perform redundancy removal on paired data ranges in a manner such as obtaining a difference. When the data ranges corresponding to the time and the previous time are quite different, the first device may directly mark the data range corresponding to the time.

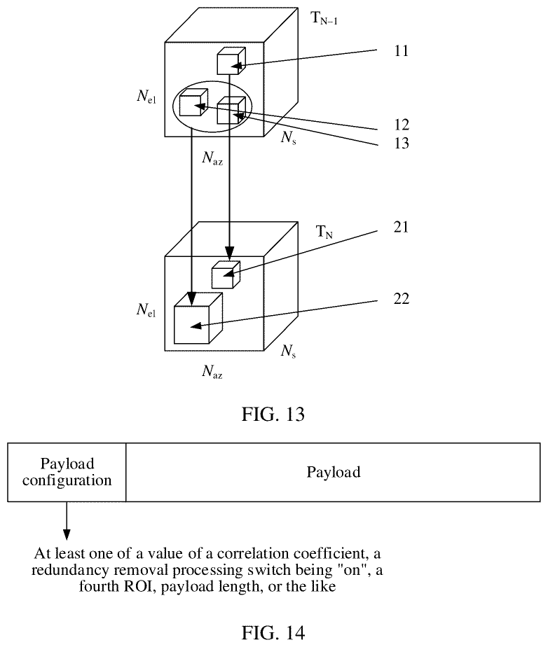

FIG. 13 is a diagram of a data range according to an embodiment of this application.

Based on descriptions of the embodiment in FIG. 11, as shown in FIG. 13, data ranges corresponding to a time T_{N} may include a range 11, a range 12, and a range 13. Data ranges corresponding to a time T_{N-1} may include a range 21 and a range 22.

The first device may configure the range 11 and the range 21 as a pair, and configure the range 12, the range 13, and the range 22 as a pair. The first device may perform redundancy removal on the range 21 based on the range 11 and the range 21. The first device may perform redundancy removal on the range 22 based on the range 12, the range 13, and the range 22. In this way, simplified marking of the data ranges corresponding to the time T_{N} is implemented.

FIG. 14 is a diagram of a transformed signal according to an embodiment of this application.

It is assumed that a data size N_{az}×Nₑₗ×Nₛ×N_{c}×Nₚₖ of the first complex signal is 150*150*601*2*301.

In this case, the initial configuration parameter may include: the space dimension size of the first complex signal is 150*150, the delay-frequency domain dimension size of the first complex signal is 601, the antenna array dimension size of the first complex signal is 2, the time dimension size of the first complex signal is 301, the block size of the block DCT is 5*5, the block quantity of the block DCT is 30, the second transform step configuration is the “configuration 1 or configuration 2”, the phase processing switch is “on”, the phase difference order K1 is 1, the antenna array dimension redundancy removal processing switch is “on”, the antenna array dimension redundancy removal order R1 is 1, the time dimension redundancy removal processing switch is “on”, the order S1 of the time dimension redundancy removal processing switch is 1, the data quantization processing switch is “on”, the data quantization type is uniform scalar quantization, the data quantization parameter is 8-bit quantization, the run-length encoding processing switch is “on”, the bit layering processing switch is “on”, the entropy encoding processing switch is “on”, and the entropy encoding type is arithmetic coding.

Based on descriptions of the embodiment in FIG. 12, when the second transform step configuration is the configuration 1, the first complex signal received by the first device may include a delay domain channel response signal. In this case, the first device does not need to perform preprocessing, and may determine that the fifth complex signal is the first complex signal.

The first device may obtain the first Mₜₐₚ taps with maximum power from the fifth complex signal, so that a percentage of energy of the first Mₜₐₚ taps in total energy of all taps exceeds 99% (corresponding to a normalized mean square error (NMSE) lower than 10⁻²), to obtain a data range corresponding to each time in each antenna array, that is, a third region of interest ROI.

The first device may obtain, from the fifth complex signal in the third region of interest ROI, a first-order phase difference of data at each time in each antenna array.

The first device may perform smoothing and block DCT on the first-order phase difference, to obtain a third bitstream.

During the block DCT, 5*5 space-delay blocks are first obtained through division, and then DCT is performed on each space-delay block.

The first device performs data quantization, bit layering, run-length encoding, and entropy encoding on the third bitstream, to update the third bitstream.

In the update process, 8-bit uniform scalar quantization is first performed, then run-length encoding is performed on alternating current coefficients, a difference operation is performed on direct current coefficients, and arithmetic coding is performed on all coefficients to update the bitstream.

The first device may perform, in the fifth complex signal in the third region of interest ROI, first-order redundancy removal on an amplitude of data corresponding to each antenna array and first-order redundancy removal on an amplitude of data at each time, to obtain a real signal.

The first device performs block DCT on the real signal to obtain a fourth bitstream.

During the block DCT, 5*5 space-delay blocks are first obtained through division, and then DCT is performed on each space-delay block.

The first device performs data quantization, bit layering, run-length encoding, and entropy encoding on the fourth bitstream, to update the fourth bitstream.

In the update process, 8-bit uniform scalar quantization is first performed, then run-length encoding is performed on alternating current coefficients, a difference operation is performed on direct current coefficients, and arithmetic coding is performed on all coefficients to update the bitstream.

The first device may determine that the transformed bitstream includes the third bitstream and the fourth bitstream.

Then, the first device may send a transformed signal shown in FIG. 14 to the second device.

In FIG. 14, the transformed signal may include the transformed bitstream (Payload (payload) is used as an example in FIG. 14) and the third signaling (configuration information (configuration) of Payload is used as an example in FIG. 14).

Payload configuration may include but is not limited to at least one of preconfigured data of the correlation coefficient, the redundancy removal processing switch being “on”, the fourth region of interest ROI, length information (length) of Payload, or the like. For a specific implementation of Payload length, refer to the foregoing descriptions. Details are not described herein again.

Based on descriptions of the foregoing embodiment, the second device may de-transform the transformed bitstream in the transformed signal based on the initial configuration parameter in combination with the space dimension, the delay-frequency domain dimension, the antenna array dimension, and the time dimension, or the space dimension, the delay-frequency domain dimension, and the antenna array dimension, or the space dimension, the delay-frequency domain dimension, and the time dimension, or the space dimension and the delay-frequency domain dimension, to obtain the second complex signal.

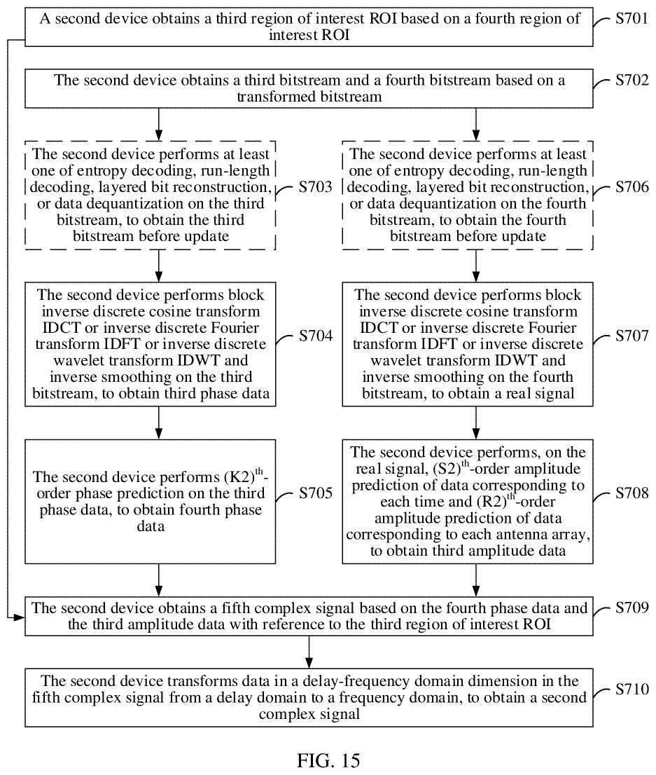

The following describes, in detail with reference to FIG. 15, a specific implementation of signal de-transform of the second device.

FIG. 15 is a schematic flowchart of a signal processing method according to an embodiment of this application.

As shown in FIG. 15, the signal processing method in this application may include the following steps.

S701: The second device obtains the third region of interest ROI based on the fourth region of interest ROI.

A specific implementation of S701 and the foregoing process in which the first device obtains the fourth region of interest ROI based on the third region of interest ROI are inverse processes to each other, and details are not described herein again.

S702: The second device obtains the third bitstream and the fourth bitstream based on the transformed bitstream.

S702 and S609 in FIG. 12 are inverse processes to each other. For a specific implementation of S702, refer to descriptions of the embodiment of S609 in FIG. 12. Details are not described herein again.

It should be noted that S701 and S702 are not necessarily performed in a specific time sequence, and S701 and S702 may be performed simultaneously or sequentially.

S703: The second device performs at least one of entropy decoding, run-length decoding, layered bit reconstruction, or data dequantization on the third bitstream, to obtain the third bitstream before update.

It should be noted that, S703 is an optional step.

The entropy decoding and entropy encoding, the run-length decoding and run-length encoding, the layered bit reconstruction and bit layering, and the data dequantization and data quantization are all inverse processes to each other.

For a specific implementation of S703, refer to descriptions of the embodiment of S605 in FIG. 12. Details are not described herein again.

S704: The second device performs block inverse discrete cosine transform IDCT or inverse discrete Fourier transform IDFT or inverse discrete wavelet transform IDWT and inverse smoothing on the third bitstream, to obtain third phase data.

The block IDCT and block DCT, the block IDFT and block DFT, the block IDWT and block DWT, and the inverse smoothing and smoothing are all inverse processes to each other.

For a specific implementation of S704, refer to descriptions of the embodiment of S604 in FIG. 12. Details are not described herein again.

S705: The second device performs (K2)^{th}-order phase prediction on the third phase data, to obtain fourth phase data.

The (K2)^{th}-order phase prediction and (K2)^{th}-order phase difference calculation are inverse processes to each other.

For a specific implementation of S705, refer to descriptions of the embodiment of S603 in FIG. 12. Details are not described herein again.

It should be noted that S703 to S705 are performed sequentially.

S706: The second device performs at least one of entropy decoding, run-length decoding, layered bit reconstruction, or data dequantization on the fourth bitstream, to obtain the fourth bitstream before update.

It should be noted that, S706 is an optional step.

The entropy decoding and entropy encoding, the run-length decoding and run-length encoding, the layered bit reconstruction and bit layering, and the data dequantization and data quantization are all inverse processes to each other.

For a specific implementation of S706, refer to descriptions of the embodiment of S608 in FIG. 12. Details are not described herein again.

S707: The second device performs block inverse discrete cosine transform IDCT or inverse discrete Fourier transform IDFT or inverse discrete wavelet transform IDWT and inverse smoothing on the fourth bitstream, to obtain the real signal.

The block IDCT and block DCT, the block IDFT and block DFT, the block IDWT and block DWT, and the inverse smoothing and smoothing are all inverse processes to each other.

For a specific implementation of S707, refer to descriptions of the embodiment of S607 in FIG. 12. Details are not described herein again.

S708: The second device performs, on the real signal, (S2)^{th}-order amplitude prediction of data corresponding to each time and (R2)^{th}-order amplitude prediction of data corresponding to each antenna array, to obtain third amplitude data.

The (S2)^{th}-order amplitude prediction and (S2)^{th}-order redundancy removal are inverse processes to each other, and the (R2)^{th}-order amplitude prediction and (R2)^{th}-order redundancy removal are inverse processes to each other.

For a specific implementation of S708, refer to descriptions of the embodiment of S606 in FIG. 12. Details are not described herein again.

It should be noted that S706 to S708 are performed sequentially. In addition, S704 and S707 are not necessarily performed in a specific time sequence, and S704 and S707 may be performed simultaneously or sequentially.

S709: The second device obtains the fifth complex signal based on the fourth phase data and the third amplitude data in combination with the third region of interest ROI.

For a specific implementation of S709, refer to descriptions of the embodiment of S602 in FIG. 12. Details are not described herein again.

S710: The second device transforms data in the delay-frequency domain dimension in the fifth complex signal from the delay domain to the frequency domain, to obtain the second complex signal.

For a specific implementation of S710, refer to descriptions of transforming the data in the delay-frequency domain dimension in the first complex signal from the frequency domain to the delay domain in the embodiment of S601 in FIG. 12. Details are not described herein again.

In conclusion, the second device may reconstruct the second complex signal by de-transforming the transformed signal.

In the scenario 3, the first device may transform the first complex signal in combination with the space dimension, the delay-frequency domain dimension, the antenna array dimension, and the time dimension, or the space dimension, the delay-frequency domain dimension, and the antenna array dimension, or the space dimension, the delay-frequency domain dimension, and the time dimension, or the space dimension and the delay-frequency domain dimension through operations such as preprocessing, data ROI processing, smoothing and discrete transform on a phase difference, time-correlation-based redundancy removal, and discrete transform on an amplitude, which removes redundant information in the first complex signal, thereby facilitating transmission and processing of the transformed signal and reducing consumption of radio transmission resources. Correspondingly, the second device may de-transform the transformed signal in combination with the delay-frequency domain dimension and the time dimension, or the space dimension, the delay-frequency domain dimension, and the antenna array dimension, or the space dimension, the delay-frequency domain dimension, and the time dimension, or the space dimension and the delay-frequency domain dimension through operations such as signal restoration, inverse discrete transform and inverse smoothing on a phase, phase prediction, inverse discrete transform on an amplitude, amplitude prediction, ROI prediction, signal prediction, and signal domain change, thereby facilitating reconstruction of the second complex signal, and improving signal reconstruction precision.

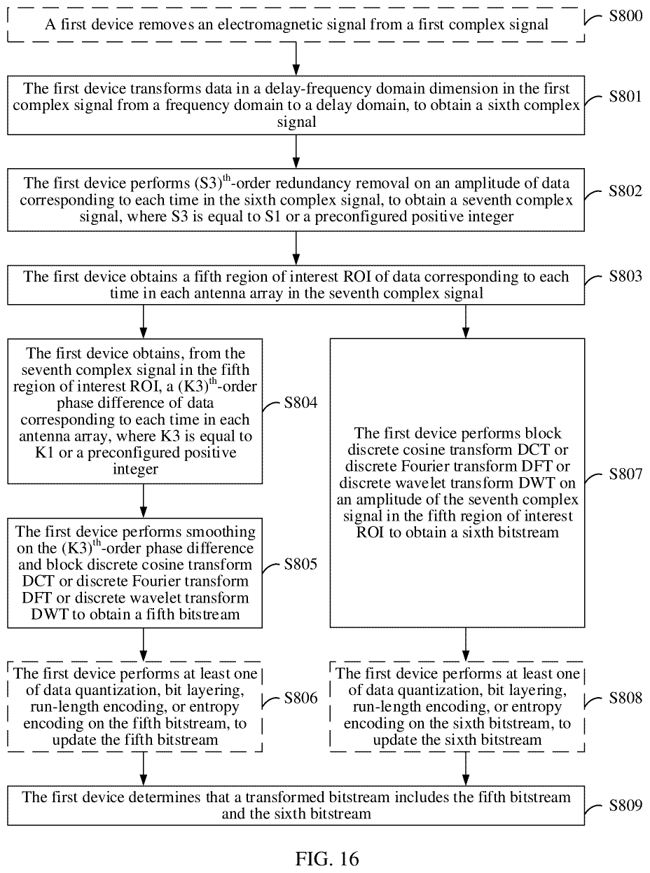

The following describes, in detail with reference to FIG. 16, a specific implementation of signal transform of the first device when the second transform step configuration is the configuration 2.

FIG. 16 is a schematic flowchart of a signal processing method according to an embodiment of this application.

As shown in FIG. 16, the signal processing method in this application may include the following steps.

S800: The first device removes the electromagnetic signal from the first complex signal.

It should be noted that, S800 is an optional step.

For a specific implementation of S800, refer to descriptions of the embodiment of S600 in FIG. 12. Details are not described herein again.

S801: The first device transforms data in the delay-frequency domain dimension in the first complex signal from a frequency domain to a delay domain, to obtain a sixth complex signal.

For a specific implementation of S801, refer to descriptions of the embodiment of S601 in FIG. 12. Details are not described herein again.

It should be noted that S800 and S801 are not necessarily performed in a specific time sequence, and may be performed simultaneously or sequentially.

S802: The first device performs (S3)^{th}-order redundancy removal on an amplitude of data corresponding to each time in the sixth complex signal, to obtain a seventh complex signal, where S3 is equal to S1 or a preconfigured positive integer.

For a specific implementation of S802, refer to descriptions of performing (S2)^{th}-order redundancy removal on the amplitude of the data corresponding to each time in the embodiment of S606 in FIG. 12. Details are not described herein again.

The first device may determine S3 to be equal to S1 in the initial configuration parameter, or may determine S3 to be equal to a preconfigured positive integer. This is not limited in this application.

S803: The first device obtains a fifth region of interest ROI of data corresponding to each time in each antenna array in the seventh complex signal.

For a specific implementation of S803, refer to descriptions of the embodiment of S602 in FIG. 12. Details are not described herein again.

S804: The first device obtains, from the seventh complex signal in the fifth region of interest ROI, a (K3)^{th}-order phase difference of data corresponding to each time in each antenna array, where K3 is equal to K1 or a preconfigured positive integer.

For a specific implementation of S804, refer to descriptions of the embodiment of S603 in FIG. 12. Details are not described herein again.

The first device may determine K3 to be equal to K1 in the initial configuration parameter, or may determine K3 to be equal to a preconfigured positive integer. This is not limited in this application.

S805: The first device performs smoothing and block discrete cosine transform DCT or discrete Fourier transform DFT or discrete wavelet transform DWT on the (K3)^{th}-order phase difference to obtain a fifth bitstream.

For a specific implementation of S805, refer to descriptions of the embodiment of S604 in FIG. 12. Details are not described herein again.

S806: The first device performs at least one of data quantization, bit layering, run-length encoding, or entropy encoding on the fifth bitstream, to update the fifth bitstream.

It should be noted that, S806 is an optional step. In addition, S804 to S806 are performed sequentially.

For a specific implementation of S806, refer to descriptions of the embodiment of S605 in FIG. 12. Details are not described herein again.

S807: The first device performs block discrete cosine transform DCT or discrete Fourier transform DFT or discrete wavelet transform DWT on an amplitude of the seventh complex signal in the fifth region of interest ROI to obtain a sixth bitstream.

For a specific implementation of S807, refer to descriptions of the embodiment of S607 in FIG. 12. Details are not described herein again.

S808: The first device performs at least one of data quantization, bit layering, run-length encoding, or entropy encoding on the sixth bitstream, to update the sixth bitstream.

For a specific implementation of S808, refer to descriptions of the embodiment of S608 in FIG. 12. Details are not described herein again.

In addition, the initial configuration parameter may further include at least one parameter of a data quantization processing switch, a data quantization type, a data quantization parameter, a bit layering processing switch, a run-length encoding processing switch, an entropy encoding processing switch, an entropy encoding type, or the like.

It should be noted that, S808 is an optional step. In addition, S807 and S808 are performed sequentially. S804 and S807 are not necessarily performed in a specific time sequence, and S804 and S807 may be performed simultaneously or sequentially.

S809: The first device determines that the transformed bitstream includes the fifth bitstream and the sixth bitstream.

For a specific implementation of S809, refer to descriptions of the embodiment of S609 in FIG. 12. Details are not described herein again.

In conclusion, the first device may preprocess the first complex signal, perform redundancy removal on the first complex signal in one or more dimensions, and perform phase and amplitude transform on the first complex signal, to remove noise/interference and redundant information from the first complex signal, and shorten a transmission length of the transformed bitstream, making it more convenient to transmit and process the transformed bitstream.

Then, the first device may include the transformed bitstream into a transformed signal and send the transformed signal to the second device.

In addition, in the scenario 3, the transformed signal further includes fourth signaling. The fourth signaling indicates at least one of, for example, a transmission length of the transformed bitstream, a total length of the transformed bitstream, a correlation coefficient for time dimension redundancy removal, or a sixth region of interest ROI.

For specific implementations of the transmission length and the total length of the transformed bitstream, refer to the descriptions in the scenario 1. Details are not described herein again. The correlation coefficient for redundancy removal is αᵢ and βₙ in the embodiment of S606 in FIG. 12.

The sixth region of interest ROI indicates the fifth region of interest ROI. The sixth region of interest ROI is obtained by the first device through redundancy removal on the fifth region of interest ROI of each antenna array. In this way, the first device may transmit the sixth region of interest ROI to the second device, so that the second device restores the fifth region of interest ROI for signal reconstruction.

For a specific implementation of the fifth region of interest ROI, refer to the foregoing descriptions about the third region of interest ROI. For a specific implementation of the sixth region of interest ROI, refer to the foregoing descriptions about the fourth region of interest ROI. Details are not described herein again.

In the initial configuration parameter and the transformed signal in the embodiment in FIG. 14, the second transform step configuration is the configuration 2. Based on descriptions of the embodiment in FIG. 16, the first complex signal received by the first device may include a delay domain channel response signal. In this case, the first device does not need to perform preprocessing, and may determine that the sixth complex signal is the first complex signal.

The first device performs first-order redundancy removal on an amplitude of data at each time in the sixth complex signal, to obtain a seventh complex signal.

The first device may obtain the first Mₜₐₚ taps with maximum power from the seventh complex signal, so that a percentage of energy of the first Mₜₐₚ taps in total energy of all taps exceeds 99% (corresponding to a normalized mean square error (NMSE) lower than 10⁻²), to obtain a data range corresponding to each time in each antenna array, that is, a fifth region of interest ROI.

The first device may obtain, from the seventh complex signal in the fifth region of interest ROI, a first-order phase difference of data at each time in each antenna array.

The first device may perform smoothing and block DCT on the first-order phase difference, to obtain a fifth bitstream.

During the block DCT, 5*5 space-delay blocks are first obtained through division, and then DCT is performed on each space-delay block.

The first device performs data quantization, bit layering, run-length encoding, and entropy encoding on the fifth bitstream, to update the third bitstream.

In the update process, 8-bit uniform scalar quantization is first performed, then run-length encoding is performed on alternating current coefficients, a difference operation is performed on direct current coefficients, and arithmetic coding is performed on all coefficients to update the bitstream.

The first device may perform block DCT on an amplitude of the seventh complex signal in the fifth region of interest ROI to obtain a sixth bitstream.

During the block DCT, 5*5 space-delay blocks are first obtained through division, and then DCT is performed on each space-delay block.

The first device performs data quantization, bit layering, run-length encoding, and entropy encoding on the sixth bitstream, to update the fourth bitstream.

In the update process, 8-bit uniform scalar quantization is first performed, then run-length encoding is performed on alternating current coefficients, a difference operation is performed on direct current coefficients, and arithmetic coding is performed on all coefficients to update the bitstream.

The first device may determine that the transformed bitstream includes the fifth bitstream and the sixth bitstream.

Then, the first device may send a transformed signal shown in FIG. 14 to the second device.

In FIG. 14, the transformed signal may include the transformed bitstream (Payload (payload) is used as an example in FIG. 14) and the third signaling (configuration information of Payload is used as an example in FIG. 14). The configuration information of Payload may include but is not limited to preconfigured data of the correlation coefficient, the redundancy removal processing switch being “on”, the sixth region of interest ROI, length information of Payload, or the like.

Based on descriptions of the foregoing embodiment, the second device may de-transform the transformed bitstream in the transformed signal based on the initial configuration parameter in combination with the space dimension, the delay-frequency domain dimension, the antenna array dimension, and the time dimension, or the space dimension, the delay-frequency domain dimension, and the antenna array dimension, or the space dimension, the delay-frequency domain dimension, and the time dimension, or the space dimension and the delay-frequency domain dimension, to obtain the second complex signal.

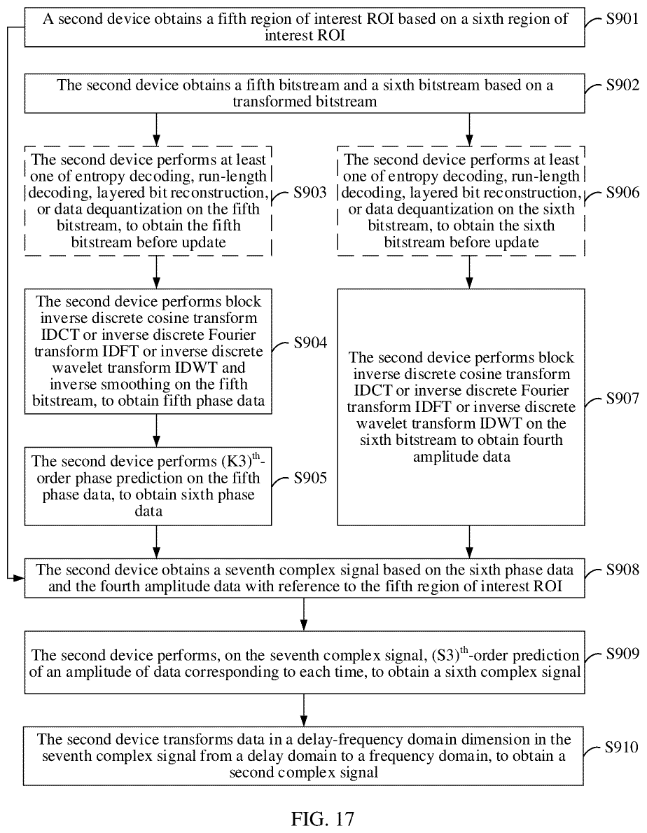

The following describes, in detail with reference to FIG. 17, a specific implementation of signal de-transform of the second device.

FIG. 17 is a schematic flowchart of a signal processing method according to an embodiment of this application.

As shown in FIG. 17, the signal processing method in this application may include the following steps.

S901: The second device obtains the fifth region of interest ROI based on the sixth region of interest ROI.

A specific implementation of S901 and the foregoing process in which the first device obtains the sixth region of interest ROI based on the fifth region of interest ROI are inverse processes to each other, and details are not described herein again.

S902: The second device obtains the fifth bitstream and the sixth bitstream based on the transformed bitstream.

S902 and S809 in FIG. 16 are inverse processes to each other. For a specific implementation of S902, refer to descriptions of the embodiment of S809 in FIG. 16. Details are not described herein again.

It should be noted that S901 and S902 are not necessarily performed in a specific time sequence, and S901 and S902 may be performed simultaneously or sequentially.

S903: The second device performs at least one of entropy decoding, run-length decoding, layered bit reconstruction, or data dequantization on the fifth bitstream, to obtain the fifth bitstream before update.

It should be noted that, S903 is an optional step.

The entropy decoding and entropy encoding, the run-length decoding and run-length encoding, the layered bit reconstruction and bit layering, and the data dequantization and data quantization are all inverse processes to each other.

For a specific implementation of S903, refer to descriptions of the embodiment of S806 in FIG. 16. Details are not described herein again.

S904: The second device performs block inverse discrete cosine transform IDCT or inverse discrete Fourier transform IDFT or inverse discrete wavelet transform IDWT and inverse smoothing on the fifth bitstream, to obtain fifth phase data.

The block IDCT and block DCT, the block IDFT and block DFT, the block IDWT and block DWT, and the inverse smoothing and smoothing are all inverse processes to each other.

For a specific implementation of S904, refer to descriptions of the embodiment of S805 in FIG. 16. Details are not described herein again.

S905: The second device performs (K3)^{th}-order phase prediction on the fifth phase data, to obtain sixth phase data.

The (K3)^{th}-order phase prediction and (K3)^{th}-order phase difference calculation are inverse processes to each other.

For a specific implementation of S905, refer to descriptions of the embodiment of S804 in FIG. 16. Details are not described herein again.

It should be noted that S903 to S905 are performed sequentially.

S906: The second device performs at least one of entropy decoding, run-length decoding, layered bit reconstruction, or data dequantization on the sixth bitstream, to obtain the sixth bitstream before update.

It should be noted that, S906 is an optional step.

The entropy decoding and entropy encoding, the run-length decoding and run-length encoding, the layered bit reconstruction and bit layering, and the data dequantization and data quantization are all inverse processes to each other.

For a specific implementation of S906, refer to descriptions of the embodiment of S808 in FIG. 16. Details are not described herein again.

S907. The second device performs block inverse discrete cosine transform IDCT or inverse discrete Fourier transform IDFT or inverse discrete wavelet transform IDWT on the sixth bitstream to obtain fourth amplitude data.

The block IDCT and block DCT, the block IDFT and block DFT, the block IDWT and block DWT, and the inverse smoothing and smoothing are all inverse processes to each other.

For a specific implementation of S907, refer to descriptions of the embodiment of S807 in FIG. 16. Details are not described herein again.

It should be noted that S906 and S907 are performed sequentially. S904 and S907 are not necessarily performed in a specific time sequence, and S904 and S907 may be performed simultaneously or sequentially.

S908: The second device obtains the seventh complex signal based on the sixth phase data and the fourth amplitude data in combination with the fifth region of interest ROI.

For a specific implementation of S908, refer to descriptions of the embodiment of S803 in FIG. 16. Details are not described herein again.

S909: The second device performs, on the seventh complex signal, (S3)^{th}-order prediction of an amplitude of data corresponding to each time, to obtain the sixth complex signal.

The (S3)^{th}-order prediction and (S3)^{th}-order redundancy removal are inverse processes to each other.

For a specific implementation of S909, refer to descriptions of the embodiment of S802 in FIG. 16. Details are not described herein again.

S910: The second device transforms data in the delay-frequency domain dimension in the seventh complex signal from the delay domain to the frequency domain, to obtain the second complex signal.

For a specific implementation of S910, refer to descriptions of transforming the data in the delay-frequency domain dimension in the first complex signal from the frequency domain to the delay domain in the embodiment of S801 in FIG. 16. Details are not described herein again.

In conclusion, the second device may reconstruct the second complex signal by de-transforming the transformed signal.

In the scenario 3, the first device may transform the first complex signal in combination with the space dimension, the delay-frequency domain dimension, the antenna array dimension, and the time dimension, or the space dimension and the delay-frequency domain dimension, or the space dimension, the delay-frequency domain dimension, and the antenna array dimension, or the space dimension, the delay-frequency domain dimension, and the time dimension through operations such as preprocessing, time-correlation-based redundancy removal, data ROI processing, smoothing and discrete transform on a phase difference, and discrete transform on an amplitude, which removes redundant information in the first complex signal, thereby facilitating transmission and processing of the transformed signal and reducing consumption of radio transmission resources. Correspondingly, the second device may de-transform the transformed signal in combination with the space dimension, the delay-frequency domain dimension, the antenna array dimension, and the time dimension, or the space dimension, the delay-frequency domain dimension, and the antenna array dimension, or the space dimension, the delay-frequency domain dimension, and the time dimension, or the space dimension and the delay-frequency domain dimension through operations such as signal restoration, inverse discrete transform and inverse smoothing on a phase, phase prediction, inverse discrete transform on an amplitude, amplitude prediction, ROI prediction, signal prediction, and signal domain change, thereby facilitating reconstruction of the second complex signal, and improving signal reconstruction precision.

Based on descriptions of the foregoing embodiment, the first device and the second device need to perform signal transmission by using a radio transmission resource.

In the communication system shown in FIG. 1A, the first device is UE, and the second device is a BS. In this case, the first device cannot actively send the transformed signal to the second device, and needs to request a transmission resource for the transformed bitstream from the second device, to send the transformed signal to the second device. In addition, the second device needs to learn of the configuration information of the first device, to de-transform the transformed signal. Then, signal transform, signal transmission, and signal reconstruction can be implemented through cooperation between the first device and the second device.

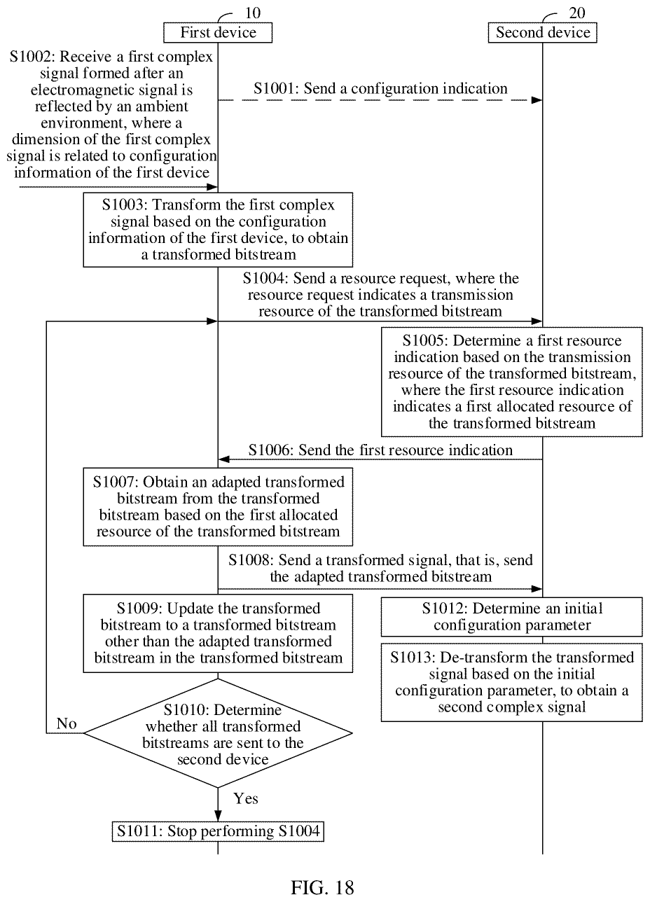

The following describes, in detail with reference to FIG. 18, a specific implementation of implementing a signal processing method by the first device and the second device.

FIG. 18 is a signaling interaction diagram of a signal processing method according to an embodiment of this application.

As shown in FIG. 18, the signal processing method in this application may include the following steps.

S1001: The first device sends a configuration indication to the second device.

It should be noted that S1001 is an optional step.

Based on pre-agreement between the first device and the second device, when the first device determines that S1001 does not need to be performed, the second device may learn of agreed configuration information of the first device, so that the second device determines an initial configuration parameter based on the configuration information of the first device. When the first device determines that S1001 needs to be performed, the second device may determine an initial configuration parameter based on a received configuration indication.

The configuration indication indicates the initial configuration parameter. A specific implementation of the configuration indication is not limited in this application.

In some embodiments, the configuration indication may include the initial configuration parameter, and the initial configuration parameter is related to configuration information of the first device.

In some other embodiments, the configuration indication may indicate a type of a first complex signal, and the type of the first complex signal is related to the initial configuration parameter. In this way, a correlation relationship between the type of the first complex signal and the initial configuration parameter is established in advance, so that resource overheads can be reduced.

The type of the first complex signal indicates at least one parameter of each dimension included in the first complex signal, a size of each dimension, a type of an electromagnetic signal, or the like. For a specific implementation of the initial configuration parameter, refer to the foregoing descriptions. Details are not described herein again.

The correlation relationship between the type of the first complex signal and the initial configuration parameter may be represented in a manner such as a table, a matrix, or a key-value pair.

For example, for the scenario 3, Table 1 and Table 2 are used to show some content of initial configuration parameters related to different types of first complex signals.

In Table 2, a block size of block DCT and a time dimension data size of a first complex signal may be indicated in another manner.

TABLE 1

| Type of | | Block | | | | | |
|---|---|---|---|---|---|---|---|
| the first | Data size of the | size of | Second | K1 | | | |
| complex | first complex | block | transform step | and | Fourth data | R1 and | Data |
| signal | signal | DCT | configuration | S1 | and sixth data | fifth data | quantization |
| 1 | 512*512*601*2*80 | 8*8 | Configuration | First | Data | First | Uniform |
| | | | 1 | order | corresponding | order, | scalar |
| | | | | | to a previous | previous | quantization, |
| | | | | | time | antenna | 8 bits |
| | | | | | | array | |
| 2 | 512*512*601*2*80 | 8*8 | Configuration | First | Data | First | Non-uniform |
| | | | 1 | order | corresponding | order, | vector |
| | | | | | to a previous | previous | quantization, |
| | | | | | time | antenna | 8 bits |
| | | | | | | array | |
| 3 | 1024*1024*601*1*80 | 16*16 | Configuration | First | Data | / | Uniform |
| | | | 2 | order | corresponding | | scalar |
| | | | | | to a previous | | quantization, |
| | | | | | time | | 8 bits |
| 4 | 1024*1024*601*1*80 | 16*16 | Configuration | First | Data | / | Non-uniform |
| | | | 2 | order | corresponding | | vector |
| | | | | | to a previous | | quantization, |
| | | | | | time | | 8 bits |

TABLE 2

| Type of | | | | | | |
|---|---|---|---|---|---|---|
| the first | Size of some data | Second | | | | |
| complex | of the first complex | transform step | K1 and | Fourth data | R1 and | Data |
| signal | signal | configuration | S1 | and sixth data | fifth data | quantization |
| 1 | 512*512*601*2 | Configuration | First | Data | First order, | Uniform |
| | | 1 | order | corresponding | previous | scalar |
| | | | | to a previous | antenna | quantization, |
| | | | | time | array | 8 bits |
| 2 | 512*512*601*2 | Configuration | First | Data | First order, | Non-uniform |
| | | 1 | order | corresponding | previous | vector |
| | | | | to a previous | antenna | quantization, |
| | | | | time | array | 8 bits |
| 3 | 1024*1024*601*1 | Configuration | First | Data | / | Uniform |
| | | 2 | order | corresponding | | scalar |
| | | | | to a previous | | quantization, |
| | | | | time | | 8 bits |
| 4 | 1024*1024*601*1 | Configuration | First | Data | / | Non-uniform |
| | | 2 | order | corresponding | | vector |
| | | | | to a previous | | quantization, |
| | | | | time | | 8 bits |

S1002: The first device receives a first complex signal formed after an electromagnetic signal is reflected by an ambient environment, where a dimension of the first complex signal is related to the configuration information of the first device.

S1003: The first device transforms the first complex signal based on the initial configuration parameter to obtain a transformed bitstream.

For specific implementations of S1002 and S1003, refer to descriptions of the embodiments of S101 and S102 in FIG. 2. Details are not described herein again.

S1004: The first device sends a resource request to the second device, where the resource request indicates a transmission resource of the transformed bitstream.

A specific implementation of the resource request is not limited in this application. In addition, the transmission resource of the transformed bitstream mentioned herein means how many transmission resources are required to transmit all current transformed bitstreams. For a specific implementation of the transmission resource of the transformed bitstream, refer to the foregoing descriptions. This is not limited herein. In addition, the resource request may be configured periodically.

S1005: The second device determines a first resource indication based on the transmission resource of the transformed bitstream, where the first resource indication indicates a first allocated resource of the transformed bitstream.

The second device may obtain, through analysis based on factors such as the transmission resource of the transformed bitstream, a channel status between the first device and the second device, and an actual situation, a transmission resource on which the second device allows the first device to transmit the transformed bitstream at most at a time, that is, the first allocated resource of the transformed bitstream, to obtain the first resource indication.

A specific implementation of the first resource indication is not limited in this application.

The first allocated resource of the transformed bitstream indicates a transmission requirement and a reconstruction requirement for the transformed bitstream, for example, at least one parameter of a length range, a maximum length, a minimum length, a distortion amount range, a maximum distortion amount, a minimum distortion amount, a compression rate range, a maximum compression rate, or a minimum compression rate of a transformed bitstream that can be transmitted.

S1006: The second device sends the first resource indication to the first device.

S1007: The first device obtains an adapted transformed bitstream from the transformed bitstream based on the first allocated resource of the transformed bitstream.

The first device may obtain the adapted transformed bitstream from the transformed bitstream in a plurality of manners based on the first allocated resource of the transformed bitstream.

In some embodiments, the first device may determine a first transform parameter based on the first allocated resource of the transformed bitstream. The first transform parameter includes at least one of the following: a first length, a first distortion amount, and a first compression rate. Then, the first device may determine that the adapted transformed bitstream is a transformed bitstream that is in the transformed bitstream and that is adapted to the first transform parameter.

In some other embodiments, the first device may obtain a first transformed bitstream from the transformed bitstream based on a preconfigured transmission resource. A size of the preconfigured transmission resource may be a size of a transmission resource used when a transformed bitstream is transmitted last time, or may be a preset size.

The first device may determine whether the preconfigured transmission resource conforms to the first allocated resource of the transformed bitstream.

If the preconfigured transmission resource conforms to the first allocated resource of the transformed bitstream, the first device may determine the first transformed bitstream as the adapted transformed bitstream, to facilitate device operations.

If the preconfigured transmission resource does not conform to the first allocated resource of the transformed bitstream, the first device may determine a second transform parameter based on the first allocated resource of the transformed bitstream. The second transform parameter includes at least one of the following: a second length, a second distortion amount, and a second compression rate. Then, the first device may determine that the adapted transformed bitstream is a transformed bitstream that is in the transformed bitstream and that is adapted to the second transform parameter.

S1008: The first device sends a transformed signal to the second device, that is, sends the adapted transformed bitstream.

For a specific implementation of S1008, refer to descriptions in which the first device sends the transformed signal to the second device in the embodiment of S103 in FIG. 2. Details are not described herein again.

S1009: The first device updates the transformed bitstream to a transformed bitstream other than the adapted transformed bitstream in the transformed bitstream.

After determining the adapted transformed bitstream, the first device does not need to further transmit the adapted transformed bitstream again. Therefore, the first device may update the current transformed bitstream in S1004 to S1007 to a transformed bitstream other than the adapted transformed bitstream in the transformed bitstream. This makes it convenient to subsequently send a remaining transformed bitstream, and avoids repeatedly sending the transformed bitstream.

It should be noted that S1008 and S1009 are not necessarily performed in a specific time sequence, and S1008 and S1009 may be performed simultaneously or sequentially.

S1010: The first device determines whether all transformed bitstreams are sent to the second device.

When determining that all the transformed bitstreams are sent to the second device, the first device performs S1011. When determining that not all the transformed bitstreams are sent to the second device, the first device performs S1004 to S1010.

All the transformed bitstreams mentioned in this application are the transformed bitstream obtained by the first device by transforming the first complex signal based on the initial configuration parameter in S1003.

S1011: The first device stops performing S1004. That is, the first device determines that all the transformed bitstreams have been transmitted to the second device, and does not need to further send a resource request to the second device.

S1012: The second device determines the initial configuration parameter.

When the first device performs S1001, the second device may receive the configuration indication from the first device. Then, the second device may determine the initial configuration parameter based on the configuration indication.

When the first device does not perform S1001, the second device may determine the initial configuration parameter based on the configuration information, learned of in advance, of the first device.

S1013: The second device de-transforms the transformed signal based on the initial configuration parameter, to obtain a second complex signal.

For a specific implementation of S1013, refer to related descriptions in the scenario 1, the scenario 2, and the scenario 3. Details are not described herein again.

In conclusion, the first device may choose, based on factors such as a single-transmission resource of the first device, the transmission resource of the transformed bitstream, the channel status between the first device and the second device, and the transmission requirement and the reconstruction requirement of the second device for the transformed bitstream, to send a transformed signal to the second device at a time or more times, to implement signal transmission and signal reconstruction.

In the communication system shown in FIG. 1B, the first device is a BS, and the second device is UE. In this case, the first device can actively send the transformed signal to the second device without requesting a transmission resource for the transformed bitstream from the second device. In addition, the second device needs to learn of the configuration information of the first device, to de-transform the transformed signal. Then, signal transform, signal transmission, and signal reconstruction can be implemented through cooperation between the first device and the second device.

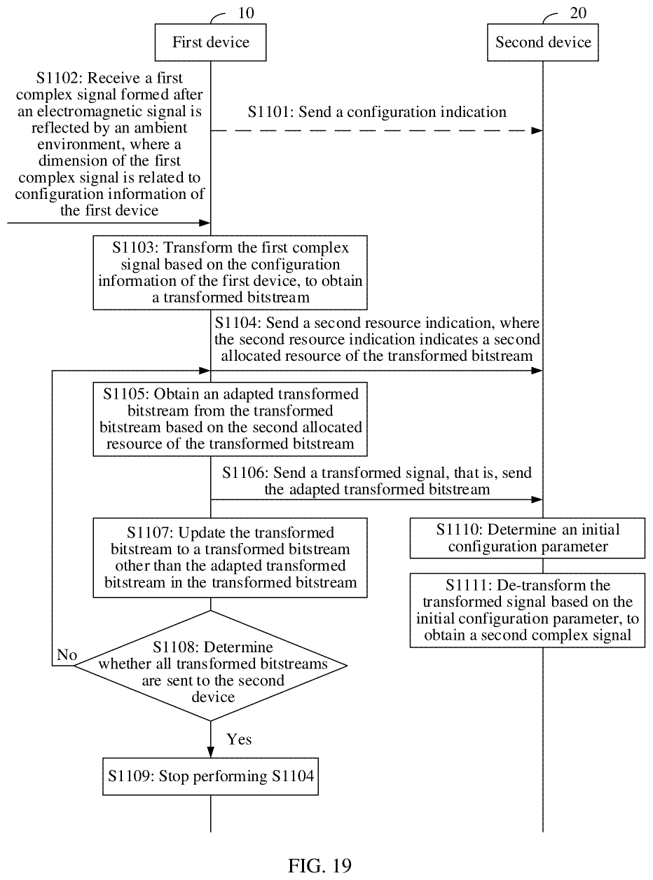

The following describes, in detail with reference to FIG. 19, a specific implementation of implementing a signal processing method by the first device and the second device.

FIG. 19 is a signaling interaction diagram of a signal processing method according to an embodiment of this application.

As shown in FIG. 19, the signal processing method in this application may include the following steps.

S1101: The first device sends a configuration indication to the second device.

For a specific implementation of S1101, refer to descriptions of the embodiment of S1001 in FIG. 18. Details are not described herein again.

S1102: The first device receives a first complex signal formed after an electromagnetic signal is reflected by an ambient environment, where a dimension of the first complex signal is related to the configuration information of the first device.

S1103: The first device transforms the first complex signal based on the initial configuration parameter to obtain a transformed bitstream.

For specific implementations of S1102 and S1103, refer to descriptions of the embodiments of S101 and S102 in FIG. 2. Details are not described herein again.

S1104: The first device sends a second resource indication to the second device, where the second resource indication indicates a second allocated resource of the transformed bitstream.

The first device may obtain, through analysis based on factors such as a transmission resource of the transformed bitstream, a channel status between the first device and the second device, and an actual situation, a transmission resource on which the first device can transmit the transformed bitstream at most at a time, that is, the second allocated resource of the transformed bitstream, to obtain the second resource indication. Then, the first device sends the second resource indication to the second device.

A specific implementation of the second resource indication is not limited in this application.

The second allocated resource of the transformed bitstream indicates a transmission requirement and a reconstruction requirement for the transformed bitstream, for example, at least one parameter of a length range, a maximum length, a minimum length, a distortion amount range, a maximum distortion amount, a minimum distortion amount, a compression rate range, a maximum compression rate, or a minimum compression rate of a transformed bitstream that can be transmitted.

In addition, the second allocated resource of the transformed bitstream may be less than or equal to a single-transmission resource of the first device, or may be a target transmission resource. This is not limited in this application.

S1105: The first device obtains an adapted transformed bitstream from the transformed bitstream based on the second allocated resource of the transformed bitstream.

The first device may obtain the adapted transformed bitstream from the transformed bitstream in a plurality of manners based on the second allocated resource of the transformed bitstream.

For a specific implementation of the foregoing process, refer to descriptions of the embodiment of S1007 in FIG. 18. Details are not described herein again.

S1106: The first device sends a transformed signal to the second device, that is, sends the adapted transformed bitstream.

S1107: The first device updates the transformed bitstream to a transformed bitstream other than the adapted transformed bitstream in the transformed bitstream.

For specific implementations of S1106 and S1107, refer to descriptions of the embodiments of S1008 and S1009 in FIG. 18. Details are not described herein again.

It should be noted that S1106 and S1107 are not necessarily performed in a specific time sequence, and S1106 and S1107 may be performed simultaneously or sequentially.

S1108: The first device determines whether all transformed bitstreams are sent to the second device.

When determining that all the transformed bitstreams are sent to the second device, the first device performs S1109. When determining that not all the transformed bitstreams are sent to the second device, the first device performs S1104 to S1108.

S1109: The first device stops performing S1104. That is, the first device determines that all the transformed bitstreams have been transmitted to the second device, and does not need to further send a second resource indication to the second device.

S1110: The second device determines the initial configuration parameter.

S1111: The second device de-transforms the transformed signal based on the initial configuration parameter, to obtain a second complex signal.

For specific implementations of S1110 and S1111, refer to descriptions of the embodiments of S1012 and S1013 in FIG. 18. Details are not described herein again.

In conclusion, the first device may choose, based on factors such as the single-transmission resource of the first device, the transmission resource of the transformed bitstream, the channel status between the first device and the second device, and the transmission requirement and the reconstruction requirement of the second device for the transformed bitstream, to send a transformed signal to the second device at a time or more times, to implement signal transform, signal transmission, and signal reconstruction.

For example, this application further provides a signal processing apparatus.

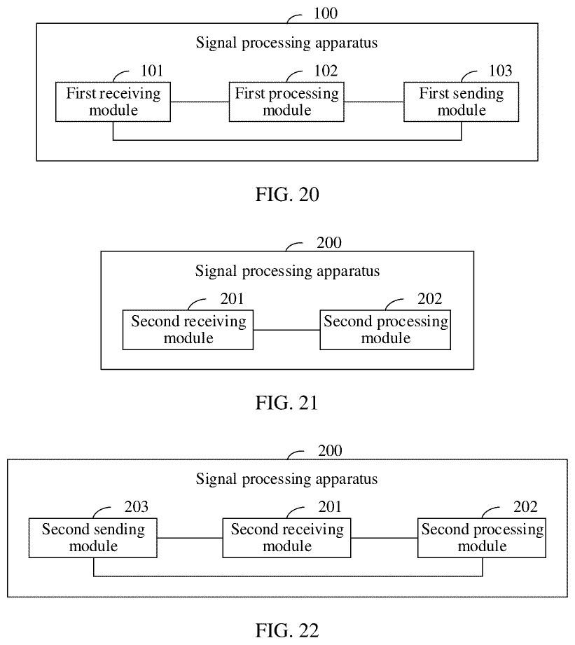

FIG. 20 is a diagram of a structure of a signal processing apparatus according to an embodiment of this application.

The signal processing apparatus 100 may exist independently, or may be integrated into another device, and may communicate with the second device in FIG. 1A or FIG. 1B, and is configured to implement an operation corresponding to the first device in any one of the foregoing method embodiments. As shown in FIG. 20, the signal processing apparatus 100 in this application may include:
a first receiving module 101, configured to receive a first complex signal formed after an electromagnetic signal is reflected by an ambient environment, where a dimension of the first complex signal is related to configuration information of the first device;
a first processing module 102, configured to transform the first complex signal based on the configuration information of the first device, to obtain a transformed bitstream; and
a first sending module 103, configured to send a transformed signal to a second device, where the transformed signal includes the transformed bitstream, so that the second device de-transforms the transformed signal based on the configuration information of the first device to obtain a second complex signal.

In some embodiments, the first processing module 102 is configured to: when the first complex signal includes data in a space dimension and a time dimension, or data in the space dimension,
determine an initial configuration parameter based on the configuration information of the first device, where the initial configuration parameter includes a space dimension size and a time dimension size of the first complex signal, and at least one of the following: a block size of block discrete cosine transform DCT or discrete Fourier transform DFT or discrete wavelet transform DWT, a block quantity of block discrete cosine transform DCT or discrete Fourier transform DFT or discrete wavelet transform DWT, a phase processing switch, a phase difference order M1, an amplitude processing switch, or an amplitude difference order Q1, where M1 and Q1 are positive integers; and
transform the first complex signal based on the initial configuration parameter to obtain the transformed bitstream.

In some embodiments, the first processing module 102 is specifically configured to obtain, from the first complex signal, an (M2)^{th}-order phase difference of data corresponding to each time, where M2 is equal to M1 or a preconfigured positive integer;
perform smoothing and block discrete cosine transform DCT or discrete Fourier transform DFT or discrete wavelet transform DWT on the (M2)^{th}-order phase difference to obtain a first bitstream;
obtain, from the first complex signal, a (Q2)^{m}-order amplitude difference of the data corresponding to each time, where Q2 is equal to Q1 or a preconfigured positive integer;
perform block discrete cosine transform DCT or discrete Fourier transform DFT or discrete wavelet transform DWT on the (Q2)^{th}-order amplitude difference to obtain a second bitstream; and
determine that the transformed bitstream includes the first bitstream and the second bitstream.

In some embodiments, the transformed signal further includes first signaling, and the first signaling indicates a transmission length of the transformed bitstream and/or a total length of the transformed bitstream.

In some embodiments, the first processing module 102 is configured to: when the first complex signal includes data in a delay-frequency domain dimension and a time dimension, or data in the delay-frequency domain dimension,
determine an initial configuration parameter based on the configuration information of the first device, where the initial configuration parameter includes a delay-frequency domain dimension size and a time dimension size of the first complex signal, and at least one of the following: a redundancy removal processing switch, a redundancy removal order P1, or a first transform step configuration, where P1 is a positive integer; and
transform the first complex signal based on the initial configuration parameter to obtain the transformed bitstream.

In some embodiments, the first processing module 102 is specifically configured to transform data in the delay-frequency domain dimension in the first complex signal from a frequency domain to a delay domain, to obtain a third complex signal;
obtain a first region of interest ROI of data corresponding to each time in the third complex signal;
perform (P2)^{th}-order redundancy removal on the data corresponding to each time in the third complex signal, to obtain a fourth complex signal, where P2 is equal to P1 or a preconfigured positive integer; and
obtain the transformed bitstream based on the first region of interest ROI and the fourth complex signal.

In some embodiments, the transformed signal further includes second signaling, and the second signaling indicates at least one of the following: a transmission length of the transformed bitstream, a total length of the transformed bitstream, a correlation coefficient for redundancy removal, or a second region of interest ROI. The second region of interest ROI is obtained by the first processing module 102 through redundancy removal on the first region of interest ROI.

In some embodiments, the first processing module 102 is configured to: when the first complex signal includes data in a space dimension, a delay-frequency domain dimension, an antenna array dimension, and a time dimension, or data in the space dimension, the delay-frequency domain dimension, and the time dimension,
determine an initial configuration parameter based on the configuration information of the first device, where the initial configuration parameter includes a space dimension size, a delay-frequency domain dimension size, an antenna array dimension size, and a time dimension size of the first complex signal, and at least one of the following: a block size of block discrete cosine transform DCT or discrete Fourier transform DFT or discrete wavelet transform DWT, a block quantity of block discrete cosine transform DCT or discrete Fourier transform DFT or discrete wavelet transform DWT, a second transform step configuration, a phase processing switch, a phase difference order K1, an antenna array dimension redundancy removal processing switch, an antenna array dimension redundancy removal order R1, a time dimension redundancy removal processing switch, or an order S1 of the time dimension redundancy removal processing switch, where K1, R1, and S1 are positive integers; and
transform the first complex signal based on the initial configuration parameter to obtain the transformed bitstream.

In some embodiments, the first processing module 102 is configured to perform at least one of the following based on the second transform step configuration and the first complex signal:
obtaining a region of interest ROI of a signal in the space dimension and the delay-frequency domain dimension, performing smoothing and block discrete cosine transform DCT or discrete Fourier transform DFT or discrete wavelet transform DWT on a phase difference of the signal, and performing antenna array dimension redundancy removal on the signal, or performing time dimension redundancy removal on the signal.

The signal is the first complex signal or a signal obtained by transforming the first complex signal.

In some embodiments, the first processing module 102 is specifically configured to transform data in the delay-frequency domain dimension in the first complex signal from a frequency domain to a delay domain, to obtain a fifth complex signal;
obtain a third region of interest ROI of data corresponding to each time in each antenna array in the fifth complex signal;
obtain, from the fifth complex signal in the third region of interest ROI, a (K2)^{th}-order phase difference of data corresponding to each time in each antenna array, where K2 is equal to K1 or a preconfigured positive integer;
perform smoothing and block discrete cosine transform DCT or discrete Fourier transform DFT or discrete wavelet transform DWT on the (K2)^{th}-order phase difference to obtain a third bitstream;
perform, in the fifth complex signal in the third region of interest ROI, (R2)^{th}-order redundancy removal on an amplitude of data corresponding to each antenna array and (S2)^{th}-order redundancy removal on an amplitude of data corresponding to each time, to obtain a real signal, where R2 is equal to R1 or a preconfigured positive integer, and S2 is equal to S1 or a preconfigured positive integer;
perform block discrete cosine transform DCT or discrete Fourier transform DFT or discrete wavelet transform DWT on the real signal to obtain a fourth bitstream; and
determine that the transformed bitstream includes the third bitstream and the fourth bitstream.

In some embodiments, the transformed signal further includes third signaling, and the third signaling indicates at least one of the following: a transmission length of the transformed bitstream, a total length of the transformed bitstream, a correlation coefficient for antenna array dimension redundancy removal, a correlation coefficient for time dimension redundancy removal, or a fourth region of interest ROI. The fourth region of interest ROI is obtained by the first processing module 102 through redundancy removal on the third region of interest ROI of each antenna array.

In some embodiments, the first processing module 102 is specifically configured to transform data in the delay-frequency domain dimension in the first complex signal from a frequency domain to a delay domain, to obtain a sixth complex signal;
perform (S3)^{th}-order redundancy removal on an amplitude of data corresponding to each time in the sixth complex signal, to obtain a seventh complex signal, where S3 is equal to S1 or a preconfigured positive integer;
obtain a fifth region of interest ROI of data corresponding to each time in each antenna array in the seventh complex signal;
obtain, from the seventh complex signal in the fifth region of interest ROI, a (K3)^{th}-order phase difference of data corresponding to each time in each antenna array, where K3 is equal to K1 or a preconfigured positive integer;
perform smoothing and block discrete cosine transform DCT or discrete Fourier transform DFT or discrete wavelet transform DWT on the (K3)^{th}-order phase difference to obtain a fifth bitstream;
perform block discrete cosine transform DCT or discrete Fourier transform DFT or discrete wavelet transform DWT on an amplitude of the seventh complex signal in the fifth region of interest ROI to obtain a sixth bitstream; and
determine that the transformed bitstream includes the fifth bitstream and the sixth bitstream.

In some embodiments, the transformed signal further includes fourth signaling, and the fourth signaling indicates at least one of the following: a transmission length of the transformed bitstream, a total length of the transformed bitstream, a correlation coefficient for time dimension redundancy removal, or a sixth region of interest ROI. The sixth region of interest ROI is obtained by the first processing module 102 through redundancy removal on the fifth region of interest ROI of each antenna array.

In some embodiments, the first processing module 102 is further configured to: before the transformed signal is sent to the second device, perform at least one of data quantization, bit layering, run-length encoding, or entropy encoding on a corresponding bitstream, to update the corresponding bitstream.

In some embodiments, a data quantization type is related to a data distribution status before data quantization and a channel status between the first device and the second device.

In some embodiments, the first sending module 103 is further configured to: before the first receiving module 101 receives the first complex signal formed after the electromagnetic signal is reflected by the ambient environment, transmit the electromagnetic signal, so that the first receiving module 101 receives the first complex signal; or
send a transmit request to a third device, where the transmit request is used by the third device to transmit the electromagnetic signal, so that the first receiving module receives the first complex signal, and the third device is different from the first device.

In some embodiments, the first sending module 103 is further configured to: send a configuration indication to the second device, where the configuration indication includes the initial configuration parameter, and the initial configuration parameter is related to the configuration information of the first device, so that the second device determines the initial configuration parameter based on the configuration indication, and de-transforms the transformed signal based on the initial configuration parameter, to obtain the second complex signal; or
send a configuration indication to the second device, where the configuration indication indicates a type of the first complex signal, and the type of the first complex signal is related to the initial configuration parameter, so that the second device determines the initial configuration parameter based on the configuration indication, and de-transforms the transformed signal based on the initial configuration parameter, to obtain the second complex signal.

In some embodiments, the dimension of the first complex signal is related to at least one of the following in the configuration information of the first device:
an antenna configuration of the first device, a quantity of carriers of the first device, or a duration for signal collection of the first device.

In some embodiments, the first sending module 103 is further configured to: before sending the transformed signal to the second device, send a resource request to the second device. The resource request is used to request a transmission resource of the transformed bitstream.

The first receiving module 101 is further configured to receive a first resource indication from the second device. The first resource indication indicates a first allocated resource of the transformed bitstream.

The first processing module 102 is further configured to obtain an adapted transformed bitstream from the transformed bitstream based on the first allocated resource of the transformed bitstream.

The first sending module 103 is further configured to send the transformed signal to the second device, that is, send the adapted transformed bitstream.

In some embodiments, the first processing module 102 is further configured to: determine a first transform parameter based on the first allocated resource of the transformed bitstream, where the first transform parameter includes at least one of the following: a first length, a first distortion amount, and a first compression rate; and
determine that the adapted transformed bitstream is a transformed bitstream that is in the transformed bitstream and that is adapted to the first transform parameter.

In some embodiments, the first processing module 102 is specifically configured to: obtain a first transformed bitstream from the transformed bitstream based on a preconfigured transmission resource; and
when determining that the preconfigured transmission resource conforms to the first allocated resource of the transformed bitstream, determine the first transformed bitstream as the adapted transformed bitstream; or
when determining that the preconfigured transmission resource does not conform to the first allocated resource of the transformed bitstream, determine a second transform parameter based on the first allocated resource of the transformed bitstream, where the second transform parameter includes at least one of the following: a second length, a second distortion amount, and a second compression ratio, and determine that the adapted transformed bitstream is a transformed bitstream that is in the transformed bitstream and that is adapted to the second transform parameter.

In some embodiments, the first sending module 103 is further configured to: before sending the transformed signal to the second device, send a second resource indication to the second device. The second resource indication indicates a second allocated resource of the transformed bitstream.

The first processing module 102 is further configured to obtain an adapted transformed bitstream from the transformed bitstream based on the second allocated resource of the transformed bitstream.

The first sending module 103 is further configured to send the transformed signal to the second device, that is, send the adapted transformed bitstream.

For example, this application further provides a signal processing apparatus.

FIG. 21 is a diagram of a structure of a signal processing apparatus according to an embodiment of this application.

The signal processing apparatus 200 may exist independently, or may be integrated into another device, and may communicate with the first device in FIG. 1A or FIG. 1B, and is configured to implement an operation corresponding to the second device in any one of the foregoing method embodiments. As shown in FIG. 21, the signal processing apparatus 200 in this application may include:
a second receiving module 201, configured to receive a transformed signal from a first device, where the transformed signal includes a transformed bitstream, the transformed bitstream is obtained by the first device by transforming a first complex signal based on configuration information of the first device, the first complex signal is obtained by reflecting an electromagnetic signal by an ambient environment and received by the first device, and a dimension of the first complex signal is related to the configuration information of the first device; and
a second processing module 202, configured to de-transform the transformed signal based on the configuration information of the first device, to obtain a second complex signal.

In some embodiments, the transformed signal further includes an instruction, and the instruction indicates a transmission length of the transformed bitstream and/or a total length of the transformed bitstream.

In some embodiments, the second receiving module 201 is further configured to receive a configuration indication from the first device. The configuration indication includes an initial configuration parameter, and the initial configuration parameter is related to the configuration information of the first device.

The second processing module 202 is specifically configured to: determine the initial configuration parameter based on the configuration indication; and de-transform the transformed signal based on the initial configuration parameter, to obtain the second complex signal.

In some embodiments, the second receiving module 201 is further configured to receive a configuration indication from the first device. The configuration indication indicates a type of the first complex signal, and the type of the first complex signal is related to an initial configuration parameter.

The second processing module 202 is specifically configured to: determine the initial configuration parameter based on the configuration indication; and de-transform the transformed signal based on the initial configuration parameter, to obtain the second complex signal.

In some embodiments, the dimension of the first complex signal is related to at least one of the following in the configuration information of the first device:
an antenna configuration of the first device, a quantity of carriers of the first device, or a duration for signal collection of the first device.

FIG. 22 is a diagram of a structure of a signal processing apparatus according to an embodiment of this application.

As shown in FIG. 22, based on the structure shown in FIG. 21, the signal processing apparatus 200 may further include a second sending module 203.

The second receiving module 201 is further configured to receive a resource request from the first device. The resource request is used to request a transmission resource of the transformed bitstream.

The second processing module 202 is further configured to determine a first resource indication based on the transmission resource of the transformed bitstream. The first resource indication indicates a first allocated resource of the transformed bitstream.

The second sending module 203 is configured to send the first resource indication to the first device, so that the first device obtains an adapted transformed bitstream from the transformed bitstream based on the first allocated resource of the transformed bitstream.

The second receiving module 201 is specifically configured to receive the transformed signal from the first device, that is, receive the adapted transformed bitstream.

In some embodiments, the second receiving module 201 is further configured to receive a second resource indication from the first device. The second resource indication indicates a second allocated resource of the transformed bitstream.

The second receiving module 201 is specifically configured to receive the transformed signal from the first device, that is, receive an adapted transformed bitstream. The adapted transformed bitstream is obtained by the first device from the transformed bitstream based on the second allocated resource of the transformed bitstream.

The signal processing apparatus in this application may be configured to perform the technical solutions in the foregoing method embodiments, and implementation principles and technical effects thereof are similar. For an operation implemented by each module therein, further refer to related descriptions in the method embodiments. Details are not described herein again. The module herein may be replaced with a component or a circuit.

In this application, the first device and the second device may be divided into functional modules based on the foregoing method examples. For example, functional modules corresponding to various functions are obtained through division, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used.

For example, this application further provides a signal processing apparatus.

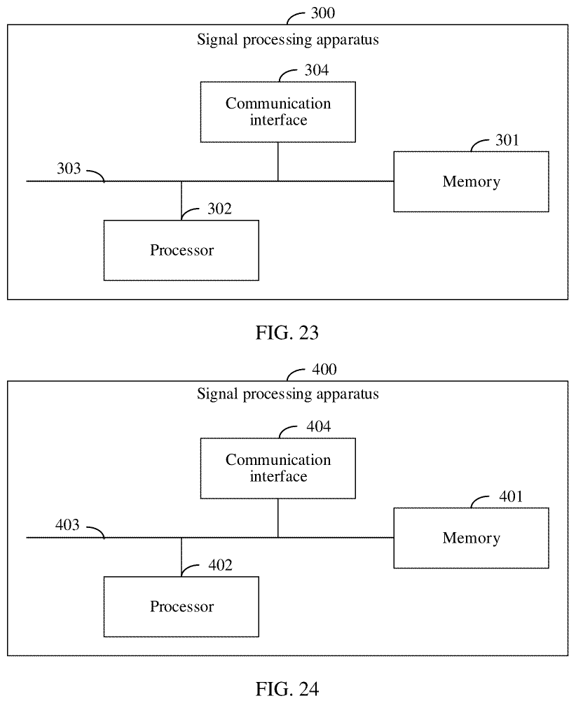

FIG. 23 is a diagram of a hardware structure of a signal processing apparatus according to an embodiment of this application.

As hardware support of the first device in FIG. 1A or FIG. 1B, the signal processing apparatus 300 may provide, for the second device, a transformed signal that represents an ambient environment feature, and is configured to implement an operation corresponding to the first device in any one of the foregoing method embodiments, so that the second device can obtain the ambient environment feature by using the transformed signal.

As shown in FIG. 23, the signal processing apparatus 300 in this application may include a memory 301 and a processor 302. The memory 301 and the processor 302 may be connected through a bus 303. Optionally, the processor and the memory are integrated.

The memory 301 is configured to store program code.

The processor 302 invokes the program code, and is configured to perform the signal processing method in any one of the foregoing embodiments when the program code is executed. For details, refer to related descriptions in the foregoing method embodiments.

Optionally, this application further includes a communication interface 304. The communication interface 304 may be connected to the processor 302 through the bus 303. The processor 302 may control the communication interface 303 to implement the foregoing receiving and sending functions of the signal processing apparatus 300.

The signal processing apparatus in this embodiment of this application may be configured to implement the technical solutions in the foregoing method embodiments. Implementation principles and technical effects thereof are similar, and details are not described herein again.

For example, this application further provides a signal processing apparatus.

FIG. 24 is a diagram of a hardware structure of a signal processing apparatus according to an embodiment of this application.

As hardware support of the second device in FIG. 1A or FIG. 1B, the signal processing apparatus 400 may obtain an ambient environment feature by using the first device, and is configured to implement an operation corresponding to the second device in any one of the foregoing method embodiments.

As shown in FIG. 24, the signal processing apparatus 400 in this application may include a memory 401 and a processor 402. The memory 401 and the processor 402 may be connected through a bus 403. Optionally, the processor and the memory are integrated.

The memory 401 is configured to store program code.

The processor 402 invokes the program code, and is configured to perform the signal processing method in any one of the foregoing embodiments when the program code is executed. For details, refer to related descriptions in the foregoing method embodiments.

Optionally, this application includes a communication interface 404. The communication interface 404 may be connected to the processor 402 through the bus 403. The processor 402 may control the communication interface 403 to implement the foregoing receiving and sending functions of the signal processing apparatus 400.

The signal processing apparatus in this embodiment of this application may be configured to implement the technical solutions in the foregoing method embodiments. Implementation principles and technical effects thereof are similar, and details are not described herein again.

For example, this application further provides a computer-readable storage medium. The computer-readable storage medium stores executable instructions. When at least one processor of a server executes the executable instructions, the server performs the signal processing method in the foregoing method embodiment.

For example, this application further provides a chip, including an interface circuit and a logic circuit. The interface circuit is configured to receive a signal from another chip other than the chip and transmit the signal to the logic circuit, or send a signal from the logic circuit to the another chip other than the chip. The logic circuit is configured to implement the signal processing method in the foregoing method embodiment.

For example, this application further provides a computer program product. The computer program product includes executable instructions, and the executable instructions are stored in a readable storage medium. At least one processor of a server may read the executable instructions from the readable storage medium, and the at least one processor executes the executable instructions to enable the server to perform the signal processing method in the foregoing method embodiment.

A person of ordinary skill in the art may understand that all or some of the foregoing embodiments may be implemented by software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, all or some of the procedures or functions according to embodiments of this application are generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk drive, or a magnetic tape), an optical medium (for example, DVD), a semiconductor medium (for example, a solid state drive (Solid State Drive, SSD)), or the like.

1. A signal processing method, wherein the method comprises:
receiving, by a first device, a first complex signal formed after an electromagnetic signal is reflected by an ambient environment, wherein a dimension of the first complex signal is related to configuration information of the first device; and
sending, by the first device, a transformed signal to a second device, wherein the transformed signal comprises a transformed bitstream, and the transformed bitstream is obtained by the first device by transforming the first complex signal based on the configuration information of the first device, so that the second device de-transforms the transformed signal based on the configuration information of the first device to obtain a second complex signal.

2. The method according to claim 1, wherein the first complex signal comprises data in a space dimension and a time dimension, or data in the space dimension; and
that the transformed bitstream is obtained by the first device by transforming the first complex signal based on the configuration information of the first device comprises:
determining, by the first device, an initial configuration parameter based on the configuration information of the first device, wherein the initial configuration parameter comprises a space dimension size and a time dimension size of the first complex signal, and at least one of the following:
a block size of block discrete cosine transform DCT or discrete Fourier transform DFT or discrete wavelet transform DWT, a block quantity of block discrete cosine transform DCT or discrete Fourier transform DFT or discrete wavelet transform DWT, a phase processing switch, a phase difference order M1, an amplitude processing switch, or an amplitude difference order Q1, wherein M1 and Q1 are positive integers; and
transforming, by the first device, the first complex signal based on the initial configuration parameter to obtain the transformed bitstream.

3. The method according to claim 2, wherein the transforming, by the first device, the first complex signal based on the initial configuration parameter to obtain the transformed bitstream comprises:
obtaining, by the first device from the first complex signal, an (M2)^{th}-order phase difference of data corresponding to each time, wherein M2 is equal to M1 or a preconfigured positive integer;
performing, by the first device, smoothing and block discrete cosine transform DCT or discrete Fourier transform DFT or discrete wavelet transform DWT on the (M2)^{th}-order phase difference to obtain a first bitstream;
obtaining, by the first device from the first complex signal, a (Q2)^{th}-order amplitude difference of the data corresponding to each time, wherein Q2 is equal to Q1 or a preconfigured positive integer;
performing, by the first device, block discrete cosine transform DCT or discrete Fourier transform DFT or discrete wavelet transform DWT on the (Q2)^{th}-order amplitude difference to obtain a second bitstream; and
determining, by the first device, that the transformed bitstream comprises the first bitstream and the second bitstream.

4. The method according to claim 3, wherein the transformed signal further comprises first signaling, and the first signaling indicates a transmission length of the transformed bitstream and/or a total length of the transformed bitstream.

5. The method according to claim 1, wherein the first complex signal comprises data in a delay-frequency domain dimension and a time dimension, or data in the delay-frequency domain dimension; and
that the transformed bitstream is obtained by the first device by transforming the first complex signal based on the configuration information of the first device comprises:
determining, by the first device, an initial configuration parameter based on the configuration information of the first device, wherein the initial configuration parameter comprises a delay-frequency domain dimension size and a time dimension size of the first complex signal, and at least one of the following: a redundancy removal processing switch, a redundancy removal order P1, or a first transform step configuration, wherein P1 is a positive integer; and
transforming, by the first device, the first complex signal based on the initial configuration parameter to obtain the transformed bitstream.

6. The method according to claim 5, wherein the transforming, by the first device, the first complex signal based on the initial configuration parameter to obtain the transformed bitstream comprises:
transforming, by the first device, data in the delay-frequency domain dimension in the first complex signal from a frequency domain to a delay domain, to obtain a third complex signal;
obtaining, by the first device, a first region of interest ROI of data corresponding to each time in the third complex signal;
performing, by the first device, (P2)^{th}-order redundancy removal on the data corresponding to each time in the third complex signal, to obtain a fourth complex signal, wherein P2 is equal to P1 or a preconfigured positive integer; and
obtaining, by the first device, the transformed bitstream based on the first region of interest ROI and the fourth complex signal.

7. The method according to claim 6, wherein the transformed signal further comprises second signaling, and the second signaling indicates at least one of the following: a transmission length of the transformed bitstream, a total length of the transformed bitstream, a correlation coefficient for redundancy removal, or a second region of interest ROI, wherein the second region of interest ROI is obtained by the first device through redundancy removal on the first region of interest ROI.

8. The method according to claim 1, wherein the first complex signal comprises data in a space dimension, a delay-frequency domain dimension, an antenna array dimension, and a time dimension, or data in the space dimension, the delay-frequency domain dimension, and the time dimension; and
that the transformed bitstream is obtained by the first device by transforming the first complex signal based on the configuration information of the first device comprises:
determining, by the first device, an initial configuration parameter based on the configuration information of the first device, wherein the initial configuration parameter comprises a space dimension size, a delay-frequency domain dimension size, an antenna array dimension size, and a time dimension size of the first complex signal, and at least one of the following: a block size of block discrete cosine transform DCT or discrete Fourier transform DFT or discrete wavelet transform DWT, a block quantity of block discrete cosine transform DCT or discrete Fourier transform DFT or discrete wavelet transform DWT, a second transform step configuration, a phase processing switch, a phase difference order K1, an antenna array dimension redundancy removal processing switch, an antenna array dimension redundancy removal order R1, a time dimension redundancy removal processing switch, or an order S1 of the time dimension redundancy removal processing switch, wherein K1, R1, and S1 are positive integers; and
transforming, by the first device, the first complex signal based on the initial configuration parameter to obtain the transformed bitstream.

9. The method according to claim 8, wherein the transforming, by the first device, the first complex signal based on the initial configuration parameter to obtain the transformed bitstream comprises:
performing, by the first device, at least one of the following based on the second transform step configuration and the first complex signal:
obtaining a region of interest ROI of a signal in the space dimension and the delay-frequency domain dimension, performing smoothing and block discrete cosine transform DCT or discrete Fourier transform DFT or discrete wavelet transform DWT on a phase difference of the signal, and performing antenna array dimension redundancy removal on the signal, or performing time dimension redundancy removal on the signal, wherein
the signal is the first complex signal or a signal obtained by transforming the first complex signal.

10. The method according to claim 9, wherein the performing, by the first device, at least one of the following based on the second transform step configuration and the first complex signal comprises:
transforming, by the first device, data in the delay-frequency domain dimension in the first complex signal from a frequency domain to a delay domain, to obtain a fifth complex signal;
obtaining, by the first device, a third region of interest ROI of data corresponding to each time in each antenna array in the fifth complex signal;
obtaining, by the first device from the fifth complex signal in the third region of interest ROI, a (K2)^{th}-order phase difference of data corresponding to each time in each antenna array, wherein K2 is equal to K1 or a preconfigured positive integer;
performing, by the first device, smoothing and block discrete cosine transform DCT or discrete Fourier transform DFT or discrete wavelet transform DWT on the (K2)^{th}-order phase difference to obtain a third bitstream;
performing, by the first device in the fifth complex signal in the third region of interest ROI, (R2)^{th}-order redundancy removal on an amplitude of data corresponding to each antenna array and (S2)^{th}-order redundancy removal on an amplitude of data corresponding to each time, to obtain a real signal, wherein R2 is equal to R1 or a preconfigured positive integer, and S2 is equal to S1 or a preconfigured positive integer;
performing, by the first device, block discrete cosine transform DCT or discrete Fourier transform DFT or discrete wavelet transform DWT on the real signal to obtain a fourth bitstream; and
determining, by the first device, that the transformed bitstream comprises the third bitstream and the fourth bitstream.

11. The method according to claim 10, wherein the transformed signal further comprises third signaling, and the third signaling indicates at least one of the following: a transmission length of the transformed bitstream, a total length of the transformed bitstream, a correlation coefficient for antenna array dimension redundancy removal, a correlation coefficient for time dimension redundancy removal, or a fourth region of interest ROI, wherein the fourth region of interest ROI is obtained by the first device through redundancy removal on the third region of interest ROI of each antenna array.

12. The method according to claim 9, wherein the performing, by the first device, at least one of the following based on the second transform step configuration and the first complex signal comprises:
transforming, by the first device, data in the delay-frequency domain dimension in the first complex signal from a frequency domain to a delay domain, to obtain a sixth complex signal;
performing, by the first device, (S3)^{th}-order redundancy removal on an amplitude of data corresponding to each time in the sixth complex signal, to obtain a seventh complex signal, wherein S3 is equal to S1 or a preconfigured positive integer;
obtaining, by the first device, a fifth region of interest ROI of data corresponding to each time in each antenna array in the seventh complex signal;
obtaining, by the first device from the seventh complex signal in the fifth region of interest ROI, a (K3)^{th}-order phase difference of data corresponding to each time in each antenna array, wherein K3 is equal to K1 or a preconfigured positive integer;
performing, by the first device, smoothing and block discrete cosine transform DCT or discrete Fourier transform DFT or discrete wavelet transform DWT on the (K3)^{th}-order phase difference to obtain a fifth bitstream;
performing, by the first device, block discrete cosine transform DCT or discrete Fourier transform DFT or discrete wavelet transform DWT on an amplitude of the seventh complex signal in the fifth region of interest ROI to obtain a sixth bitstream; and
determining, by the first device, that the transformed bitstream comprises the fifth bitstream and the sixth bitstream.

13. The method according to claim 12, wherein the transformed signal further comprises fourth signaling, and the fourth signaling indicates at least one of the following: a transmission length of the transformed bitstream, a total length of the transformed bitstream, a correlation coefficient for time dimension redundancy removal, or a sixth region of interest ROI, wherein the sixth region of interest ROI is obtained by the first device through redundancy removal on the fifth region of interest ROI of each antenna array.

14. The method according to claim 1, wherein before the sending, by the first device, a transformed signal to a second device, the method further comprises:
performing, by the first device, at least one of data quantization, bit layering, run-length encoding, or entropy encoding on a corresponding bitstream, to update the corresponding bitstream.

15. The method according to claim 14, wherein a data quantization type is related to a data distribution status before data quantization and a channel status between the first device and the second device.

16. The method according to claim 1, wherein before the receiving, by a first device, a first complex signal formed after an electromagnetic signal is reflected by an ambient environment, the method further comprises:
transmitting, by the first device, the electromagnetic signal, so that the first device receives the first complex signal; or
sending, by the first device, a transmit request to a third device, wherein the transmit request is used by the third device to transmit the electromagnetic signal, so that the first device receives the first complex signal, and the third device is different from the first device.

17. The method according to claim 1, wherein the method further comprises:
sending, by the first device, a configuration indication to the second device, wherein the configuration indication comprises the initial configuration parameter, and the initial configuration parameter is related to the configuration information of the first device, so that the second device determines the initial configuration parameter based on the configuration indication, and de-transforms the transformed signal based on the initial configuration parameter, to obtain the second complex signal; or
sending, by the first device, a configuration indication to the second device, wherein the configuration indication indicates a type of the first complex signal, and the type of the first complex signal is related to the initial configuration parameter, so that the second device determines the initial configuration parameter based on the configuration indication, and de-transforms the transformed signal based on the initial configuration parameter, to obtain the second complex signal.

18. The method according to claim 1, wherein the dimension of the first complex signal is related to at least one of the following in the configuration information of the first device:
an antenna configuration of the first device, a quantity of carriers of the first device, or a duration for signal collection of the first device.

19. The method according to claim 1, wherein before the sending, by the first device, a transformed signal to a second device, the method further comprises:
sending, by the first device, a resource request to the second device, wherein the resource request is used to request a transmission resource of the transformed bitstream;
receiving, by the first device, a first resource indication from the second device, wherein the first resource indication indicates a first allocated resource of the transformed bitstream; and
obtaining, by the first device, an adapted transformed bitstream from the transformed bitstream based on the first allocated resource of the transformed bitstream; and
the sending, by the first device, a transformed signal to a second device comprises:
the sending, by the first device, a transformed signal to a second device is sending the adapted transformed bitstream.

20. The method according to claim 19, wherein the obtaining, by the first device, an adapted transformed bitstream from the transformed bitstream based on the first allocated resource of the transformed bitstream comprises:
determining, by the first device, a first transform parameter based on the first allocated resource of the transformed bitstream, wherein the first transform parameter comprises at least one of the following: a first length, a first distortion amount, and a first compression rate; and
determining, by the first device, that the adapted transformed bitstream is a transformed bitstream that is in the transformed bitstream and that is adapted to the first transform parameter.
